(19) United States
(12) Patent Application Publication
(10) Pub. No.: US 2026/0012821 A1
(43) Pub. Date: Jan. 8, 2026

(54) UE-INITIATED MULTI-CELL REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/232,812

(22) Filed: Jun. 9, 2025

Related U.S. Application Data
(60) Provisional application No. 63/666,960, filed on Jul. 2, 2024.
(60) Provisional application No. 63/684,119, filed on Aug. 16, 2024.
(60) Provisional application No. 63/753,758, filed on Feb. 4, 2025.
(60) Provisional application No. 63/778,186, filed on Mar. 26, 2025.

(51) Int. Cl. H04W 24/08; H04L 5/00; H04W 24/10

(52) U.S. Cl. CPC H04W 24/08; H04L 5/0098; H04W 24/10

(57) ABSTRACT

Methods and apparatuses for beam measurement and reporting with multiple cells. A method performed by a user equipment (UE) includes receiving a configuration related to UE-initiated (UEI) channel state information (CSI) reporting, identifying, based on the configuration, one or more first reference signal (RS) resources and a first component carrier (CC), and identifying, based on the configuration, a second CC to which an indicated transmission configuration indication (TCI) state is applied. The method further includes determining a second RS resource based on the indicated TCI state, monitoring transmission occasions (TOs) of the one or more first RS resources or the second RS resource, and determining an event based on measured layer-1 reference signal received powers (L1-RSRPs) of the TOs.

### CROSS-REFERENCE TO RELATED AND CLAIM OF PRIORITY

The present application claims priority under 35 U.S.C. § 119(e) to U.S. Provisional Patent Application No. 63/666,960 filed on Jul. 2, 2024; U.S. Provisional Patent Application No. 63/684,119 filed on Aug. 16, 2024; U.S. Provisional Patent Application No. 63/753,758 filed on Feb. 4, 2025; and U.S. Provisional Patent Application No. 63/778,186 filed on Mar. 26, 2025, which are hereby incorporated by reference in their entirety.

### TECHNICAL FIELD

The present disclosure relates generally to wireless communication systems and, more specifically, the present disclosure relates to methods and apparatuses for beam measurement and reporting with multiple cells.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam measurement and reporting with multiple cells.

In one embodiment, a user equipment (UE) is provided. The UE includes a transceiver configured to receive a configuration related to UE-initiated (UEI) channel state information (CSI) reporting and a processor operably coupled with the transceiver. The processor is configured to identify, based on the configuration, one or more first reference signal (RS) resources and a first component carrier (CC), identify, based on the configuration, a second CC to which an indicated transmission configuration indication (TCI) state is applied, and determine a second RS resource based on the indicated TCI state. The transceiver is further configured to monitor transmission occasions (TOs) of the one or more first RS resources or the second RS resource. The processor is further configured to determine an event based on measured layer-1 reference signal received powers (L1-RSRPs) of the TOs.

In another embodiment, a base station (BS) is provided. The BS includes a processor and a transceiver operably coupled with the processor. The transceiver is configured to transmit a configuration related to UEI CSI reporting and transmit on TOs of one or more first RS resources or a second RS resource associated with an indicated TCI state. The configuration indicates one or more first RS resources, a first CC, and a second CC to which the indicated TCI state is applied An event is based on L1-RSRPs of the TOs.

In yet another embodiment, a method performed by a UE is provided. The method includes receiving a configuration related to UEI CSI reporting, identifying, based on the configuration, one or more first RS resources and a first carrier CC, and identifying, based on the configuration, a second CC to which an indicated TCI state is applied. The method further includes determining a second RS resource based on the indicated TCI state, monitoring TOs of the one or more first RS resources or the second RS resource, and determining an event based on measured L1-RSRPs of the TOs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a flowchart of an example UE procedure for declaring an event and/or triggering beam reporting according to embodiments of the present disclosure;

FIG. 8 illustrates a flowchart of an example UE procedure for determining/identifying a current serving beam RS according to embodiments of the present disclosure; and

FIG. 9 illustrates an example method performed by a UE in a wireless communication system according to embodiments of the present disclosure.

### DETAILED DESCRIPTION

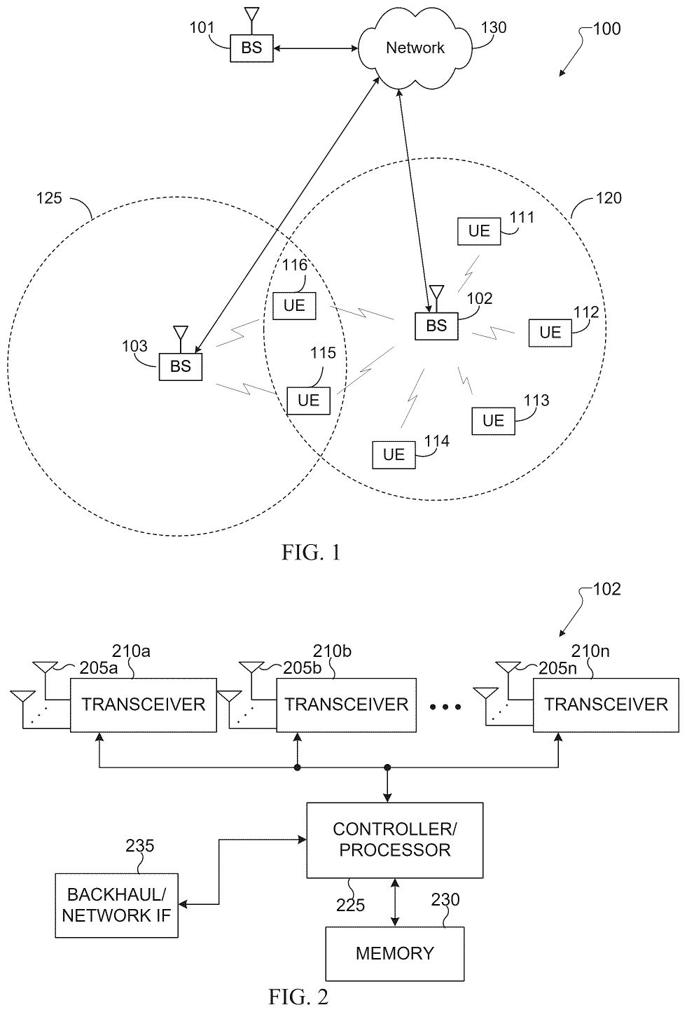

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v16.1.0, “NR; Physical channels and modulation;” [REF 2]3GPP TS 38.212 v16.1.0, “NR; Multiplexing and Channel coding;” [REF 3]3GPP TS 38.213 v16.1.0, “NR; Physical Layer Procedures for Control;” [REF 4]3GPP TS 38.214 v16.1.0, “NR; Physical Layer Procedures for Data;” [REF 5] 3GPP TS 38.321 v16.1.0, “NR; Medium Access Control (MAC) protocol specification;” and [REF 6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for beam measurement and reporting with multiple cells. In certain embodiments, one or more of the BSs 101-103 include circuitry, programing, or a combination thereof to support beam measurement and reporting with multiple cells.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as to support beam measurement and reporting with multiple cells. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

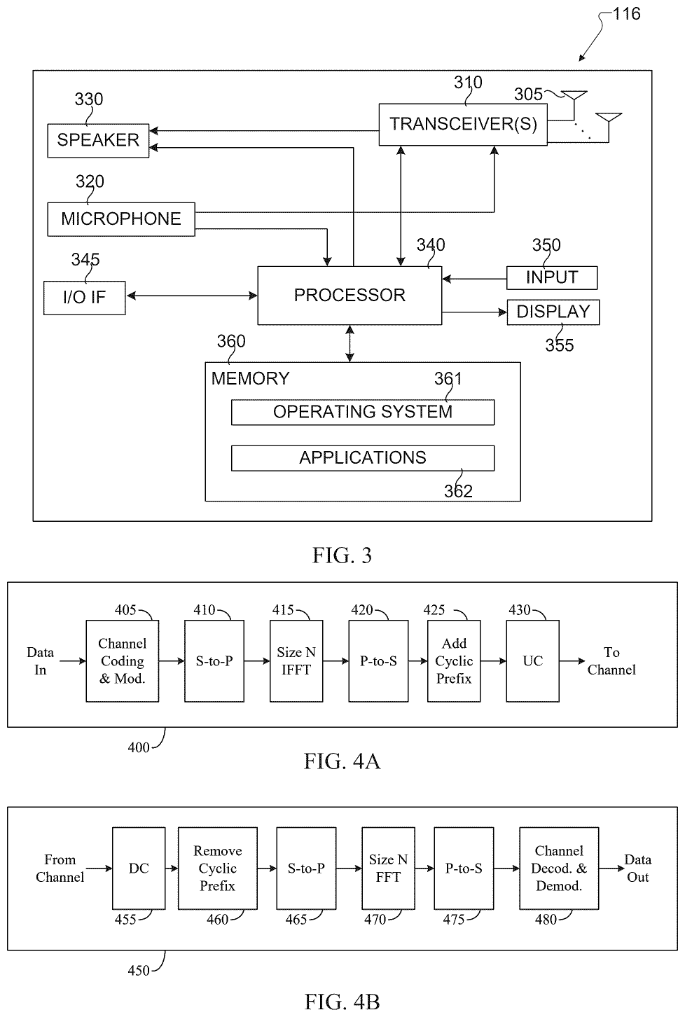

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for beam measurement and reporting with multiple cells as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support beam measurement and reporting with multiple cells as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

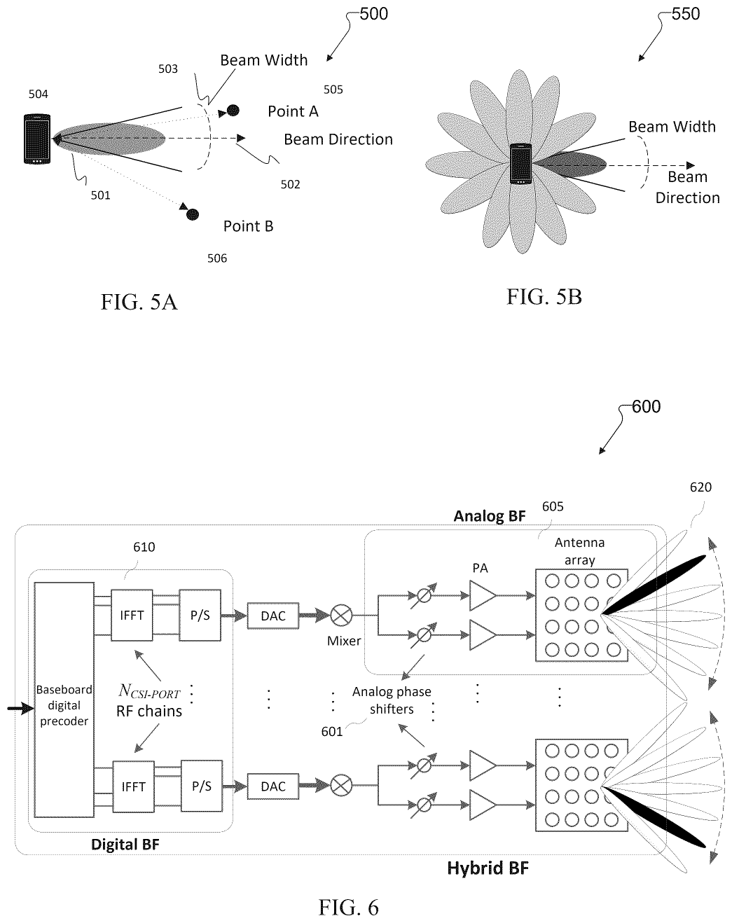

As illustrated in FIG. 5A, in a wireless system 500, a beam 501 for a device 504 can be characterized by abeam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication refence signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the 02 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of;
A transmission configuration indication (TCI) state, that establishes a quasi-colocation (QCL) relationship or spatial relation between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal or the ID of the TCI state or the ID of the spatial relation identifies the beam.

The TCI state and/or the spatial relation reference RS can determine a spatial Rx filter for reception of downlink channels at the UE, or a spatial TX filter for transmission of uplink channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB (e.g., the BS 102) or trigger a new beam update without having to wait for a beam change or update indication from the NW/gNB (e.g., the BS 102). Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Therefore, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), or/and multiple event types when a report type can be associated with an event (e.g. for beam report, the event can be beam failure, and for CSI, the event can be user throughput degradation or increasing retransmission rate).

The present disclosure provides various detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations in a wireless communications system with one or more or multiple (i.e., more than one) frequency carriers or component carriers or cells. In addition, the present disclosure provides various report formats customized for the UE-initiated/event-driven beam reporting, and specifies different conditions or settings to apply or use different report formats in a multiple-carrier/cell system. Means of detecting/declaring different events or combinations of different events, and designs of their corresponding configurations and signaling details with multiple carriers or component carriers or cells are specified in this disclosure as well. Throughout the present disclosure, a carrier or a frequency carrier can also be referred to as a component carrier (CC) or a cell, or a cell can be referred to as a (frequency) carrier or a component carrier (CC) as well.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE (e.g., the UE 116) could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. CRI, SSB resource indicator (SSBRI)) and Jᵢ is a beam metric (e.g. L1-reference signal received power (RSRP)/L1-signal-to-interference-plus-noise ratio (SINR)).
In one example, the content includes CSI-related quantity/quantities. For example, at least one of rank indicator (RI), precoding matrix indicator (PMI), channel quality indicator (CQI), CQI report interval (CRI), layer index (LI).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).

The In one example, the content includes other (e.g. non-beam, non-CSI, non-TDCP) quantity/quantities. In one example, quantity/quantities comprises a selector/indicator indicating selection of one (or >1) of either
beam (TCI state) TCI states (e.g. DL TCI state, UL TCI state, or unified (joint) DL/UL TCI state), or
panel(s) (e.g. UE panels for DL reception or/and UL transmission), or
antenna(e) (e.g. UE antennae for DL reception or/and UL transmission), or
antenna port(s) (e.g. UE antenna ports for DL reception or/and UL transmission).

In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).

In one example, the content includes beam-related quantity/quantities (according to one or more examples described herein) and at least one other quantity/quantities (according to one or more examples described herein).

In one example, the content includes CSI-related quantity/quantities (according to one or more examples described herein) and at least one other quantity/quantities (according to one or more examples described herein).

In one example, the content includes TDCP-related quantity/quantities (according to one or more examples described herein) and at least one other quantity/quantities (according to one or more examples described herein).

In one example, the content includes beam-related quantity/quantities (according to one or more examples described herein) and CSI-related quantity/quantities (according to one or more examples described herein).

In one example, the content includes beam-related quantity/quantities (according to one or more examples described herein) and TDCP-related quantity/quantities (according to one or more examples described herein).

In one example, the content includes TDCP-related quantity/quantities (according to one or more examples described herein) and CSI-related quantity/quantities (according to one or more examples described herein).

In one example, the report is targeting a physical layer (L1) communication (e.g. L1 DL/UL, or L1 sidelink (SL)), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/beam/ | (A) | Yes (e.g. non-CSI-related event) | No |
| TDCP | (B) | No | Yes |
| | (C) | Yes (e.g. non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), | No |
| | content-specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.

For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).

For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.

For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.

For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).

For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.

For another example, the hint (or purpose of the PN message/trigger as specified herein in the present disclosure) is about transmission scheme, which can be one of PMI-based, diversity (cyclic delay diversity (CDD), cycling, space frequency block code (SFBC)), reciprocity (NCB, or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).

For another example, the hint (or purpose of the PN message/trigger as specified herein in the present disclosure) is about transmission parameters, e.g. modulation and coding scheme (MCS), or number of carrier waves (CWs).

For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a random access channel (RACH) procedure.

For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including physical uplink control channel(s) (PUCCH(s)), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE (e.g., the UE 116) could send to the network (e.g., the network 130) UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB (e.g., the BS 102) or trigger a new beam update without having to wait for a beam change or update indication from the NW/gNB. Such UE-initiated reporting and/or beam switching for a content can be enabled for other types of report quantities (different from beam or CSI reports) and application scenarios.

For one or more measurement instances or one or more measurement occasions corresponding to one or more measurement RSs for one or more current serving beams, a UE (e.g., the UE 116) could detect or declare or identify or determine an instance for a first event (denoted by Event-1) when/if the UE has identified or determined that radio link or beam quality(s)—including at least L1-RSRP(s)—of the one or more measurement RSs for the one or more current serving beams is below or less than or equal to a threshold-A, wherein the threshold-A value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network (e.g., the network 130) via various UL channels/signals including CSI/beam report(s) and/or UE's capability signaling. In this case, (a) when/if Event-1 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventOneConfig (e.g., set to ‘enabled’) and/or a higher layer parameter eventType set to ‘Event-1’, and/or (b) when/if the UE has determined or identified or detected that within a time window/period/gap/offset, a number of instances of the first event (denoted by N_1) according to or following those specified/defined herein in the present disclosure is greater than or equal to a minimum value/number denoted by N_min, and/or (c) when/if the UE has determined or identified or detected an instance of the first event according to or following those specified/defined herein in the present disclosure, the UE could increase a number of count in a counter (e.g., specific to the Event-1) by 1 and/or when/if the number of counts (denoted by N_1) in the counter reaches to a maximum number of counts denoted by N_max before a timer (e.g., specific to the Event-1) has expired, the UE could declare (occurrence of) the first event (i.e., the Event-1), and initiate/trigger the corresponding beam reporting. For (c), the corresponding MAC entity could or shall for each Serving Cell configured for UE-initiated (UEI)/event-driven reporting according to those specified herein in the present disclosure:
1> to initiate or trigger a UEI/event-driven reporting based on or according to detection or declaration of the first event (or the Event-1):
   2> if an indication for an instance for the first event or Event-1 as specified/defined herein in the present disclosure has been received from lower layers:
      3> start or restart thefirstEventInstanceDetectionTimer (higher layer configured for the first event—when/if applicable)
      3> increment firstEvent_COUNTER (higher layer configured for the first event—when/if applicable) by 1;
      3> if firstEvent_COUNTER>=firstEventInstanceMaxCount or N_max (configured for the first event—when/if applicable), wherein the firstEventInstanceMaxCount or N_max is higher layer configured for the first event—when/if applicable:
         4> trigger a UEI (beam) reporting corresponding/specific to the first event—when/if applicable—for this Serving Cell.
   2> if thefirstEventInstanceDetectionTimer (for the first event—when/if applicable) expires; and/or
   2> if thefirstEventInstanceDetectionTimer (for the first event—when/if applicable), firstEvent_COUNTER (for the first event—when/if applicable), or any of the reference signals used for UEI reporting—e.g., including that/those specific to/for the current serving beam(s) and/or the candidate beam(s) as specified or defined herein in the present disclosure specific to/for the first event—is reconfigured by upper layers associated with this Serving Cell; and/or
   2> if the reference signal(s) associated with this Serving Cell used for detection/declaration/indication for the first event as specified/defined herein in the present disclosure is changed and/or reconfigured by upper layers associated with this Serving Cell; and/or
   2> if the UE has received or detected or determined or identified a network's response to the UE-initiated/event-driven beam reporting corresponding/specific to the first event—when/if applicable for this Serving Cell:
      3> set firstEvent_COUNTER (for the first event—when/if applicable) to 0; and/or
      3> stop firstEventInstanceDetectionTimer (for the first event—when/if applicable); and/or
      3> stop the ueiReportingTimer, if configured; and/or
      3> consider the UE-initiated (UEI) reporting procedure triggered or initiated with respect to the first event successfully completed, and/or cancel the UEI report(s) triggered or initiated with respect to at least the first event for this Serving Cell.

The value(s) of the N_min, N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Furthermore, the network's response to the UE-initiated/event-driven reporting corresponding/specific to the first event (or the Event-1) could be in form of or could comprise one or more of the following components:
A physical downlink control channel (PDCCH) reception in a search space set provided by beamReportingEventOneSearchSpaceId for which the UE could detect a DCI format with cyclic redundancy check (CRC) scrambled by cell-radio network temporary identifier (C-RNTI) or modulation and coding scheme (MCS)-C-RNTI
A PDCCH reception that determines completion of a contention based random access procedure (e.g., if a MAC CE is used to carry or convey or transmit or send the corresponding (UEI or event-driven or L1/L2-triggered mobility (LTM) based) beam report(s), and the MAC CE is provided in Msg3 or MsgA of contention based random access procedure)
A PDCCH reception with a DCI format scheduling a PUSCH transmission with a same hybrid automatic repeat request (HARQ) process number as for the transmission of a PUSCH used for carrying, conveying, transmitting or sending the corresponding (UEI or event-driven or LTM based) beam report(s) and having a toggled new data indicator (NDI) field value
A one-bit indicator set to ‘1’ (or ‘0’) or an acknowledgement (ACK) provided/indicated in a DCI format (e.g., DCI format 0_0, 0_1, 0_2, 0_3, 1_0, 1_1, 1_2, 1_3, and/or etc.)
TCI state(s) update/indication via a MAC CE activation/deactivation command or a DCI (e.g., DCI format 1_1/1_2 with or without DL assignment and/or DCI format 1_3) or a MAC CE cell switching command (CSC), wherein the updated/indicated TCI state(s) could correspond to beam(s) (or RS(s)) reported by the UE in the UE-initiated/event-driven beam report(s)
TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s)
TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s)
A non-zero CSI request field (and therefore, a corresponding trigger state) in a DCI (e.g., of a DCI format 0_1 or 0_2)
CSI-RS(s) or CSI-RS resource(s), e.g., aperiodic (AP)/semi-persistent (SP) CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘on’
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘off’ or without the higher layer parameter repetition (or equivalently, the higher layer parameter repetition is not present or is absent)
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent)

Furthermore, the network's response to the UE-initiated/event-driven reporting corresponding/specific to the first event (or the Event-1) and/or the medium/container such as RRC signaling(s), MAC CE command(s) and/or DCI format(s) used to carry/convey the network's response to the UE-initiated/event-driven reporting corresponding/specific to the first event (or the Event-1) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the first event or the Event-1 as described/specified herein could be denoted by or referred to as a first LTM event or a LTM Event-1. For the first LTM event or the LTM Event-1, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more physical cell IDs (PCIs) and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For one or more measurement instances or one or more measurement occasions corresponding to one or more measurement RSs for one or more candidate/new beams, a UE could detect or declare or identify or determine an instance for a second event (denoted by Event-2) when/if the UE has identified or determined that radio link or beam quality(s)—including at least L1-RSRP(s)—of the one or more measurement RSs for the one or more candidate/new beams is below or less than or equal to a threshold-B, wherein the threshold-B value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. In this case, (a) when/if Event-2 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventTwoConfig (e.g., set to ‘enabled’) and/or a higher layer parameter eventType set to ‘Event-2’, and/or (b) when/if the UE has determined or identified or detected that within a time window/period/gap/offset, a number of instances of the second event (denoted by N_2) according to or following those specified/defined herein in the present disclosure is greater than or equal to a minimum value/number denoted by N_min, and/or (c) when/if the UE has determined or identified or detected an instance of the second event according to or following those specified/defined herein in the present disclosure, the UE could increase a number of count in a counter (e.g., specific to the Event-2) by 1 and/or when/if the number of counts (denoted by N_2) in the counter reaches to a maximum number of counts denoted by N_max before a timer (e.g., specific to the Event-2) has expired, the UE could declare (occurrence of) the second event (i.e., the Event-2), and initiate/trigger the corresponding beam reporting. For (c), the corresponding MAC entity could or shall for each Serving Cell configured for UE-initiated (UEI)/event-driven reporting according to those specified herein in the present disclosure:
1> to initiate or trigger a UEI/event-driven reporting based on or according to detection or declaration of the second event (or the Event-2):
   2> if an indication for an instance for the second event or Event-2 as specified/defined herein in the present disclosure has been received from lower layers:
      3> start or restart the secondEventInstanceDetectionTimer (higher layer configured for the second event—when/if applicable)
      3> increment secondEvent_COUNTER (higher layer configured for the second event—when/if applicable) by 1;
      3> if secondEvent_COUNTER>=secondEventInstanceMaxCount or N_max (configured for the second event—when/if applicable), wherein the secondEventInstanceMaxCount or N_max is higher layer configured for the second event—when/if applicable:
         4> trigger a UEI (beam) reporting corresponding/specific to the second event—when/if applicable—for this Serving Cell.
   2> if the secondEventInstanceDetectionTimer (for the second event—when/if applicable) expires; and/or
   2> if the secondEventInstanceDetectionTimer (for the second event—when/if applicable), secondEvent_COUNTER (for the second event—when/if applicable), or any of the reference signals used for UEI reporting—e.g., including that/those specific to/for the current serving beam(s) and/or the candidate beam(s) as specified or defined herein in the present disclosure specific to/for the second event—is reconfigured by upper layers associated with this Serving Cell; and/or
   2> if the reference signal(s) associated with this Serving Cell used for detection/declaration/indication for the second event as specified/defined herein in the present disclosure is changed and/or reconfigured by upper layers associated with this Serving Cell; and/or
   2> if the UE has received or detected or determined or identified a network's response to the UE-initiated/event-driven beam reporting corresponding/specific to the second event—when/if applicable—for this Serving Cell:
      3> set secondEvent_COUNTER (for the second event—when/if applicable) to 0; and/or
      3> stop secondEventInstanceDetectionTimer (for the second event—when/if applicable); and/or
      3> stop the ueiReportingTimer, if configured; and/or
      3> consider the UE-initiated (UEI) reporting procedure triggered or initiated with respect to the second event successfully completed, and/or cancel the UEI report(s) triggered or initiated with respect to at least the second event for this Serving Cell.

The value(s) of the N_min, N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Furthermore, the network's response to the UE-initiated/event-driven reporting corresponding/specific to the second event (or the Event-2) could be in form of or could comprise one or more of the following components:
A PDCCH reception in a search space set provided by beamReportingEventTwoSearchSpaceId for which the UE could detect a DCI format with CRC scrambled by C-RNTI or MCS-C-RNTI
A PDCCH reception that determines completion of a contention based random access procedure (e.g., if a MAC CE is used to carry or convey or transmit or send the corresponding (UEI or event-driven or LTM based) beam report(s), and the MAC CE is provided in Msg3 or MsgA of contention based random access procedure)
A PDCCH reception with a DCI format scheduling a PUSCH transmission with a same HARQ process number as for the transmission of a PUSCH used for carrying, conveying, transmitting or sending the corresponding (UEI or event-driven or LTM based) beam report(s) and having a toggled NDI field value
A one-bit indicator set to ‘1’ (or ‘0’) or an ACK provided/indicated in a DCI format (e.g., DCI format 0_0, 0_1, 0_2, 0_3, 1_0, 1_1, 1_2, 1_3, and/or etc.)
TCI state(s) update/indication via a MAC CE activation/deactivation command or a DCI (e.g., DCI format 1_1/1_2 with or without DL assignment and/or DCI format 1_3) or a MAC CE cell switch command (CSC), wherein the updated/indicated TCI state(s) could correspond to beam(s) (or RS(s)) reported by the UE in the UE-initiated/event-driven beam report(s)
TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s)
TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s)
A non-zero CSI request field (and therefore, a corresponding trigger state) in a DCI (e.g., of a DCI format 0_1 or 0_2)
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘on’
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘off’ or without the higher layer parameter repetition (or equivalently, the higher layer parameter repetition is not present or is absent)
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent)

Furthermore, the network's response to the UE-initiated/event-driven reporting corresponding/specific to the second event (or the Event-3) and/or the medium/container such as RRC signaling(s), MAC CE command(s) and/or DCI format(s) used to carry/convey the network's response to the UE-initiated/event-driven reporting corresponding/specific to the second event (or the Event-2) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the second event or the Event-2 as described/specified herein could be denoted by or referred to as a second LTM event or a LTM Event-2. For the second LTM event or the LTM Event-2, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For one or more measurement instances or one or more measurement occasions corresponding to one or more measurement RSs for one or more current serving beams and/or one or more measurement RSs for one or more candidate/new beams, a UE could detect or declare or identify or determine an instance for a third event (denoted by Event-3) when/if the UE has identified or determined that the radio link or beam quality(s)—including at least L1-RSRP(s)—of the one or more measurement RSs for the one or more current serving beams is below or less than or equal to a threshold-A, and the radio link or beam quality(s)—including at least L1-RSRP(s)—of the one or more measurement RSs for the one or more candidate/new beams is beyond or greater than or equal to a threshold-B, wherein the threshold-A and/or threshold-B value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. In this case, (a) when/if Event-3 based UE-initiated/event-driven beam reporting is enabled—e.g., the UE (e.g., the UE 116) could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventThreeConfig (e.g., set to ‘enabled’) and/or a higher layer parameter eventType set to ‘Event-3’, and/or (b) when/if the UE has determined or identified or detected that within a time window/period/gap/offset, a number of instances of the third event (denoted by N_3) according to or following those specified/defined herein in the present disclosure is greater than or equal to a minimum value/number denoted by N_min, and/or (c) when/if the UE has determined or identified or detected an instance of the third event according to or following those specified/defined herein in the present disclosure, the UE could increase a number of count in a counter (e.g., specific to the Event-3) by 1 and/or when/if the number of counts (denoted by N_3) in the counter reaches to a maximum number of counts denoted by N_max before a timer (e.g., specific to the Event-3) has expired, the UE could declare (occurrence of) the third event (i.e., the Event-3), and initiate/trigger the corresponding beam reporting. For (c), the corresponding MAC entity could or shall for each Serving Cell configured for UE-initiated (UEI)/event-driven reporting according to those specified herein in the present disclosure:
1> to initiate or trigger a UEI/event-driven reporting based on or according to detection or declaration of the third event (or the Event-3):
   2> if an indication for an instance for the third event or Event-3 as specified/defined herein in the present disclosure has been received from lower layers:
      3> start or restart the thirdEventInstanceDetectionTimer (higher layer configured for the third event—when/if applicable)
      3> increment thirdEvent_COUNTER (higher layer configured for the third event—when/if applicable) by 1;
      3> if thirdEvent_COUNTER>=thirdEventInstanceMaxCount or N_max (configured for the third event—when/if applicable), wherein the thirdEventInstanceMaxCount or N_max is higher layer configured for the third event—when/if applicable:
         4> trigger a UEI (beam) reporting corresponding/specific to the third event—when/if applicable—for this Serving Cell.
   2> if the thirdEventInstanceDetectionTimer (for the third event—when/if applicable) expires; and/or
   2> if the thirdEventInstanceDetectionTimer (for the third event—when/if applicable), thirdEvent_COUNTER (for the third event—when/if applicable), or any of the reference signals used for UEI reporting—e.g., including that/those specific to/for the current serving beam(s) and/or the candidate beam(s) as specified or defined herein in the present disclosure specific to/for the third event—is reconfigured by upper layers associated with this Serving Cell; and/or
   2> if the reference signal(s) associated with this Serving Cell used for detection/declaration/indication for the third event as specified/defined herein in the present disclosure is changed and/or reconfigured by upper layers associated with this Serving Cell; and/or
   2> if the UE has received or detected or determined or identified a network's response to the UE-initiated/event-driven beam reporting corresponding/specific to the third event—when/if applicable—for this Serving Cell:
      3> set thirdEvent_COUNTER (for the third event—when/if applicable) to 0; and/or
      3> stop thirdEventInstanceDetectionTimer (for the third event—when/if applicable); and/or
      3> stop the ueiReportingTimer, if configured; and/or
      3> consider the UE-initiated (UEI) reporting procedure triggered or initiated with respect to the third event successfully completed, and/or cancel the UEI report(s) triggered or initiated with respect to at least the third event for this Serving Cell.

The value(s) of the N_min, N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network (e.g., the network 130) via various UL channels/signals including CSI/beam report(s) and/or UE's capability signaling. Furthermore, the network's response to the UE-initiated/event-driven reporting corresponding/specific to the third event (or the Event-3) could be in form of or could comprise one or more of the following components:
A PDCCH reception in a search space set provided by beamReportingEventThreeSearchSpaceId for which the UE could detect a DCI format with CRC scrambled by C-RNTI or MCS-C-RNTI
A PDCCH reception that determines completion of a contention based random access procedure (e.g., if a MAC CE is used to carry or convey or transmit or send the corresponding (UEI or event-driven or LTM based) beam report(s), and the MAC CE is provided in Msg3 or MsgA of contention based random access procedure)
A PDCCH reception with a DCI format scheduling a PUSCH transmission with a same HARQ process number as for the transmission of a PUSCH used for carrying, conveying, transmitting or sending the corresponding (UEI or event-driven or LTM based) beam report(s) and having a toggled NDI field value
A one-bit indicator set to ‘1’ (or ‘0’) or an ACK provided/indicated in a DCI format (e.g., DCI format 0_0, 0_1, 0_2, 0_3, 1_0, 1_1, 1_2, 1_3, and/or etc.)
TCI state(s) update/indication via a MAC CE activation/deactivation command or a DCI (e.g., DCI format 1_1/1_2 with or without DL assignment and/or DCI format 1_3) or a MAC CE cell switch command (CSC), wherein the updated/indicated TCI state(s) could correspond to beam(s) (or RS(s)) reported by the UE in the UE-initiated/event-driven beam report(s)
TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s)
TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s)
A non-zero CSI request field (and therefore, a corresponding trigger state) in a DCI (e.g., of a DCI format 0_1 or 0_2)
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘on’
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘off’ or without the higher layer parameter repetition (or equivalently, the higher layer parameter repetition is not present or is absent)
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent)

Furthermore, the network's response to the UE-initiated/event-driven reporting corresponding/specific to the third event (or the Event-3) and/or the medium/container such as RRC signaling(s), MAC CE command(s) and/or DCI format(s) used to carry/convey the network's response to the UE-initiated/event-driven reporting corresponding/specific to the third event (or the Event-3) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the third event or the Event-3 as described/specified herein could be denoted by or referred to as a third LTM event or a LTM Event-3. For the third LTM event or the LTM Event-3, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For one or more measurement instances or one or more measurement occasions corresponding to one or more measurement RSs for one or more current serving beams and/or one or more measurement RSs for one or more candidate/new beams, a UE could detect or declare or identify or determine an instance for a fourth event (denoted by Event-4) when/if the UE has identified or determined that the radio link or beam quality(s)—including at least L1-RSRP(s)—of the one or more measurement RSs for the one or more (or at least one) candidate/new beams is beyond or greater than the radio link or beam quality(s)—including at least L1-RSRP(s)—of the one or more measurement RSs for the one or more current serving beams by a threshold-C, wherein the threshold-C value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. In this case, (a) when/if Event-4 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventFourConfig (e.g., set to ‘enabled’) and/or a higher layer parameter eventType set to ‘Event-4’, and/or (b) when/if the UE has determined or identified or detected that within a time window/period/gap/offset, a number of instances of the fourth event (denoted by N_4) according to or following those specified/defined herein in the present disclosure that have at least one same candidate/new beam determined/identified during the measurement instance(s)/occasion(s) is greater than or equal to a minimum value/number denoted by N_min, and/or (c) when/if the UE has determined or identified or detected an instance of the fourth event (i.e., an Event-4 instance) according to or following those specified/defined herein in the present disclosure and a candidate/new beam, the UE could increase a number of count in a counter (e.g., specific to the Event-4 or the Event-4 instance or the candidate/new beam) by 1 and/or when/if the number of counts (denoted by N_4) in the counter reaches to a maximum number of counts denoted by N_max before a timer (e.g., specific to the Event-4 or the Event-4 instance or the candidate/new beam) has expired, the UE could declare (occurrence of) the fourth event (i.e., the Event-4), and initiate/trigger the corresponding beam reporting. For (c), the corresponding MAC entity could or shall for each Serving Cell configured for UE-initiated (UEI)/event-driven reporting according to those specified herein in the present disclosure:
1> to initiate or trigger a UEI/event-driven reporting based on or according to detection or declaration of the fourth event (or the Event-4):
   2> if an indication for an instance for the fourth event or Event-4 as specified/defined herein in the present disclosure has been received from lower layers, and/or
   2> if an indication for a candidate/new beam determined/identified for the instance for the fourth event or Event-4 has been received from lower layers:
      3> start or restart the fourthEventInstanceDetectionTimer (higher layer configured for the fourth event—when/if applicable)
   2> if an indication for another instance for the fourth event or Event-4 as specified/defined herein in the present disclosure has been received from lower layers, and/or
   2> if an indication for the (same) candidate/new beam determined/identified for the other instance for the fourth event or Event-4 has been received from lower layers:
      3> increment fourthEvent_COUNTER (higher layer configured for the fourth event—when/if applicable) by 1;
      3> if fourthEvent_COUNTER>=fourthEventInstanceMaxCount or N_max (configured for the fourth event—when/if applicable), wherein the fourthEventInstanceMaxCount or N_max is higher layer configured for the fourth event—when/if applicable:
         4> trigger a UEI (beam) reporting corresponding/specific to the fourth event—when/if applicable—for this Serving Cell.
   2> if the fourthEventInstanceDetectionTimer (for the fourth event—when/if applicable) expires; and/or
   2> if the fourthEventInstanceDetectionTimer (for the fourth event—when/if applicable), fourthEvent_COUNTER (for the fourth event—when/if applicable), or any of the reference signals used for UEI reporting—e.g., including that/those specific to/for the current serving beam(s) and/or the candidate beam(s) as specified or defined herein in the present disclosure specific to/for the fourth event—is reconfigured by upper layers associated with this Serving Cell; and/or
   2> if the reference signal(s) associated with this Serving Cell used for detection/declaration/indication for the fourth event as specified/defined herein in the present disclosure is changed and/or reconfigured by upper layers associated with this Serving Cell; and/or
   2> if the UE has received or detected or determined or identified a network's response to the UE-initiated/event-driven beam reporting corresponding/specific to the fourth event—when/if applicable—for this Serving Cell:
      3> set fourthEvent_COUNTER (for the fourth event—when/if applicable) to 0; and/or
      3> stop fourthEventInstanceDetectionTimer (for the fourth event—when/if applicable); and/or
      3> stop the ueiReportingTimer, if configured; and/or
      3> consider the UE-initiated (UEI) reporting procedure triggered or initiated with respect to the fourth event successfully completed, and/or cancel the UEI report(s) triggered or initiated with respect to at least the fourth event for this Serving Cell.

The value(s) of the N_min, N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Furthermore, the network's response to the UE-initiated/event-driven reporting corresponding/specific to the fourth event (or the Event-4) could be in form of or could comprise one or more of the following components:
A PDCCH reception in a search space set provided by beamReportingEventFourSearchSpaceId for which the UE could detect a DCI format with CRC scrambled by C-RNTI or MCS-C-RNTI
A PDCCH reception that determines completion of a contention based random access procedure (e.g., if a MAC CE is used to carry or convey or transmit or send the corresponding (UEI or event-driven or LTM based) beam report(s), and the MAC CE is provided in Msg3 or MsgA of contention based random access procedure)
A PDCCH reception with a DCI format scheduling a PUSCH transmission with a same HARQ process number as for the transmission of a PUSCH used for carrying, conveying, transmitting or sending the corresponding (UEI or event-driven or LTM based) beam report(s) and having a toggled NDI field value
A one-bit indicator set to ‘1’ (or ‘0’) or an ACK provided/indicated in a DCI format (e.g., DCI format 0_0, 0_1, 0_2, 0_3, 1_0, 1_1, 1_2, 1_3, and/or etc.)
TCI state(s) update/indication via a MAC CE activation/deactivation command or a DCI (e.g., DCI format
1_1/1_2 with or without DL assignment and/or DCI format 1_3) or a MAC CE cell switch command (CSC), wherein the updated/indicated TCI state(s) could correspond to beam(s) (or RS(s)) reported by the UE in the UE-initiated/event-driven beam report(s)
TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s)
TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s)
A non-zero CSI request field (and therefore, a corresponding trigger state) in a DCI (e.g., of a DCI format 0_1 or 0_2)
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘on’
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘off’ or without the higher layer parameter repetition (or equivalently, the higher layer parameter repetition is not present or is absent)
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent)

Furthermore, the network's response to the UE-initiated/event-driven reporting corresponding/specific to the fourth event (or the Event-4) and/or the medium/container such as RRC signaling(s), MAC CE command(s) and/or DCI format(s) used to carry/convey the network's response to the UE-initiated/event-driven reporting corresponding/specific to the fourth event (or the Event-4) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the fourth event or the Event-4 as described/specified herein could be denoted by or referred to as a fourth LTM event or a LTM Event-4. For the fourth LTM event or the LTM Event-4, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

For one or more measurement instances or one or more measurement occasions corresponding to one or more measurement RSs for one or more current serving beams and/or one or more measurement RSs for one or more candidate/new beams, a UE could detect or declare or identify or determine an instance for a fifth event (denoted by Event-5) according to or based on one or more of and/or a combination of one or more of:
(an instance for the first event, i.e., Event-1): when/if the UE has identified or determined that radio link or beam quality(s)—including at least L1-RSRP(s)—of the one or more measurement RSs for the one or more current serving beams is below or less than or equal to a threshold-A, wherein the threshold-A value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling;
(an instance for the second event, i.e., Event-2): when/if the UE has identified or determined that radio link or beam quality(s)—including at least L1-RSRP(s)—of the one or more measurement RSs for the one or more candidate/new beams is below or less than or equal to a threshold-B, wherein the threshold-B value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling
(an instance for the third event, i.e., Event-3): when/if the UE (e.g., the UE 116) has identified or determined that the radio link or beam quality(s)—including at least L1-RSRP(s)—of the one or more measurement RSs for the one or more current serving beams is below or less than or equal to a threshold-A, and the radio link or beam quality(s)—including at least L1-RSRP(s)—of the one or more measurement RSs for the one or more candidate/new beams is beyond or greater than or equal to a threshold-B, wherein the threshold-A and/or threshold-B value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling
(an instance for the fourth event, i.e., Event-4): when/if the UE has identified or determined that the radio link or beam quality(s)—including at least L1-RSRP(s)—of the one or more measurement RSs for the one or more (or at least one) candidate/new beams is beyond or greater than the radio link or beam quality(s)—including at least L1-RSRP(s)—of the one or more measurement RSs for the one or more current serving beams by a threshold-C, wherein the threshold-C value(s) could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

The UE could send to the network a capability signaling to indicate whether or not they are capable of supporting detecting or declaring an instance of the fifth event (i.e., Event-5), and/or which (combination(s)) of an instance for the first event (Event-1), an instance for the second event (Event-2), an instance for the third event (Event-3) and/or an instance for the fourth event (Event-4) they are capable of supporting as an instance for the fifth event (Event-5); for instance, the capability or capability signaling could comprise one or more of the following components as an instance for the fifth event (i.e., the Event-5):
Component-1: {an instance for the first event }
Component-2: {an instance for the second event}
Component-3: {an instance for the third event}
Component-4: {an instance for the fourth event}
Component-5: {instances for the first, second, third and fourth events}
Component-6: {instances for the first, second and third events}
Component-7: {instances for the first, second and fourth events}
Component-8: {instances for the first, third and fourth events}
Component-9: {instances for the first and second events}
Component-10: {instances for the first and third events}
Component-11: {instances for the first and fourth events}
Component-12: {instances for the second, third and fourth events}
Component-13: {instances for the second and third events}
Component-14: {instances for the second and fourth events}
Component-15: {instances for the third and fourth events}

Accordingly, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling as defined/specified herein in the present disclosure, which (combination(s)) of an instance for the first event (Event-1), an instance for the second event (Event-2), an instance for the third event (Event-3) and/or an instance for the fourth event (Event-4) could be considered, used or applied as an instance for the fifth event (Event-5), and/or which one or more of the Component-1—Component-15 as defined herein could be considered, used or applied as an instance for the fifth event (Event-5).

In one example, an instance for the fifth event (Event-5) may not comprise any component(s) related/corresponding to an instance for the fourth event (Event-4), and/or an instance for the fifth event (Event-5) does not comprise, include or contain an instance for the fourth event (Event-4), and/or detection, determination or identification of the fifth event (Event-5) may not be according to or based on any component(s) related/corresponding to an instance for the fourth event (Event-4). In this case, (a) when/if Event-5 based UE-initiated/event-driven beam reporting is enabled—e.g., the UE could be provided/configured by the network (e.g., the network 130), e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventFiveConfig (e.g., set to ‘enabled’) and/or a higher layer parameter eventType set to ‘Event-5’, and/or (b) when/if the UE has determined or identified or detected that within a time window/period/gap/offset, a number of instances of the fifth event (denoted by N_5) according to or following those specified/defined herein in the present disclosure is greater than or equal to a minimum value/number denoted by N_min, and/or (c) when/if the UE has determined or identified or detected an instance of the fifth event according to or following those specified/defined herein in the present disclosure, the UE could increase a number of count in a counter (e.g., specific to the Event-5) by 1 and/or when/if the number of counts (denoted by N_5) in the counter reaches to a maximum number of counts denoted by N_max before a timer (e.g., specific to the Event-5) has expired, the UE could declare (occurrence of) the fifth event (i.e., the Event-5), and initiate/trigger the corresponding beam reporting. For (c), the corresponding MAC entity could or shall for each Serving Cell configured for UE-initiated (UEI)/event-driven reporting according to those specified herein in the present disclosure:
1> to initiate or trigger a UEI/event-driven reporting based on or according to detection or declaration of the fifth event (or the Event-5):
   2> if an indication for an instance for the fifth event or Event-5 as specified/defined herein in the present disclosure has been received from lower layers:
      3> start or restart the fifthEventInstanceDetectionTimer (higher layer configured for the fifth event—when/if applicable)
      3> increment fifthEvent_COUNTER (higher layer configured for the fifth event—when/if applicable) by 1;
      3> if fifthEvent_COUNTER>=fifthEventInstanceMaxCount or N_max (configured for the fifth event—when/if applicable), wherein the fifthEventInstanceMaxCount or N_max is higher layer configured for the fifth event—when/if applicable:
         4> trigger a UEI (beam) reporting corresponding/specific to the fifth event—when/if applicable—for this Serving Cell.
   2> if the fifthEventInstanceDetectionTimer (for the fifth event—when/if applicable) expires; and/or
   2> if the fifthEventInstanceDetectionTimer (for the fifth event—when/if applicable), fifthEvent_COUNTER (for the fifth event—when/if applicable), or any of the reference signals used for UEI reporting—e.g., including that/those specific to/for the current serving beam(s) and/or the candidate beam(s) as specified or defined herein in the present disclosure specific to/for the fifth event—is reconfigured by upper layers associated with this Serving Cell; and/or
   2> if the reference signal(s) associated with this Serving Cell used for detection/declaration/indication for the fifth event as specified/defined herein in the present disclosure is changed and/or reconfigured by upper layers associated with this Serving Cell; and/or
   2> if the UE has received or detected or determined or identified a network's response to the UE-initiated/event-driven beam reporting corresponding/specific to the fifth event—when/if applicable—for this Serving Cell:
      3> set fifthEvent_COUNTER (for the fifth event—when/if applicable) to 0; and/or
      3> stop fifthEventInstanceDetectionTimer (for the fifth event—when/if applicable); and/or
      3> stop the ueiReportingTimer, if configured; and/or
      3> consider the UE-initiated (UEI) reporting procedure triggered or initiated with respect to the fifth event successfully completed, and/or cancel the UEI report(s) triggered or initiated with respect to at least the fifth event for this Serving Cell.

The value(s) of the N_min, N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

In another example, an instance for the fifth event (Event-5) could comprise component(s) related/corresponding to an instance for the fourth event (Event-4), and/or an instance for the fifth event (Event-5) could comprise, include or contain an instance for the fourth event (Event-4), and/or detection, determination or identification of the fifth event (Event-5) could be according to or based on component(s) related/corresponding to at least an instance for the fourth event (Event-4). In this case, (a) when/if Event-5 based UE-initiated/event-driven beam reporting is enabled—e.g., the UE could be provided/configured by the network, e.g., in higher layer parameter(s) CSI-ReportConfig, CSI-ResourceConfig, UEI-ReportConfig and/or UEI-ResourceConfig that provides necessary information or setting(s) for the corresponding UE-initiated/event-driven beam reporting, a higher layer parameter eventFiveConfig (e.g., set to ‘enabled’) and/or a higher layer parameter eventType set to ‘Event-5’, and/or (b) when/if the UE has determined or identified or detected that within a time window/period/gap/offset, a number of instances of the fifth event (denoted by N_5) according to or following those specified/defined herein in the present disclosure that have at least one same candidate/new beam determined/identified during the measurement instance(s)/occasion(s) is greater than or equal to a minimum value/number denoted by N_min, and/or (c) when/if the UE has determined or identified or detected an instance of the fifth event (i.e., an Event-5 instance) according to or following those specified/defined herein in the present disclosure and a candidate/new beam, the UE could increase a number of count in a counter (e.g., specific to the Event-5 or the Event-5 instance or the candidate/new beam) by 1 and/or when/if the number of counts (denoted by N_5) in the counter reaches to a maximum number of counts denoted by N_max before a timer (e.g., specific to the Event-5 or the Event-5 instance or the candidate/new beam) has expired, the UE could declare (occurrence of) the fifth event (i.e., the Event-5), and initiate/trigger the corresponding beam reporting. For (c), the corresponding MAC entity could or shall for each Serving Cell configured for UE-initiated (UEI)/event-driven reporting according to those specified herein in the present disclosure:
1> to initiate or trigger a UEI/event-driven reporting based on or according to detection or declaration of the fifth event (or the Event-5):
   2> if an indication for an instance for the fifth event or Event-5 as specified/defined herein in the present disclosure has been received from lower layers, and/or
   2> if an indication for a candidate/new beam determined/identified for the instance for the fifth event or Event-5 has been received from lower layers:
      3> start or restart the fifthEventInstanceDetectionTimer (higher layer configured for the fifth event—when/if applicable)
   2> if an indication for another instance for the fifth event or Event-5 as specified/defined herein in the present disclosure has been received from lower layers, and/or
   2> if an indication for the (same) candidate/new beam determined/identified for the other instance for the fifth event or Event-5 has been received from lower layers:
      3> increment fifthEvent_COUNTER (higher layer configured for the fifth event—when/if applicable) by 1;
      3> if fifthEvent_COUNTER>=fifthEventInstanceMaxCount or N_max (configured for the fifth event—when/if applicable), wherein the fifthEventInstanceMaxCount or N_max is higher layer configured for the fifth event—when/if applicable:
         4> trigger a UEI (beam) reporting corresponding/specific to the fifth event—when/if applicable—for this Serving Cell.
   2> if the fifihEventInstanceDetectionTimer (for the fifth event—when/if applicable) expires; and/or
   2> if the fifihEventInstanceDetectionTimer (for the fifth event—when/if applicable), fifthEvent_COUNTER (for the fifth event—when/if applicable), or any of the reference signals used for UEI reporting—e.g., including that/those specific to/for the current serving beam(s) and/or the candidate beam(s) as specified or defined herein in the present disclosure specific to/for the fifth event—is reconfigured by upper layers associated with this Serving Cell; and/or
   2> if the reference signal(s) associated with this Serving Cell used for detection/declaration/indication for the fifth event as specified/defined herein in the present disclosure is changed and/or reconfigured by upper layers associated with this Serving Cell; and/or
   2> if the UE has received or detected or determined or identified a network's response to the UE-initiated/event-driven beam reporting corresponding/specific to the fifth event—when/if applicable—for this Serving Cell:
      3> set fifthEvent_COUNTER (for the fifth event—when/if applicable) to 0; and/or
      3> stop fifthEventInstanceDetectionTimer (for the fifth event—when/if applicable); and/or
      3> stop the ueiReportingTimer, if configured; and/or
      3> consider the UE-initiated (UEI) reporting procedure triggered or initiated with respect to the fifth event successfully completed, and/or cancel the UEI report(s) triggered or initiated with respect to at least the fifth event for this Serving Cell.

The value(s) of the N_min, N_max, time window/period/gap/offset and/or etc. as specified/defined herein in the present disclosure could be determined or identified according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.

Furthermore, the network's response to the UE-initiated/event-driven reporting corresponding/specific to the fifth event (or the Event-5) could be in form of or could comprise one or more of the following components:
A PDCCH reception in a search space set provided by beamReportingEventFiveSearchSpaceId for which the UE could detect a DCI format with CRC scrambled by C-RNTI or MCS-C-RNTI
A PDCCH reception that determines completion of a contention based random access procedure (e.g., if a MAC CE is used to carry or convey or transmit or send the corresponding (UEI or event-driven or LTM based) beam report(s), and the MAC CE is provided in Msg3 or MsgA of contention based random access procedure)
A PDCCH reception with a DCI format scheduling a PUSCH transmission with a same HARQ process number as for the transmission of a PUSCH used for carrying, conveying, transmitting or sending the corresponding (UEI or event-driven or LTM based) beam report(s) and having a toggled NDI field value
A one-bit indicator set to ‘1’ (or ‘0’) or an ACK provided/indicated in a DCI format (e.g., DCI format 0_0, 0_1, 0_2, 0_3, 1_0, 1_1, 1_2, 1_3, and/or etc.)
TCI state(s) update/indication via a MAC CE activation/deactivation command or a DCI (e.g., DCI format
1_1/1_2 with or without DL assignment and/or DCI format 1_3) or a MAC CE cell switch command (CSC), wherein the updated/indicated TCI state(s) could correspond to beam(s) (or RS(s)) reported by the UE in the UE-initiated/event-driven beam report(s)
TCI state(s) activation/deactivation via a MAC CE activation/deactivation command or a MAC CE CSC, wherein the activated/deactivated TCI state(s) could correspond to beam(s) (or RS(s)) reported by the UE in the UE-initiated/event-driven beam report(s)
TCI state(s) (re-)configuration provided by RRC signaling(s), e.g., via DLorJoint-TCIState-List or UL-TCIState-List, wherein the (re-)configured/provided TCI state(s) could correspond to beam(s) (or RS(s)) reported by the UE in the UE-initiated/event-driven beam report(s)
A non-zero CSI request field (and therefore, a corresponding trigger state) in a DCI (e.g., of a DCI format 0_1 or 0_2)
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘on’
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter repetition set to ‘off’ or without the higher layer parameter repetition (or equivalently, the higher layer parameter repetition is not present or is absent)
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet with the higher layer parameter trs-Info
CSI-RS(s) or CSI-RS resource(s), e.g., AP/SP CSI-RS(s) or CSI-RS resource(s), triggered/activated by a trigger state associated/corresponding to a non-zero CSI request field in a DCI (e.g., of a DCI format 0_1 or 0_2), wherein the CSI-RS(s) or CSI-RS resource(s) could be associated with a NZP-CSI-RS-ResourceSet without the higher layer parameter trs-Info (or equivalently, the higher layer parameter trs-Info is not present or is absent)

Furthermore, the network's response to the UE-initiated/event-driven reporting corresponding/specific to the fifth event (or the Event-5) and/or the medium/container such as RRC signaling(s), MAC CE command(s) and/or DCI format(s) used to carry/convey the network's response to the UE-initiated/event-driven reporting corresponding/specific to the fifth event (or the Event-5) could be received/detected within a time window/period/gap/offset after the last symbol/slot/etc. of the transmission of the corresponding UEI/event-driven beam report(s), wherein the time window/period/gap/offset could be determined or identified based on or according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. When/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), the fifth event or the Event-5 as described/specified herein could be denoted by or referred to as a fifth LTM event or a LTM Event-5. For the fifth LTM event or the LTM Event-5, the one or more current serving beams (or equivalently, the RS(s)/RS resource(s)/RS resource index(es) corresponding to/of the one or more current serving beams or the current serving beam RS(s)/RS resource(s)/RS resource index(es)) could be associated to one or more PCIs and/or one or more candidate cells (e.g., a serving cell PCI and/or a serving cell), wherein a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s). In addition, the indicated joint/DL/UL TCI state(s) could correspond to the joint/DL/UL TCI state(s) provided/indicated by/in a cell switch command (CSC) for a PCI or a candidate cell via MAC CE signaling(s).

As specified/discussed herein in the present disclosure, a UE could indicate or send or transmit to the network a capability signaling indicating whether or not the UE can support one or more of the events as specified herein in the present disclosure. For instance, the corresponding capability or capability signaling could comprise one or more of the following components—i.e., if the corresponding capability or capability signaling comprises (Event-1, Event-4), the UE could indicate or send or transmit to the network that they could support or could be capable of supporting the Event-1 and Event-4 in the present disclosure:
{Event-1}; {Event-2}; {Event-3}; {Event-4}; {Event-5};
{Event-1, Event-2}; {Event-1, Event-3}; {Event-1, Event-4}; {Event-1, Event-5}; {Event-2, Event-3}; {Event-2, Event-4}; {Event-2, Event-5}; {Event-3, Event-4}; {Event-3, Event-5}; {Event-4, Event-5};
{Event-1, Event-2, Event-3}; {Event-1, Event-2, Event-4}; {Event-1, Event-2, Event-5}; {Event-1, Event-3, Event-4}; {Event-1, Event-3, Event-5}; {Event-1, Event-4, Event-5}; {Event-2, Event-3, Event-4}; {Event-2, Event-3, Event-5}; {Event-2, Event-4, Event-5}; {Event-3, Event-4, Event-5};
{Event-1, Event-2, Event-3, Event-4}; {Event-1, Event-2, Event-3, Event-5}; {Event-1, Event-3, Event-4, Event-5}; {Event-2, Event-3, Event-4, Event-5}; or
{Event-1, Event-2, Event-3, Event-4, Event-5}

Furthermore, UEs that could or would support the UE-initiated or event-driven reporting should support or indicate their support of one or more of the events—such as Event-4; i.e., the one or more of the events—such as Event-4 in the present disclosure—could be specified or regarded as basic UE feature(s). The UE (e.g., the UE 116) could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as discussed herein, that one or more (e.g., only one or more than one) of the events (e.g., Event-1 and/or Event-4) can be enabled. For instance, a higher layer parameter eventType could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting, and/or in the higher layer parameter(s) LTM-Config, LTM-CSI-ResourceConfig, LTM-CSI-ReportConfig and/or etc. that provides or configures information or settings for the L1/L2 triggered mobility (LTM) operation(s). For example, when/if the eventType is set to ‘Event-1’ or ‘one’ or ‘1’ or ‘first’ or ‘enabled’ (or ‘disabled’) or 1 (or 0), the Event-1 as specified/described herein in the present disclosure is enabled; and when/if the eventType is set to ‘Event-4’ or ‘four’ or ‘4’ or ‘fourth’ or ‘two’ or ‘2’ or ‘second’ or ‘disabled’ (or ‘enabled’) or 0 (or 1), the Event-4 as specified/described herein in the present disclosure is enabled. For another example, when/if the eventType is set to ‘Event-1 and Event-4’ or ‘one and four’ or ‘1 and 4’ or ‘first and fourth’ or ‘enabled’ (or ‘disabled’) or 1 (or 0) or ‘00’ (or ‘01’ or ‘10’ or ‘11’), both the Event-1 and Event-4 as specified/defined herein in the present disclosure are enabled. Throughout the present disclosure, discussions, descriptions, specifications and etc. for when one/an event (e.g., Event-1 or Event-4) is enabled (e.g., detection, declaration, triggering and etc. of the event) can be equally applied or extended to when more than one events (e.g., both Event-1 and Event-4) are enabled (e.g., detection, declaration, triggering and etc. of the more than one events).

According to those specified herein in the present disclosure, when/if more than one events are enabled or a UE is configured/provided/indicated by the network that more than one events (including which events in terms/form of their event IDs/indexes) are enabled, the UE could initiate or trigger the corresponding beam reporting following one or more of:
In one example, the UE could individually or separately declare (occurrence of) each of the more than one events according to or following those specified/described herein in the present disclosure. For this design example, when/if there is no ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s), and/or when/if there is ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s), and/or when/if the UE has declared (occurrence of) an event (i.e., out of the enabled more than one events), the UE could initiate or trigger the corresponding beam reporting with respect to the declared event.
   When/if the UE has declared (occurrence of) an event, and/or when/if the UE has initiated or triggered or started a beam reporting with respect to the declared event, and/or when/if the beam reporting is ongoing/in progress (e.g., before receiving or detecting network's response(s) to the beam reporting according to or following those specified herein in the present disclosure), the UE could stop monitoring other event(s) than the declared event or instance(s) of other event(s) than the declared event, and/or stop declaring or detecting (occurrence(s) of) other event(s) than the declared event, and/or stop initiating or triggering or starting any beam reporting(s) with respect to other event(s) than the declared event.
   When/if the UE has declared (occurrence of) an event, and/or when/if the UE has initiated or triggered or started a beam reporting with respect to the declared event, and/or when/if the beam reporting is ongoing/in progress (e.g., before receiving or detecting network's response(s) to the beam reporting according to or following those specified herein in the present disclosure), the UE could still declare (occurrence of) another event (i.e., out of the enabled more than one events but different from the previously declared event), and initiate or trigger the corresponding beam reporting with respect to the declared another event. In this case, the UE could indicate or send to the network (e.g., the network 130), e.g., in a/the beam/CSI report triggered or initiated with respect to declaration of an event, an event ID/index (e.g., out of the enabled events) for/of the declared event.
   When/if the UE has declared (occurrence of) an event—denoted by event A here, and/or when/if the UE has initiated or triggered or started a beam reporting with respect to the declared event A, and/or when/if the beam reporting is ongoing/in progress (e.g., before receiving or detecting network's response(s) to the beam reporting according to or following those specified herein in the present disclosure), the UE could still declare (occurrence of) another event (i.e., out of the enabled more than one events but different from the previously declared event A)—denoted by event B here, and initiate or trigger the corresponding beam reporting with respect to the declared another event B. In this case, the UE could indicate or send to the network, e.g., in a/the beam/CSI report triggered or initiated with respect to declaration of an event (e.g., the event A or event B), an event ID/index, e.g., for/of the event A or event B, (e.g., out of the enabled events) for/of the declared event (e.g., the event A or event B). Furthermore, the UE could declare (occurrences of) of both the event A and event B simultaneously or at the same time (e.g., in or at the same slot/symbol/etc.); in this case, the UE could initiate or trigger a/the same beam reporting with respect to both the declared event A and event B such that the report content(s)/quantity(s) in the initiated/triggered beam report could be specific/associated to both the declared event A and event B; according to or following those specified herein in the present disclosure, the UE could indicate or send to the network, in the initiated/triggered beam/CSI report specific/associated to both the declared event A and event B, event IDs/indexes (e.g., out of the enabled events) for/of the declared event A and event B.
In another example, the UE could individually or separately declare (occurrence of) each of the more than one events according to or following those specified/described herein in the present disclosure. For this design example, when/if there is no ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s), and/or when/if there is ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s), and/or when/if the UE has declared (occurrence of) an event (i.e., out of the enabled more than one events)—denoted by event A here, the UE could start a timer (configured for the event—when/if applicable) with respect to or specific to the event A.
   Before the timer expires, the UE could stop monitoring other event(s) than the declared event A or instance(s) of other event(s) than the declared event A, and/or stop declaring or detecting (occurrence(s) of) other event(s) than the declared event A, and/or stop initiating or triggering or starting any beam reporting(s) with respect to other event(s) than the declared event A.
   Before the timer expires, the UE could still declare (occurrence of) another event (i.e., out of the enabled more than one events but different from the previously declared event A)—denoted by event B here. In this case, the UE could separately or respectively or individually initiate or trigger a first beam reporting corresponding/with respect to the declared event A—i.e., the report content(s)/quantity(s) in the first beam reporting/report could be specific/associated to the declared event A, and a second beam reporting corresponding/with respect to the declared event B—i.e., the report content(s)/quantity(s) in the second beam reporting/report could be specific/associated to the declared event B. Optionally, the UE could indicate or send to the network, e.g., in a/the beam/CSI report triggered or initiated with respect to declaration of an event, an event ID/index (e.g., out of the enabled events) for/of the declared event. In this case, the UE could indicate or send to the network, in the first (or second) beam reporting/report triggered or initiated with respect to declaration of the event A (or event B), an event ID/index (e.g., out of the enabled events) for/of the event A (or event B). The UE could declare (occurrences of) of the event A and event B simultaneously or at the same time (e.g., at or in the same symbol/slot/etc.), or at or in different (time) symbols/slots/etc.
   Before the timer expires, the UE could still declare (occurrence of) another event (i.e., out of the enabled more than one events but different from the previously declared event A)—denoted by event B here. In this case, the UE could initiate or trigger a/the same (or joint) beam reporting corresponding/with respect to both the declared event A and event B—i.e., the report content(s)/quantity(s) in the initiated/triggered (joint) beam reporting/report could be specific/associated to both the declared event A and event B. Optionally, the UE could indicate or send to the network, e.g., in a/the beam/CSI report triggered or initiated with respect to declaration of an event, an event ID/index (e.g., out of the enabled events) for/of the declared event. In this case, the UE could indicate or send to the network, in the initiated/triggered (joint) beam/CSI report specific/associated to both the declared event A and event B, event IDs/indexes (e.g., out of the enabled events) for/of the declared event A and event B. The UE could declare (occurrences of) of the event A and event B simultaneously or at the same time (e.g., at or in the same symbol/slot/etc.), or at or in different (time) symbols/slots/etc.

After the timer has expired, the UE could initiate or trigger or start a beam reporting corresponding/with respect to at least the declared event A—i.e., the report content(s)/quantity(s) in the initiated/triggered beam reporting/report could be specific/associated to at least the event A; in this case, the UE may not declare or detect any additional event(s) other than the event A before the timer expires. Under certain setting(s) or deployment scenario(s)—e.g., configured/enabled by the network subject to or based on or according to a corresponding UE's capability or capability signaling, when/if the UE has started the timer, the UE may stop the timer (i.e., the timer would not expire, or the length of the timer would be infinite).

In another example, the UE could individually or separately declare (occurrence of) each of the more than one events according to or following those specified/described herein in the present disclosure. For this design example, when/if there is no ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s), and/or when/if there is ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s), and/or when/if the UE has declared (occurrence of) an event (i.e., out of the enabled more than one events)—denoted by event A here,
Within a time window/period/offset/gap—e.g., starting from the first/last symbol/slot/etc. of declaration/detection of the event A, the UE could stop monitoring other event(s) than the declared event A or instance(s) of other event(s) than the declared event A, and/or stop declaring or detecting (occurrence(s) of) other event(s) than the declared event A, and/or stop initiating or triggering or starting any beam reporting(s) with respect to other event(s) than the declared event A.
Within a time window/period/offset/gap—e.g., starting from the first/last symbol/slot/etc. of declaration/detection of the event A, the UE could still declare (occurrence of) another event (i.e., out of the enabled more than one events but different from the previously declared event A)—denoted by event B here. In this case, the UE could separately or respectively or individually initiate or trigger a first beam reporting corresponding/with respect to the declared event A—i.e., the report content(s)/quantity(s) in the first beam reporting/report could be specific/associated to the declared event A, and a second beam reporting corresponding/with respect to the declared event B—i.e., the report content(s)/quantity(s) in the second beam reporting/report could be specific/associated to the declared event B. Optionally, the UE could indicate or send to the network, e.g., in a/the beam/CSI report triggered or initiated with respect to declaration of an event, an event ID/index (e.g., out of the enabled events) for/of the declared event. In this case, the UE could indicate or send to the network, in the first (or second) beam reporting/report triggered or initiated with respect to declaration of the event A (or event B), an event ID/index (e.g., out of the enabled events) for/of the event A (or event B). The UE could declare (occurrences of) of the event A and event B simultaneously or at the same time (e.g., at or in the same symbol/slot/etc.), or at or in different (time) symbols/slots/etc.
Within a time window/period/offset/gap—e.g., starting from the first/last symbol/slot/etc. of declaration/detection of the event A, the UE could still declare (occurrence of) another event (i.e., out of the enabled more than one events but different from the previously declared event A)—denoted by event B here. In this case, the UE could initiate or trigger a/the same (joint) beam reporting corresponding/with respect to both the declared event A and event B—i.e., the report content(s)/quantity(s) in the initiated/triggered (joint) beam reporting/report could be specific/associated to both the declared event A and event B. Optionally, the UE could indicate or send to the network, e.g., in a/the beam/CSI report triggered or initiated with respect to declaration of an event, an event ID/index (e.g., out of the enabled events) for/of the declared event. In this case, the UE could indicate or send to the network, in the initiated/triggered (joint) beam/CSI report specific/associated to both the declared event A and event B, event IDs/indexes (e.g., out of the enabled events) for/of the declared event A and event B. The UE could declare (occurrences of) of the event A and event B simultaneously or at the same time (e.g., at or in the same symbol/slot/etc.), or at or in different (time) symbols/slots/etc.

For this design example, the value(s) of the time window/period/offset/gap could be determined according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. After the last symbol/slot/etc. of the time window/period/offset/gap, the UE could initiate or trigger or start a beam reporting corresponding/with respect to at least the declared event A—i.e., the report content(s)/quantity(s) in the initiated/triggered beam reporting/report could be specific/associated to at least the event A; in this case, the UE may not declare or detect any additional event(s) other than the event A within the time window/period/offset/gap. Under certain setting(s) or deployment scenario(s)—e.g., configured/enabled by the network subject to or based on or according to a corresponding UE's capability or capability signaling, the length/value of the time window/period/offset/gap could be infinite.

In another example, the UE could individually or separately declare (occurrence of) each of the more than one events according to or following those specified/described herein in the present disclosure. For this design example, when/if there is no ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s), and/or when/if there is ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s),
When/if the UE has declared (occurrences of) the enabled more than one events according to or following those specified herein in the present disclosure, the UE could initiate or trigger or start a/the same (or joint) beam reporting corresponding/with respect to the enabled events—i.e., the report content(s)/quantity(s) in the initiated/triggered (joint) beam reporting/report could be specific/associated to the enabled events; otherwise, i.e., when/if the UE could not declare (occurrence of) at least one of the enabled more than one events according to or following those specified herein in the present disclosure, the UE may not initiate or trigger or start any beam reporting. The UE could declare (occurrences of) of the enabled more than one events simultaneously or at the same time (e.g., at or in the same symbol/slot/etc.), or at or in different (time) symbols/slots/etc.
When/if the UE has declared (occurrence of) an event (i.e., out of the enabled more than one events)—denoted by event A here, the UE could start a timer (configured for the event—when/if applicable), e.g., specific to the event A. Before the timer expires, when/if the UE has declared (occurrences of) the enabled more than one events (including the event A) according to or following those specified herein in the present disclosure, the UE could initiate or trigger or start a/the same (or joint) beam reporting corresponding/with respect to the enabled events—i.e., the report content(s)/quantity(s) in the initiated/triggered (joint) beam reporting/report could be specific/associated to the enabled events, and/or stop the timer; otherwise, i.e., when/if the timer has expired, and/or when/if the UE could not declare (occurrence of) at least one of the enabled more than one events according to or following those specified herein in the present disclosure before the timer expires, the UE may not initiate or trigger or start any beam reporting. The UE could declare (occurrences of) of the enabled more than one events simultaneously or at the same time (e.g., at or in the same symbol/slot/etc.), or at or in different (time) symbols/slots/etc. Optionally, under certain setting(s) or deployment scenario(s)—e.g., configured/enabled by the network subject to or based on or according to a corresponding UE's capability or capability signaling, when/if the UE has started the timer, the UE may stop the timer (i.e., the timer would not expire, or the length of the timer would be infinite).
When/if the UE has declared (occurrence of) an event (i.e., out of the enabled more than one events)—denoted by event A here, and when/if the UE has declared (occurrences of) the enabled more than one events (including the event A) according to or following those specified herein in the present disclosure within a time window/period/offset/gap—e.g., starting from the first/last symbol/slot/etc. of declaration/detection of the event A, the UE could initiate or trigger or start a/the same (or joint) beam reporting corresponding/with respect to the enabled events—i.e., the report content(s)/quantity(s) in the initiated/triggered (joint) beam reporting/report could be specific/associated to the enabled events; otherwise, i.e., when/if the UE could not declare (occurrence of) at least one of the enabled more than one events according to or following those specified herein in the present disclosure within the time window/period/offset/gap—e.g., starting from the first/last symbol/slot/etc. of declaration/detection of the event A, the UE may not initiate or trigger or start any beam reporting. The UE could declare (occurrences of) of the enabled more than one events simultaneously or at the same time (e.g., at or in the same symbol/slot/etc.), or at or in different (time) symbols/slots/etc. For this design example, the value(s) of the time window/period/offset/gap could be determined according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Under certain setting(s) or deployment scenario(s)—e.g., configured/enabled by the network subject to or based on or according to a corresponding UE's capability or capability signaling, the length/value of the time window/period/offset/gap could be infinite.

In another example, the UE could individually or separately declare (occurrence of) each of the more than one events according to or following those specified/described herein in the present disclosure. For this design example, when/if there is no ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s), and/or when/if there is ongoing/in progress beam reporting (e.g., before receiving or detecting network's response(s) to the beam reporting according to or following those specified herein in the present disclosure), wherein the beam reporting could be triggered/initiated by the UE based on declaration/detection of an event and/or based on LTM triggering condition(s),
When/if the UE has declared (occurrences of) one or more of the enabled more than one events—denoted by one or more enabled events here—according to or following those specified herein in the present disclosure, the UE could initiate or trigger or start a/the same (or joint) beam reporting corresponding/with respect to the one or more enabled events—i.e., the report content(s)/quantity(s) in the initiated/triggered (joint) beam reporting/report could be specific/associated to the one or more enabled events as defined herein; otherwise, i.e., when/if the UE could not declare (occurrence of) at least one of the one or more enabled events according to or following those specified herein in the present disclosure, the UE may not initiate or trigger or start any beam reporting, e.g., with respect to the one or more enabled events. The UE could declare (occurrences of) of the one or more enabled events simultaneously or at the same time (e.g., at or in the same symbol/slot/etc.), or at or in different (time) symbols/slots/etc.
When/if the UE has declared (occurrence of) an event (here, the event could be from one or more of the enabled more than one events, wherein the one or more of the enabled more than one events could be denoted by one or more enabled events)—denoted by event A here, the UE could start a timer (configured for the event and/or the one or more enabled events—when/if applicable), e.g., specific to the event A and/or the one or more enabled events as defined herein. Before the timer expires, when/if the UE has declared (occurrences of) the one or more enabled events (including the event A) according to or following those specified herein in the present disclosure, the UE could initiate or trigger or start a/the same (or joint) beam reporting corresponding/with respect to the one or more enabled events as defined herein—i.e., the report content(s)/quantity(s) in the initiated/triggered (joint) beam reporting/report could be specific/associated to the one or more enabled events, and/or stop the timer; otherwise, i.e., when/if the timer has expired, and/or when/if the UE could not declare (occurrence of) at least one of the one or more enabled events according to or following those specified herein in the present disclosure before the timer expires, the UE may not initiate or trigger or start any beam reporting, e.g., with respect to the one or more enabled events. The UE could declare (occurrences of) of the one or more enabled events simultaneously or at the same time (e.g., at or in the same symbol/slot/etc.), or at or in different (time) symbols/slots/etc. Optionally, under certain setting(s) or deployment scenario(s)—e.g., configured/enabled by the network subject to or based on or according to a corresponding UE's capability or capability signaling, when/if the UE has started the timer, the UE may stop the timer (i.e., the timer would not expire, or the length of the timer would be infinite).
When/if the UE has declared (occurrence of) an event (here, the event could be from one or more of the enabled more than one events, wherein the one or more of the enabled more than one events could be denoted by one or more enabled events)—denoted by event A here, and when/if the UE has declared (occurrences of) the one or more enabled events as defined herein (including the event A) according to or following those specified herein in the present disclosure within a time window/period/offset/gap—e.g., starting from the first/last symbol/slot/etc. of declaration/detection of the event A, the UE could initiate or trigger or start a/the same (or joint) beam reporting corresponding/with respect to the one or more enabled events as defined/specified herein—i.e., the report content(s)/quantity(s) in the initiated/triggered (joint) beam reporting/report could be specific/associated to the one or more enabled events; otherwise, i.e., when/if the UE could not declare (occurrence of) at least one of the one or more enabled events according to or following those specified herein in the present disclosure within the time window/period/offset/gap—e.g., starting from the first/last symbol/slot/etc. of declaration/detection of the event A, the UE may not initiate or trigger or start any beam reporting, e.g., with respect to the one or more enabled events. The UE could declare (occurrences of) of the one or more enabled events simultaneously or at the same time (e.g., at or in the same symbol/slot/etc.), or at or in different (time) symbols/slots/etc. For this design example, the value(s) of the time window/period/offset/gap could be determined according to: (1) fixed value(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Under certain setting(s) or deployment scenario(s)—e.g., configured/enabled by the network subject to or based on or according to a corresponding UE's capability or capability signaling, the length/value of the time window/period/offset/gap could be infinite.

The UE (e.g., the UE 116) could determine or identify the one or more enabled events—e.g., in form/terms of their event IDs/indexes out of the enabled more than one events—according to or based on: (1) fixed rule(s)/setting(s) in system specification(s) and/or per RRC (re)configuration, e.g., the first and fourth events (i.e., the Event-1 and Event-4) as specified/defined herein in the present disclosure (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network (e.g., the network 130) via various UL channels/signals including CSI/beam report(s) and/or UE's capability signaling.

In one example, when/if the first and fourth events (i.e., the Event-1 and Event-4) are enabled, and/or when/if the one or more enabled events as defined herein in the present disclosure correspond to the first and fourth events (i.e., the Event-1 and Event-4), and/or when/if both of the first and fourth events (i.e., both of the Event-1 and Event-4) are accounted for initiating or triggering or starting a beam reporting according to or following those specified herein in the present disclosure, an example MAC entity could or shall for each Serving Cell configured for UE-initiated (UEI)/event-driven reporting according to those specified herein in the present disclosure:
1> to initiate or trigger a UEI/event-driven reporting based on or according to detection or declaration of the first and fourth events (or the Event-1 and Event-4):
   2> if an indication for an instance for the first event or Event-1 as specified/defined herein in the present disclosure has been received from lower layers:
      3> start or restart thefirstEventInstanceDetectionTimer (higher layer configured for the first event—when/if applicable)
      3> increment firstEvent_COUNTER (higher layer configured for the first event—when/if applicable) by 1; 2> if an indication for an instance for the fourth event or Event-4 as specified/defined herein in the present disclosure has been received from lower layers, and/or
   2> if an indication for a candidate/new beam determined/identified for the instance for the fourth event or Event-4 has been received from lower layers:
      3> start or restart the fourthEventInstanceDetectionTimer (higher layer configured for the fourth event—when/if applicable)
   2> if an indication for another instance for the fourth event or Event-4 as specified/defined herein in the present disclosure has been received from lower layers, and/or
   2> if an indication for the (same) candidate/new beam determined/identified for the other instance for the fourth event or Event-4 has been received from lower layers:
      3> increment fourthEvent_COUNTER (higher layer configured for the fourth event—when/if applicable) by 1;
   2> if firstEvent_COUNTER>=firstEventInstanceMaxCount or N_max (configured for the first event—when/if applicable), wherein the firstEventInstanceMaxCount or N_max is higher layer configured for the first event—when/if applicable, and/or if fourthEvent_COUNTER>=fourthEventInstanceMaxCount or N_max (configured for the fourth event—when/if applicable), wherein the fourthEventInstanceMaxCount or N_max is higher layer configured for the fourth event—when/if applicable:
      3> trigger a UEI (beam) reporting specific to the first and fourth events for this Serving Cell, wherein the report content(s)/quantity(s) in the UEI report(s) is specific to the first and fourth events—when/if applicable—according to or following those specified herein in the present disclosure.
   2> if thefirstEventInstanceDetectionTimer (for the first event—when/if applicable) expires; and/or
   2> if thefirstEventInstanceDetectionTimer (for the first event—when/if applicable), firstEvent_COUNTER (for the first event—when/if applicable), or any of the reference signals used for UEI reporting—e.g., including that/those specific to/for the current serving beam(s) and/or the candidate beam(s) as specified or defined herein in the present disclosure specific to/for the first event—is reconfigured by upper layers associated with this Serving Cell; and/or
   2> if the reference signal(s) associated with this Serving Cell used for detection/declaration/indication for the first event as specified/defined herein in the present disclosure is changed and/or reconfigured by upper layers associated with this Serving Cell:
      3> set firstEvent_COUNTER (for the first event—when/if applicable) to 0; and/or
      3> stop firstEventInstanceDetectionTimer (for the first event—when/if applicable); and/or
   2> if the fourthEventInstanceDetectionTimer (for the fourth event—when/if applicable) expires; and/or
   2> if the fourthEventInstanceDetectionTimer (for the fourth event—when/if applicable), fourthEvent_COUNTER (for the fourth event—when/if applicable), or any of the reference signals used for UEI reporting—e.g., including that/those specific to/for the current serving beam(s) and/or the candidate beam(s) as specified or defined herein in the present disclosure specific to/for the fourth event—is reconfigured by upper layers associated with this Serving Cell; and/or
   2> if the reference signal(s) associated with this Serving Cell used for detection/declaration/indication for the fourth event as specified/defined herein in the present disclosure is changed and/or reconfigured by upper layers associated with this Serving Cell:
      3> set fourthEvent_COUNTER (for the fourth event—when/if applicable) to 0; and/or
      3> stop fourthEventInstanceDetectionTimer (for the fourth event—when/if applicable); and/or
   2> if the UE has received or detected or determined or identified a network's response to the UE-initiated/event-driven beam reporting corresponding/specific to the first and fourth events—when/if applicable—for this Serving Cell:
      3> stop the ueiReportingTimer, if configured; and/or
      3> consider the UE-initiated (UEI) reporting procedure triggered or initiated with respect to the first and fourth events successfully completed, and/or cancel the UEI report(s) triggered or initiated with respect to at least the first and fourth events for this Serving Cell

In another example, when/if the first and second events (i.e., the Event-1 and Event-2) are enabled, and/or when/if the one or more enabled events as defined herein in the present disclosure correspond to the first and second events (i.e., the Event-1 and Event-2), and/or when/if both of the first and second events (i.e., both of the Event-1 and Event-2) are accounted for initiating or triggering or starting a beam reporting according to or following those specified herein in the present disclosure, an example MAC entity could or shall for each Serving Cell configured for UE-initiated (UEI)/event-driven reporting according to those specified herein in the present disclosure:
1> to initiate or trigger a UEI reporting based on or according to detection or declaration of the first and second events:
   2> if an indication for an instance for the first event has been received from lower layers, and/or if an indication for an instance for the second event has been received from lower layers:
      3> start or restart the firstEventnstanceDetectionTimer and/or secondEventnstanceDetectionTimer (higher layer configured for the first and/or second event(s)—when/if applicable)
      3> increment firstEvent_COUNTER and/or secondEvent_COUNTER (higher layer configured for the first and/or second event(s)—when/if applicable) by 1;
      3> if both firstEvent_COUNTER>=firstEventInstanceMaxCount and secondEvent_COUNTER>=secondEventInstanceMaxCount (for the first and second events—when/if applicable), wherein the firstEventInstanceMaxCount and secondEventInstanceMaxCount are higher layer configured respectively for the first and second events—when/if applicable:
         4> trigger a UEI (beam) reporting specific to the first and second events for this Serving Cell, wherein the report content(s)/quantity(s) in the UEI report(s) is specific to the first and second events—when/if applicable—according to or following those specified herein in the present disclosure.
   2> if the firstEventInstanceDetectionTimer and/or secondEventInstanceDetectionTimer (respectively for the first and/or second event(s)—when/if applicable) expires; and/or
   2> if the firstEventInstanceDetectionTimer and/or secondEventInstanceDetectionTimer (respectively for the first and/or second event(s)—when/if applicable), firstEvent_COUNTER and/or secondEvent_COUNTER (respectively for the first and/or second event(s)—when/if applicable), or any of the reference signals used for UEI reporting—e.g., including that/those specific to/for the current serving beam(s) and/or the candidate beam(s) as specified or defined herein in the present disclosure for the first and/or second event(s)—is reconfigured by upper layers associated with this Serving Cell; and/or
   2> if the reference signal(s) associated with this Serving Cell used for detection/declaration/indication for the first and/or second event(s) as specified/defined herein in the present disclosure is changed and/or reconfigured by upper layers associated with this Serving Cell:
      3> set firstEvent_COUNTER and/or secondEvent_COUNTER (respectively for the first and/or second event(s)—when/if applicable) to 0; and/or
      3> stop the ueiReportingTimer, if configured; and/or
      3> consider the UE-initiated (UEI) reporting procedure triggered or initiated with respect to both the first and second events successfully completed, and/or cancel the UEI report(s) triggered or initiated with respect to at least the first and second events for this Serving Cell.

The described/specified MAC entity(s) and the corresponding operation(s)/procedure(s) herein could be applied or extended to when/if more than two events are configured and/or enabled by the network and/or applied or used by the UE for initiating or triggering the UEI reporting.

Throughout the present disclosure, a time window/period/offset/gap could be in a number of symbols/slots/etc., and/or in millisecond (ms). Furthermore, a timer or length of a timer or a timer duration or value of a timer could be in a number of symbols/slots/etc., and/or in millisecond (ms). A UE could report or indicate to the network, e.g., in their capability or capability signaling, whether or not they are capable of supporting those specified/defined in one or more examples described herein in the present disclosure to initiate or trigger the corresponding beam reporting. For instance, the corresponding capability or capability signaling could comprise or indicate support of one or more of the following components:
The procedure(s)/assumption(s) described/specified in one or more examples described herein
Any combination(s) of the design procedure(s)/assumption(s) described/specified in one or more examples described herein Accordingly, a UE could be configured, provided or indicated by the network, e.g., via higher layer RRC signaling(s)/parameter(s) and/or MAC CE command(s) and/or dynamic DCI based L1 signaling(s) based on or according to a corresponding UE's capability/capability signaling, which of the design procedure(s)/assumption(s) in one or more examples described herein in the present disclosure to follow to initiate or trigger the corresponding beam reporting.

Throughout the present disclosure, discussions, descriptions, specifications and etc. related to the first event (Event-1), the second event (Event-2), the third event (Event-3) and the fourth event (Event-4) can be equally applied or extended to the first LTM event (LTM Event-1), the second LTM event (LTM Event-2), the third LTM event (LTM event-3) and the fourth LTM event (LTM event-4), respectively, according to/following those described/specified herein in the present disclosure.

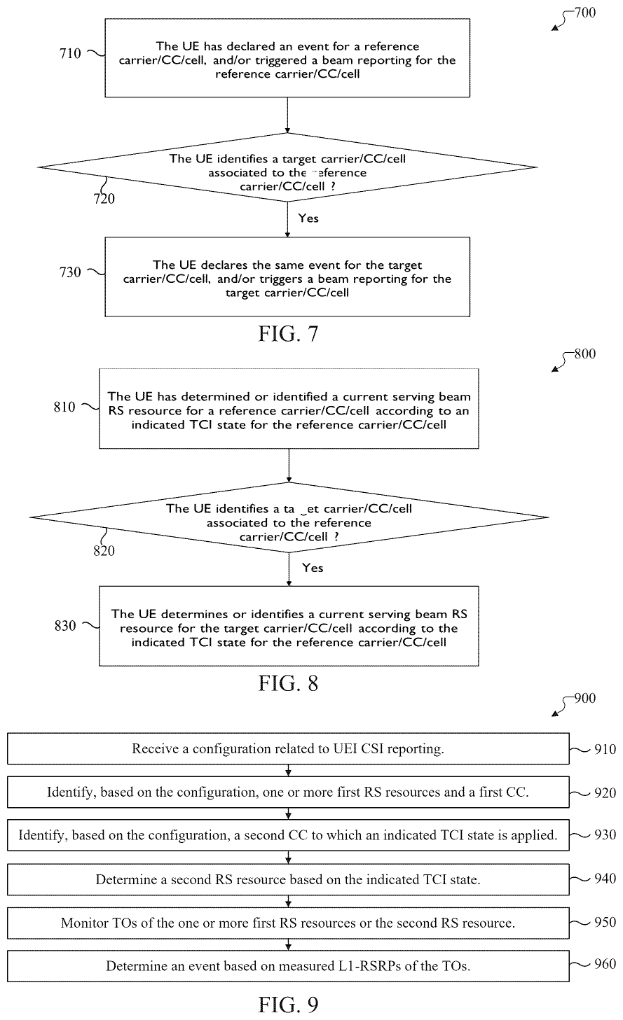

FIG. 7 illustrates a flowchart of an example UE procedure 700 for declaring an event and/or triggering beam reporting according to embodiments of the present disclosure. For example, procedure 700 can be performed by any of the UEs 111-116 of FIG. 1. This example is for illustration only and other embodiments can be used without departing from the scope of the present disclosure.

The procedure begins in 710, a UE has declared an event for a reference carrier/CC/cell, and/or triggered a beam reporting for the reference carrier/CC/cell. In 720, the UE identifies a target carrier/CC/cell associated to the reference carrier/CC/cell. In 730, the UE declares the same event for the target carrier/CC/cell, and/or triggers a beam reporting for the target carrier/CC/cell.

In a multi-carrier or multi-CC or multi-cell system, wherein one or more (e.g., multiple or more than one) carriers and/or component carriers (CCs) and/or cells could be configured, provided and/or enabled by the network, e.g., via higher layer RRC signaling(s)/parameter(s) and/or MAC CE command(s) and/or dynamic DCI based L1 signaling(s) based on or according to a corresponding UE's capability or capability signaling—e.g., when/if a UE is higher layer configured/provided by the network, e.g., in higher layer parameter(s) CSI-ReportConfig, CSI-ResourceConfig, UEI-ReportConfig and/or UEI-ResourceConfig that provides or configures necessary information and/or setting(s) for the corresponding UE-initiated/event-driven beam reporting, one or more lists of carriers (e.g., in terms/form of their carrier IDs/indexes), one or more lists of component carriers (CCs) (e.g., in terms/form of their CC IDs/indexes), and/or one or more lists of cells (e.g., in terms/form of their cell IDs/indexes), for the UE-initiated/event-driven beam operations including beam reporting, and/or when/if a UE is higher layer configured/provided by the network, e.g., in higher layer parameter(s) CSI-ReportConfig, CSI-ResourceConfig, UEI-ReportConfig and/or UEI-ResourceConfig that provides or configures necessary information and/or setting(s) for the corresponding UE-initiated/event-driven beam reporting, higher layer parameter(s) multiCarrierBeamReporting, multiCCBeamReporting, multiCellBeamReporting, crossCarrierBeamReporting, crossCCBeamReporting, crossCellBeamReporting and/or etc. dedicated for enabling the multi-carrier (or cross-carrier), multi-CC (or cross-CC) and/or multi-cell (or cross-cell) beam reporting (e.g., set to ‘enabled’), and/or when/if the UE has declared or detected one or more events according to or following those specified herein in the present disclosure for one or more reference carriers/CCs/cells, and/or triggered or initiated or started corresponding beam reporting for the one or more reference carriers/CCs/cells, the UE could also declare the same one or more events for one or more target carriers/CCs/cells, and/or triggers or initiates or starts corresponding beam reporting for the one or more target carriers/CCs/cells, wherein:
In one example, the one or more reference carriers/CCs/cells and the one or more target carriers/CCs/cells could be provided, configured or enabled (e.g., by the network via higher layer RRC signaling(s)/parameter(s)) in a/the same list/set/pool of carriers/CCs/cells (e.g., in terms/form of their carrier/CC/cell IDs/indexes). For this design example, the UE could determine or identify the one or more reference carriers/CCs/cells, e.g., in terms/form of their carrier/CC/cell IDs/indexes out of the carriers/CCs/cells in a/the same list/set/pool of carriers/CCs/cells, according to or based on or following one or more of:
   For example, the one or more reference carriers/CCs/cells could correspond to any of the carriers/CCs/cells (e.g., in form/terms of their carrier/CC/cell IDs/indexes) in a/the same list/set/pool of carriers/CCs/cells (e.g., in form/terms of their carrier/CC/cell IDs/indexes); when/if (or as long as) the UE declares or detects one or more events according to or following those specified herein in the present disclosure for one or more (reference) carriers/CCs/cells in a list/set/pool of carriers/CCs/cells, and/or triggers or initiates or starts corresponding beam reporting for the one or more (reference) carriers/CCs/cells, the UE could declare the same one or more events for one or more of the rest/remaining carrier(s)/CC(s)/cell(s) in the same list/set/pool of carriers/CCs/cells, and/or trigger or initiate or start corresponding beam reporting for one or more of the rest/remaining carrier(s)/CC(s)/cell(s) in the same list/set/pool of carriers/CCs/cells, wherein the one or more of the rest/remaining carrier(s)/CC(s)/cell(s) in the same list/set/pool of carriers/CCs/cells could be considered, treated or denoted as the target carrier(s)/CC(s)/cell(s).
   For another example, the UE could determine or identify the one or more reference carriers/CCs/cells, e.g., in terms/form of their carrier/CC/cell IDs/indexes out of the carriers/CCs/cells in a/the same list/set/pool of carriers/CCs/cells, according to or based on: (1) fixed rule(s)/setting(s) in system specification(s) and/or per RRC (re)configuration, e.g., the first/last carrier/CC/cell or the carrier/CC/cell with the lowest/highest ID/index in the list/set/pool of carriers/CCs/cells (or equivalently, in the list/set/pool of carrier/CC/cell IDs/indexes), (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. In this case, when/if (or as long as) the UE declares or detects one or more events according to or following those specified herein in the present disclosure for the one or more reference carriers/CCs/cells in a list/set/pool of carriers/CCs/cells, and/or triggers or initiates or starts corresponding beam reporting for the one or more reference carriers/CCs/cells, the UE could declare the same one or more events for one or more of the rest/remaining carrier(s)/CC(s)/cell(s) in the same list/set/pool of carriers/CCs/cells, and/or trigger or initiate or start corresponding beam reporting for one or more of the rest/remaining carrier(s)/CC(s)/cell(s) in the same list/set/pool of carriers/CCs/cells, wherein the one or more of the rest/remaining carrier(s)/CC(s)/cell(s) in the same list/set/pool of carriers/CCs/cells could be considered, treated or denoted as the target carrier(s)/CC(s)/cell(s).

Furthermore, the UE could determine or identify the one or more target carriers/CCs/cells, e.g., in terms/form of their carrier/CC/cell IDs/indexes out of the carriers/CCs/cells in a/the same list/set/pool of carriers/CCs/cells, according to or based on or following one or more of:
For example, the one or more target carriers/CCs/cells could correspond to (all) the carriers/CCs/cells (e.g., in terms/form of their carrier/CC/cell IDs/indexes) in the list/set/pool of carriers/CCs/cells (or equivalently, in the list/set/pool of carrier/CC/cell IDs/indexes) other than the reference carrier(s)/CC(s)/cell(s) in the (same) list/set/pool of carriers/CCs/cells (or equivalently, in the (same) list/set/pool of carrier/CC/cell IDs/indexes).
For another example, the one or more target carriers/CCs/cells could correspond to (all) the remaining/rest of the carriers/CCs/cells (e.g., in terms/form of their carrier/CC/cell IDs/indexes)—i.e., without/not account for the reference carrier(s)/CC(s)/cell(s) in the (same) list/set/pool of carriers/CCs/cells (or equivalently, in the (same) list/set/pool of carrier/CC/cell IDs/indexes)—in the list/set/pool of carriers/CCs/cells (or equivalently, in the list/set/pool of carrier/CC/cell IDs/indexes).
For another example, the UE could determine or identify the one or more target carriers/CCs/cells, e.g., in terms/form of their carrier/CC/cell IDs/indexes out of (i) the carriers/CCs/cells in a/the same list/set/pool of carriers/CCs/cells and/or (ii) the rest/remaining carriers/CCs/cells in a/the same list/set/pool of carriers/CCs/cells other than or without accounting for the reference carrier(s)/CC(s)/cell(s), according to or based on: (1) fixed rule(s)/setting(s) in system specification(s) and/or per RRC (re)configuration, e.g., the first/last carrier/CC/cell or the carrier/CC/cell with the lowest/highest ID/index in the list/set/pool of carriers/CCs/cells (or equivalently, in the list/set/pool of carrier/CC/cell IDs/indexes) with or without accounting for the reference carrier(s)/CC(s)/cell(s), (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.
In another example, the UE could first determine or identify the one or more reference carriers/CCs/cells, e.g., in terms/form of their carrier/CC/cell IDs/indexes out of (i) the carriers/CCs/cells in a list/set/pool of carriers/CCs/cells or a list/set/pool of carrier/CC/cell IDs/indexes higher layer configured/provided by the network to the UE, according to or based on: (1) fixed rule(s)/setting(s) in system specification(s) and/or per RRC (re)configuration, e.g., the first/last carrier/CC/cell or the carrier/CC/cell with the lowest/highest ID/index in the list/set/pool of carriers/CCs/cells (or equivalently, in the list/set/pool of carrier/CC/cell IDs/indexes), (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. Optionally, the UE could then determine or identify the one or more target carriers/CCs/cells, e.g., in terms/form of their carrier/CC/cell IDs/indexes out of (i) the carriers/CCs/cells in a list/set/pool of carriers/CCs/cells or a list/set/pool of carrier/CC/cell IDs/indexes higher layer configured/provided by the network to the UE, according to or based on: (1) fixed rule(s)/setting(s) in system specification(s) and/or per RRC (re)configuration, e.g., the first/last carrier/CC/cell or the carrier/CC/cell with the lowest/highest ID/index in the list/set/pool of carriers/CCs/cells (or equivalently, in the list/set/pool of carrier/CC/cell IDs/indexes), (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling. In this case, the UE could further determine or identify association/mapping between the one or more reference carriers/CCs/cells and the one or more target carriers/CCs/cells according to or based on: (1) fixed rule(s)/setting(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling.
   For example, the UE could be higher layer configured/provided by the network, e.g., via/in higher layer parameter(s) CSI-ResourceConfig, CSI-ReportConfig, UEI-ResourceConfig and/or UEI-ReportConfig that configures/provides necessary information and/or setting(s) for the corresponding UE-initiated/event-driven beam reporting, a first list/set/pool of carriers/CCs/cells (or carrier/CC/cell IDs/indexes) for reference carrier(s)/CC(s)/cell(s), and/or a second list/set/pool of carriers/CCs/cells (or carrier/CC/cell IDs/indexes) for target carrier(s)/CC(s)/cell(s). For this design example, when/if a UE has declared or detected one or more events according to or following those specified herein in the present disclosure for one or more reference carriers/CCs/cells in/from the first list/set/pool, and/or triggered or initiated or started corresponding beam reporting procedure(s) for the one or more reference carriers/CCs/cells in/from the first list/set/pool, the UE could also declare the one or more events for one or more target carriers/CCs/cells in/from the second list/set/pool, and/or trigger or initiate or start corresponding beam reporting procedure(s) for the one or more target carriers/CCs/cells in/from the second list/set/pool, wherein the one or more reference carriers/CCs/cells in/from the first list/set/pool and the one or more target carriers/CCs/cells from/in the second list/set/pool could be associated/mapped to each other(s), and the UE could determine or identify the association(s)/mapping(s) according to or based on: (1) fixed rule(s)/setting(s) in system specification(s) and/or per RRC (re)configuration, e.g., one-to-one, one-to-many or many-to-one mappings (e.g., according to their IDs/indexes from low to high or high to low), (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network (e.g., the network 130) via various UL channels/signals including CSI/beam report(s) and/or UE's capability signaling. For this design example, the first list/set/pool of carriers/CCs/cells (or carrier/CC/cell IDs/indexes) and the second list/set/pool of carriers/CCs/cells (or carrier/CC/cell IDs/indexes) could be identical/the same, or different.
   For another example, a/the UE could be configured or indicated or provided by the network, e.g., via/in higher layer RRC signaling(s)/parameter(s) and/or MAC CE command(s) and/or dynamic DCI based L1 signaling(s) for/specific to/associated to/corresponding to one or more reference carriers/CCs/cells—based on or according to a corresponding UE's capability or capability signaling—that indicates or provides or configures necessary information and/or setting(s) for the corresponding UE-initiated/event-driven beam reporting, a set of one or more (target) carriers/CCs/cells (e.g., in form/terms of their carrier/CC/cell IDs/indexes). Alternatively, a/the UE could be configured or indicated or provided by the network, e.g., via/in higher layer RRC signaling(s)/parameter(s) and/or MAC CE command(s) and/or dynamic DCI based L1 signaling(s) for/specific to/associated to/corresponding to one or more reference carriers/CCs/cells—based on or according to a corresponding UE's capability or capability signaling—that enables the corresponding UE-initiated/event-driven beam reporting, a set of one or more (target) carriers/CCs/cells (e.g., in form/terms of their carrier/CC/cell IDs/indexes). In this case, when/if the UE (e.g., the UE 116) has declared or detected one or more events according to or following those specified herein in the present disclosure for the one or more reference carriers/CCs/cells, and/or triggered or initiated or started corresponding beam reporting for the one or more reference carriers/CCs/cells, the UE could also declare the same one or more events for the set of one or more (target) carriers/CCs/cells, and/or triggers or initiates or starts corresponding beam reporting for the set of one or more (target) carriers/CCs/cells. For instance, the UE could be provided or configured by the network, e.g., in higher layer parameter(s)/signaling(s) such as CSI-ReportConfig, CSI-ResourceConfig, UEI-ReportConfig, UEI-ResourceConfig and/or etc. (dedicated) for a reference carrier/CC/cell #A that provides or indicates or configures necessary information and/or setting(s) for the corresponding UE-initiated/event-driven beam reporting, and/or enables the corresponding UE-initiated/event-driven beam reporting, a set of (target) carrier/CC/cell IDs/indexes denoted by {#B, #C, #D}; in this case, when/if the UE has declared or detected one or more events according to or following those specified herein in the present disclosure for the reference carrier/CC/cell #A, and/or triggered or initiated or started corresponding beam reporting for the reference carrier/CC/cell #A, the UE could also declare the same one or more events for the set of (target) carriers/CCs/cells #B, #C and #D, and/or triggers or initiates or starts corresponding beam reporting for the set of (target) carriers/CCs/cells #B, #C and #D.
   For another example, a/the UE could be configured or indicated or provided by the network, e.g., via/in higher layer RRC signaling(s)/parameter(s) and/or MAC CE command(s) and/or dynamic DCI based L1 signaling(s) based on or according to a corresponding UE's capability or capability signaling, an indication, configuration and/or information that indicates or provides or configures or includes or comprises or contains a first set of one or more (reference) carriers/CCs/cells (e.g., in form/terms of their carrier/CC/cell IDs/indexes) and a second set of one or more (target) carriers/CCs/cells (e.g., in form/terms of their carrier/CC/cell IDs/indexes). In this case, when/if the UE has declared or detected one or more events according to or following those specified herein in the present disclosure for the first set of one or more (reference) carriers/CCs/cells, and/or triggered or initiated or started corresponding beam reporting for the first set of one or more reference carriers/CCs/cells, the UE could also declare the same one or more events for the second set of one or more (target) carriers/CCs/cells, and/or triggers or initiates or starts corresponding beam reporting for the second set of one or more (target) carriers/CCs/cells, wherein as specified/described herein in the present disclosure, the first set and the second set could be provided, configured, indicated, comprised, included or contained in the same indication, configuration or information provided, indicated or configured to the UE. For instance, the UE could be provided or configured by the network, e.g., in higher layer parameter(s)/signaling(s) such as CSI-ReportConfig, CSI-ResourceConfig, UEI-ReportConfig, UEI-ResourceConfig and/or etc. that provides or configures necessary information and/or setting(s) for the corresponding UE-initiated/event-driven beam reporting, and/or enables the corresponding UE-initiated/event-driven beam reporting, an indication or configuration or information providing, indicating, configuring, comprising, including or containing a first set of a reference carrier/CC/cell #A and a second set of (target) carrier/CC/cell IDs/indexes denoted by {#B, #C, #D}; in this case, when/if the UE has declared or detected one or more events according to or following those specified herein in the present disclosure for the reference carrier/CC/cell #A in the first set, and/or triggered or initiated or started corresponding beam reporting for the reference carrier/CC/cell #A in the first set, the UE could also declare the same one or more events for the set of (target) carriers/CCs/cells #B, #C and #D in the second set, and/or triggers or initiates or starts corresponding beam reporting for the set of (target) carriers/CCs/cells #B, #C and #D in the second set.

A conceptual example characterizing the described design procedure(s) herein is provided in FIG. 7. With reference to FIG. 7, for a multi-carrier or multi-CC or multi-cell system as defined/specified herein in the present disclosure (e.g., carrier aggregation (CA) scenarios), when/if a UE has declared an event for a reference carrier/CC/cell, and/or triggered a beam reporting for the reference carrier/CC/cell, and when/if the UE identifies a target carrier/CC/cell that is associated to the reference carrier/CC/cell according to or following those specified herein in the present disclosure, the UE could also declare the same event for the target carrier/CC/cell, and/or triggers a corresponding beam reporting for the target carrier/CC/cell. Furthermore, a list of carriers/CCs/cells as specified/defined herein in the present disclosure could correspond to a CC list provided by simultaneousU-TCI-UpdateList1-r17, simultaneousU-TCI-UpdateList2-r17, simultaneousU-TCI-UpdateList3-r17 or simultaneousU-TCI-UpdateList4-r17.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

FIG. 8 illustrates a flowchart of an example UE procedure 800 for determining/identifying a current serving beam RS according to embodiments of the present disclosure. For example, procedure 800 can be performed the UE 116 of FIG. 3. This example is for illustration only and other embodiments can be used without departing from the scope of the present disclosure.

The procedure begins in 810, a UE has determined or identified a current serving beam RS resource for a reference carrier/CC/cell according to an indicated TCI state for the reference carrier/CC/cell, In 820, the UE identifies a target carrier/CC/cell associated to the reference carrier/CC/cell. In 830, the UE determines or identifies a current serving beam RS resource for the target carrier/CC/cell according to the indicated TCI state for the reference carrier/CC/cell.

For a carrier or a CC or a cell as specified/defined herein in the present disclosure, the RS(s) or RS resource(s) or RS resource index(es) of/for a current serving beam—denoted by current serving beam RS(s) or RS resource(s) or RS resource index(es)—for or specific to the carrier/CC/cell could be identified or determined according to one or more of:
(implicit determination example-1): One or more RSs or RS resources or RS resource indexes provided in/by an indicated TCI state for or specific to the carrier/CC/cell, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a tracking reference signal (TRS) is also a type of CSI-RS.
(implicit determination example-2): One or more first RSs or RS resources or RS resource indexes quasi-co-located (QCL'ed) with second RS(s)/RS resource(s)/RS resource index(es) provided in/by an indicated TCI state for or specific to the carrier/CC/cell, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state for or specific to the carrier/CC/cell, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-1): a set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) for or specific to the carrier/CC/cell according to those specified herein in the present disclosure. The serving beam(s) set s̅₀ of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting for or specific to the carrier/CC/cell as specified herein in the present disclosure.
(explicit configuration example-2): a set s̅₀ of SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) for or specific to the carrier/CC/cell according to those specified herein in the present disclosure. The serving beam(s) set s̅₀ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting for or specific to the carrier/CC/cell as specified herein in the present disclosure.

In one example, when/if the one or more RSs/RS resources/RS resource indexes provided in/by the indicated TCI state (e.g., of QCL-TypeD) for or specific to the carrier/CC/cell correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es) for or specific to the carrier/CC/cell. In another example, when/if the one or more RSs/RS resources/RS resource indexes provided in/by the indicated TCI state (e.g., of QCL-TypeD) for or specific to the carrier/CC/cell correspond to CSI-RS(s) for tracking or tracking reference signal(s)—e.g., CSI-RS(s) configured with trs-Info, the UE may not follow those specified in the implicit determination example-1 in the present disclosure to determine or identify the current serving beam RS(s)/RS resource(s)/RS resource index(es) for or specific to the carrier/CC/cell, but instead, the UE could expect to be provided or configured or indicated by the network a/the set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) for or specific to the carrier/CC/cell according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam for or specific to the carrier/CC/cell based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) for or specific to the carrier/CC/cell in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) for or specific to the carrier/CC/cell in the UEI/event-driven beam reporting according to (or that has the same RS(s) or RS resource(s) or RS resource index(es) as to)
   one or more RSs or RS resources or RS resource indexes provided in/by an indicated TCI state for or specific to the carrier/CC/cell, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state for or specific to the carrier/CC/cell, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state for or specific to the carrier/CC/cell, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

The carrier/CC/cell as discussed or specified in the (described herein) design example(s)/procedure(s) in the present disclosure could correspond to a reference carrier/CC/cell or a target carrier/CC/cell as defined or determined according to or following those specified herein in the present disclosure in a multi-carrier or multi-CC or multi-cell system according to or following those specified herein in the present disclosure. For instance, when/if a UE has received and/or applied an indicated TCI state to or for a first carrier/CC/cell (e.g., a reference carrier/CC/cell defined or determined according to or following those specified herein in the present disclosure) provided in a list/set/pool of carriers/CCs/cells (e.g., in form of their carrier/CC/cell IDs/indexes), wherein the list/set/pool of carriers/CCs/cells could correspond to a CC list provided by simultaneousU-TCI-UpdateList1-r17, simultaneousU-TCI-UpdateList2-r17, simultaneousU-TCI-UpdateList3-r17 or simultaneousU-TCI-UpdateList4-r17, the UE could determine or identify the current serving beam RS(s) or RS resource(s) or RS resource index(es) for or specific to the first carrier/CC/cell according to the indicated TCI state for or specific to the first carrier/CC/cell following those specified herein in the present disclosure, and/or assess or evaluate or measure the radio link/beam quality(s), e.g., by measuring L1-RSRP(s)/L1-SINR(s), of the current serving beam(s) for or specific to the first carrier/CC/cell according to the indicated TCI state for or specific to the first carrier/CC/cell following those specified herein in the present disclosure; furthermore, the UE could also determine or identify current serving beam RS(s) or RS resource(s) or RS resource index(es) for or specific to one or more or any of the carriers/CCs/cells other than the first carrier/CC/cell in the list/set/pool of carriers/CCs/cells (e.g., the target carrier(s)/CC(s)/cell(s) defined or determined according to or following those specified herein in the present disclosure)—denoted by second carrier(s)/CC(s)/cell(s)—according to the indicated TCI state for or specific to the first carrier/CC/cell following those specified herein in the present disclosure, and/or assess or evaluate or measure the radio link/beam quality(s), e.g., by measuring L1-RSRP(s)/L1-SINR(s), of the current serving beam(s) for or specific to the second carrier(s)/CC(s)/cell(s) according to the indicated TCI state for or specific to the first carrier/CC/cell following those specified herein in the present disclosure. For instance, a UE could receive from the network, in a higher layer parameter CSI-ReportConfig or UEI-ReportConfig provided or configured for the UE-initiated/event-driven beam reporting according to or following those specified herein in the present disclosure for a first carrier/CC/cell, a higher layer parameter carrier/servCellIndex pointing to a second carrier/CC/cell as specified/defined herein in the present disclosure,
In one example, the UE could determine or identify the current serving beam RS(s) or RS resource(s) for the second carrier/CC/cell according to the RS(s) provided in the TCI state, e.g., provided by TCI-State or UL-TCIState, configured, activated or indicated or applied in/for/on the second carrier/CC/cell.
In another example, when/if the first carrier/CC/cell is associated with an indicated TCI state—e.g., provided by TCI-State or UL-TCIState, or equivalently, when/if a TCI state—e.g., provided by TCI-State or UL-TCIState—is provided or indicated or activated or configured for the first carrier/CC/cell, and when/if the first carrier/CC/cell and the second carrier/CC/cell are in the same list of carriers/CCs/cells (e.g., provided by simultaneousU-TCI-UpdateList1-r17, simultaneousU-TCI-UpdateList2-r17, simultaneousU-TCI-UpdateList3-r17 or simultaneousU-TCI-UpdateList4-r17) for TCI state(s) indication/update, the UE could determine or identify the current serving beam RS(s) or RS resource(s) for the second carrier/CC/cell according to the RS(s) provided in the (indicated) TCI state associated with the first carrier/CC/cell as specified/defined herein in the present disclosure.
In another example, when/if the first carrier/CC/cell is associated with an indicated first TCI state—e.g., provided by TCI-State or UL-TCIState, or equivalently, when/if a first TCI state—e.g., provided by TCI-State or UL-TCIState—is provided or indicated or activated or configured for the first carrier/CC/cell, and when/if the first carrier/CC/cell and the second carrier/CC/cell are not in the same list of carriers/CCs/cells (e.g., provided by simultaneousU-TCI-UpdateList1-r17, simultaneousU-TCI-UpdateList2-r17, simultaneousU-TCI-UpdateList3-r17 or simultaneousU-TCI-UpdateList4-r17) for TCI state(s) indication/update, the UE could determine or identify the current serving beam RS(s) or RS resource(s) for the second carrier/CC/cell according to the RS(s) provided in a second TCI state, e.g., provided by TCI-State or UL-TCIState, configured, activated or indicated in/for/on the second carrier/CC/cell.
In another example, when/if the first carrier/CC/cell is associated with an indicated first TCI state—e.g., provided by TCI-State or UL-TCIState, or equivalently, when/if a first TCI state—e.g., provided by TCI-State or UL-TCIState—is provided or indicated or activated or configured for the first carrier/CC/cell, and when/if the first carrier/CC/cell and the second carrier/CC/cell are not in the same list of carriers/CCs/cells (e.g., provided by simultaneousU-TCI-UpdateList1-r17, simultaneousU-TCI-UpdateList2-r17, simultaneousU-TCI-UpdateList3-r17 or simultaneousU-TCI-UpdateList4-r17) for TCI state(s) indication/update, the UE could determine or identify the current serving beam RS(s) or RS resource(s) for the second carrier/CC/cell according to the RS(s) provided in a second TCI state, e.g., provided by TCI-State or UL-TCIState, applied in/for/on the second carrier/CC/cell. For this design example, the UE could determine or identify the second TCI state as an indicated TCI state for a reference carrier/CC/cell as specified/defined herein in the present disclosure or any carrier/CC/cell in a list of carriers/CCs/cells (e.g., provided by simultaneousU-TCI-UpdateList1-r17, simultaneousU-TCI-UpdateList2-r17, simultaneousU-TCI-UpdateList3-r17 or simultaneousU-IC-UpdateList4-r17) for TCI state(s) indication/update that also comprise, include or contain the second carrier/CC/cell.
In another example, when/if the higher layer parameter or field carrier/servCelIndex is absent or not present or set to invalid value(s) such as ‘0’ or ‘null’ or ‘empty’ in the higher layer parameter CSI-ReportConfig or UEI-ReportConfig provided or configured for the UE-initiated/event-driven beam reporting according to or following those specified herein in the present disclosure for the first carrier/CC/cell, the UE could determine or identify the current serving beam RS(s) or RS resource(s) according to the RS(s) provided in the (indicated) TCI state associated with the first carrier/CC/cell as specified/defined herein in the present disclosure.

In the present disclosure, an indicated TCI state (denoted by the indicated TCI state of interest) is said to be associated/specific to or provided or configured or indicated or activated or applied to a carrier/CC/cell (denoted by the carrier/CC/cell of interest) according to or based on one or more of:
The higher layer parameter(s) TCI-State or UL-TCIState that configures or provides an indicated TCI state could comprise, contain, include, configure or provide a carrier/CC/cell ID or index (e.g., denoted by carrier/servCelIndex) for or specific to the carrier/CC/cell of interest.
The UE could determine or identify the indicated TCI state of interest as an indicated TCI state for a reference carrier/CC/cell as specified/defined herein in the present disclosure or any carrier/CC/cell in a list of carriers/CCs/cells (e.g., provided by simultaneousU-TCI-UpdateList1-r17, simultaneousU-TCI-UpdateList2-r17, simultaneousU-TCI-UpdateList3-r17 or simultaneousU-TCI-UpdateList4-r17) for TCI state(s) indication/update that also comprise, include or contain the carrier/CC/cell of interest.
A list/set/pool of TCI states or TCI state IDs higher layer configured/provided for the carrier/CC/cell of interest contains, comprises, includes, provides or configures the indicated TCI state of interest (e.g., in form of its TCI state ID/index)
A (unified) TCI state(s) activation/deactivation MAC CE command on the carrier/CC/cell of interest—e.g., the serving cell ID in the MAC CE command indicates the carrier/CC/cell of interest—indicates, provides, comprises, contains or includes a TCI codepoint comprising the indicated TCI state of interest.
A beam indication DCI (e.g., DCI format 1_1/1_2 with or without DL assignment) received in a CORESET associated/specific to the carrier/CC/cell of interest indicates the indicated TCI state of interest (e.g., via a TCI codepoint in the TCI field in the corresponding DCI format(s)).

The described or specified design example(s)/procedure(s) herein for determining, identifying, evaluating or assessing current serving beam(s) or current serving beam RS(s)/RS resource(s) in a multi-carrier or a multi-CC or a multi-cell system is presented in FIG. 8. With reference to FIG. 8, when a UE (e.g., the UE 116) has determined or identified current serving beam(s) or current serving beam RS(s)/RS resource(s) for a (reference) carrier/CC/cell according to an indicated TCI state for or specific to the (reference) carrier/CC/cell, the UE could also determine or identify current serving beam(s) or current serving beam RS(s)/RS resource(s) for another (target) carrier/CC/cell according to the same indicated TCI state for or specific to the (reference) carrier/CC/cell, wherein the (reference) carrier/CC/cell and the another (target) carrier/CC/cell could be provided or configured in a/the (same) list/set/pool of carriers/CCs/cells (e.g., in terms/form of their IDs/indexes).

In one embodiment, a UE could be provided or configured by the network, e.g., in/via higher layer parameter(s) CSI-MeasConfig and/or ueiCSI-MeasConfig and/or TCI-State/UL-TCIState that configures or provides a joint/DL/UL TCI state, one or more CSI reporting settings each provided by CSI-ReportConfig or ueiCSI-ReportConfig for the UE-initiated/event-driven beam reporting as specified/defined herein in the present disclosure. In a multi-carrier or multi-CC or multi-cell system, wherein one or more (e.g., multiple or more than one) carriers and/or component carriers (CCs) and/or cells could be configured, provided and/or enabled by the network, e.g., via higher layer RRC signaling(s)/parameter(s) and/or MAC CE command(s) and/or dynamic DCI based L1 signaling(s) based on or according to a corresponding UE's capability or capability signaling—e.g., when/if a UE is higher layer configured/provided by the network, e.g., in higher layer parameter(s) CSI-ReportConfig, CSI-ResourceConfig, UEI-ReportConfig and/or UEI-ResourceConfig that provides or configures necessary information and/or setting(s) for the corresponding UE-initiated/event-driven beam reporting, one or more lists of carriers (e.g., in terms/form of their carrier IDs/indexes), one or more lists of CCs (e.g., in terms/form of their CC IDs/indexes), and/or one or more lists of cells (e.g., in terms/form of their cell IDs/indexes), for the UE-initiated/event-driven beam operations including beam reporting, and/or when/if a UE is higher layer configured/provided by the network (e.g., the network 130), e.g., in higher layer parameter(s) CSI-ReportConfig, CSI-ResourceConfig, ueiCSI-ReportConfig and/or ueiCSI-ResourceConfig that provides or configures necessary information and/or setting(s) for the corresponding UE-initiated/event-driven beam reporting, higher layer parameter(s) multiCarrierBeamReporting, multiCCBeamReporting, multiCellBeamReporting, crossCarrierBeamReporting, crossCCBeamReporting, crossCellBeamReporting and/or etc. dedicated for enabling the multi-carrier (or cross-carrier), multi-CC (or cross-CC) and/or multi-cell (or cross-cell) beam reporting (e.g., set to ‘enabled’), the one or more CSI reporting settings for the UE-initiated/event-driven beam reporting as specified/defined herein in the present disclosure could be associated or specific to one or more carriers/CCs/cells according to or following one or more of:
In one example, the UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a list/set/pool of carriers/CCs/cells (e.g., in terms/form of their carrier/CC/cell IDs/indexes). For instance, the higher layer parameter(s) CSI-MeasConfig and/or ueiCSI-MeasConfig that configures or provides the one or more CSI reporting settings for the UEI/event-driven beam reporting, and/or the higher layer parameter(s) TCI-State/UL-TCIState that configures or provides a joint/DL/UL TCI state and comprises or provides the one or more CSI reporting settings for the UEI/event-driven beam reporting could also provide or configure or include or comprise or contain the list/set/pool of carrier/CC/cell indexes/IDs. In this case,
   For example, each of the one or more CSI reporting settings (and therefore, the corresponding CSI resource setting(s), CSI resource set(s) including SSB resource set(s) and/or non-zero power (NZP) CSI-RS resource set(s), and/or CSI-RS resource(s) including SSB(s) and/or NZP CSI-RS resource(s) associated/linked/corresponding to the CSI reporting setting(s)) could be associated or specific to one or more carriers/CCs/cells in the list/set/pool according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s).
   For another example, the one or more CSI reporting settings (and therefore, the corresponding CSI resource setting(s), CSI resource set(s) including SSB resource set(s) and/or NZP CSI-RS resource set(s), and/or CSI-RS resource(s) including SSB(s) and/or NZP CSI-RS resource(s) associated/linked/corresponding to the CSI reporting setting(s)) could be one-to-one mapped/associated/specific to the carriers/CCs/cells in the list/set/pool according to a fixed rule in system specification(s) and/or per RRC (re-)configuration. For instance, the first/last CSI reporting setting or the CSI reporting setting with the lowest/highest reportConfigId among the one or more CSI reporting settings provided/configured for the UE-initiated/event-driven beam reporting specified/defined herein in the present disclosure could be mapped/associated/specific to the first/last entry in the list/set/pool or the carrier/CC/cell in the list/set/pool with the lowest/highest carrier/CC/cell index/ID among the carriers/CCs/cells in the list/set/pool, and so on, and the last/first CSI reporting setting or the CSI reporting setting with the highest/lowest reportConfigId among the one or more CSI reporting settings provided/configured for the UE-initiated/event-driven beam reporting specified/defined herein in the present disclosure could be mapped/associated/specific to the last/first entry in the list/set/pool or the carrier/CC/cell in the list/set/pool with the highest/lowest carrier/CC/cell index/ID among the carriers/CCs/cells in the list/set/pool.
   For another example, the one or more CSI reporting settings (and therefore, the corresponding CSI resource setting(s), CSI resource set(s) including SSB resource set(s) and/or NZP CSI-RS resource set(s), and/or CSI-RS resource(s) including SSB(s) and/or NZP CSI-RS resource(s) associated/linked/corresponding to the CSI reporting setting(s)) could be one-to-one mapped/associated/specific to the carriers/CCs/cells in the list/set/pool according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s).
In another example, the UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a list/set/pool of carriers/CCs/cells (e.g., in terms/form of their carrier/CC/cell IDs/indexes). For this design example, the UE could be further provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a subset of carriers/CCs/cells (e.g., in terms/form of their carrier/CC/cell IDs/indexes) from/out of the carriers/CCs/cells in the list/set/pool. For instance, the higher layer parameter(s) CSI-MeasConfig and/or ueiCSI-MeasConfig that configures or provides the one or more CSI reporting settings for the UEI/event-driven beam reporting, and/or the higher layer parameter(s) TCI-State/UL-TCIState that configures or provides a joint/DL/UL TCI state and comprises or provides the one or more CSI reporting settings for the UEI/event-driven beam reporting could also provide or configure or include or comprise or contain information related to the subset of carrier/CC/cell indexes/IDs.
   For example, the information could be or could comprise a bitmap with each entry/bit position of the bitmap corresponding to an entry in the list/set/pool of carriers/CCs/cells (e.g., in terms/form of their carrier/CC/cell IDs/indexes). In this case, when/if an entry/bit position in the bitmap is set to ‘1’ (or ‘0’), the carrier/CC/cell ID/index in the list/set/pool corresponding to the entry/bit position could belong to the subset of carriers/CCs/cells.
   For another example, the information could be or could comprise one or more one-bit indicators each corresponding to an entry in the list/set/pool of carriers/CCs/cells (e.g., in terms/form of their carrier/CC/cell IDs/indexes). In this case, when/if a one-bit indicator is set to ‘1’ (or ‘0’), the carrier/CC/cell ID/index in the list/set/pool corresponding to the one-bit indicator could belong to the subset of carriers/CCs/cells.
   For another example, the information could be or could comprise IDs of the carriers/CCs/cells in the subset, and/or indexes of the carriers/CCs/cells in the subset from/out of the carriers/CCs/cells in the list/set/pool.
In this case,
   For example, each of the one or more CSI reporting settings (and therefore, the corresponding CSI resource setting(s), CSI resource set(s) including SSB resource set(s) and/or NZP CSI-RS resource set(s), and/or CSI-RS resource(s) including SSB(s) and/or NZP CSI-RS resource(s) associated/linked/corresponding to the CSI reporting setting(s)) could be associated or specific to one or more carriers/CCs/cells in the subset according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s).
   For another example, the one or more CSI reporting settings (and therefore, the corresponding CSI resource setting(s), CSI resource set(s) including SSB resource set(s) and/or NZP CSI-RS resource set(s), and/or CSI-RS resource(s) including SSB(s) and/or NZP CSI-RS resource(s) associated/linked/corresponding to the CSI reporting setting(s)) could be one-to-one mapped/associated/specific to the carriers/CCs/cells in the subset according to a fixed rule in system specification(s) and/or per RRC (re-)configuration. For instance, the first/last CSI reporting setting or the CSI reporting setting with the lowest/highest reportConfigId among the one or more CSI reporting settings provided/configured for the UE-initiated/event-driven beam reporting specified/defined herein in the present disclosure could be mapped/associated/specific to the first/last entry in the subset or the carrier/CC/cell in the subset with the lowest/highest carrier/CC/cell index/ID among the carriers/CCs/cells in the subset, and so on, and the last/first CSI reporting setting or the CSI reporting setting with the highest/lowest reportConfigId among the one or more CSI reporting settings provided/configured for the UE-initiated/event-driven beam reporting specified/defined herein in the present disclosure could be mapped/associated/specific to the last/first entry in the subset or the carrier/CC/cell in the subset with the highest/lowest carrier/CC/cell index/ID among the carriers/CCs/cells in the subset.
   For another example, the one or more CSI reporting settings (and therefore, the corresponding CSI resource setting(s), CSI resource set(s) including SSB resource set(s) and/or NZP CSI-RS resource set(s), and/or CSI-RS resource(s) including SSB(s) and/or NZP CSI-RS resource(s) associated/linked/corresponding to the CSI reporting setting(s)) could be one-to-one mapped/associated/specific to the carriers/CCs/cells in the subset according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s).
In another example, each of the one or more CSI reporting settings for the UE-initiated/event-driven beam reporting as specified/defined herein in the present disclosure could be associated/specific to a carrier/CC/cell (e.g., in terms/form of a carrier/CC/cell ID/index from/in a list/set/pool of carrier/CC/cell IDs/indexes). For instance, the higher layer parameter(s) CSI-ReportConfig and/or ueiCSI-ReportConfig that configures or provides a CSI reporting setting for the UE-initiated/event-driven beam reporting could also provide, configure, comprise, include or contain a carrier/CC/cell ID/index.

When/if a UE has determined or identified a CSI reporting setting provided/configured for the UE-initiated/event-driven beam reporting as specified/defined herein in the present disclosure, and therefore, the carrier(s)/CC(s)/cell(s) associated/specific to the determined or identified CSI reporting setting according to or following those specified/described herein in the present disclosure, the UE could also determine or identify one or more CSI resource settings (and therefore, the CSI resource set(s) including SSB resource set(s) and/or NZP CSI-RS resource set(s), and/or CSI-RS resource(s) including SSB(s) and/or NZP CSI-RS resource(s) provided/configured/indicated in the CSI resource setting(s)) linked/mapped/associated/specific to the determined or identified CSI reporting setting, and therefore, the carrier(s)/CC(s)/cell(s) associated/specific to the determined or identified CSI reporting setting, wherein the UE could determine or identify the CSI-RS resource(s) including SSB(s) and/or NZP CSI-RS resource(s) as candidate/new beam RS resource(s) for the UE-initiated/event-driven beam reporting for/on the carrier(s)/CC(s)/cell(s). For actual candidate/new beam(s) measurement in a multi-carrier or multi-CC or multi-cell system as specified/defined herein in the present disclosure,
In one example, the UE could determine or identify which one or more of the one or more CSI reporting settings to use or apply for determining or identifying candidate/new beam RS resource(s) for actual candidate/new beam(s) measurement on/for the corresponding carrier(s)/CC(s)/cell(s) according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s).
   For example, the UE could determine or identify that the candidate/new beam RS resource(s) linked/associated/specific to a subset of the one or more CSI reporting settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI reporting settings respectively according to or following those specified herein in the present disclosure. In this case, the subset could correspond to the one or more CSI reporting settings configured/provided for the UE-initiated/event-driven beam reporting according to or following those specified herein in the present disclosure; optionally, the subset could correspond to the CSI reporting setting(s) with odd (or event) reportConfigId value(s) and/or the odd (or even) numbered/indexed CSI reporting setting(s) among the one or more CSI reporting settings configured/provided for the UE-initiated/event-driven beam reporting as specified/defined herein in the present disclosure; alternatively, the subset could correspond to the CSI reporting setting(s) with the K≥1 highest/lowest reportConfigId value(s) and/or the first/last K≥1 CSI reporting setting(s) among the one or more CSI reporting settings configured/provided for the UE-initiated/event-driven beam reporting as specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more indicators or triggers each pointing/corresponding/associated/specific to one or more CSI reporting settings in the subset; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, an indicator or trigger pointing/corresponding/associated/specific to a CSI reporting setting in the subset; when/if the UE has received or detected such indicator(s)/trigger(s) from the network, the UE could determine or identify that the candidate/new beam RS resource(s) linked/associated/specific to the subset of the one or more CSI reporting settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI reporting settings respectively according to or following those specified herein in the present disclosure. Otherwise, i.e., when/if the UE does not receive or detect such indicator(s)/trigger(s) or the indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the subset of the one or more CSI reporting settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI reporting settings respectively according to or following those specified herein in the present disclosure, and/or the UE could determine or identify that the candidate/new beam RS resource(s) linked/associated/specific to the one or more CSI reporting settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI reporting settings respectively according to or following those specified herein in the present disclosure.
   For another example, the UE could determine or identify that the candidate/new beam RS resource(s) linked/associated/specific to a subset of the one or more CSI reporting settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI reporting settings respectively according to or following those specified herein in the present disclosure, wherein the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset. For instance, the information related to the subset could be or could correspond to a bitmap with each entry/bit position of the bitmap corresponding to a CSI reporting setting configured/provided for the UE-initiated/event-driven beam reporting as specified/defined herein in the present disclosure; when/if an entry/bit position of the bitmap is set to ‘1’ (or ‘0’), the corresponding CSI reporting setting could belong to the subset. Alternatively, the information related to the subset could correspond to or comprise one or more one-bit indicators each corresponding/associated to a CSI reporting setting configured/provided for the UE-initiated/event-driven beam reporting as specified/defined herein in the present disclosure; when/if a one-bit indicator is set to ‘1’ (or ‘0’), the corresponding CSI reporting setting could belong to the subset. Optionally, the information related to the subset could correspond to or could comprise one or more reporting setting IDs (or reportConfigId's); in this case, the CSI reporting setting(s) with the one or more reporting setting IDs/reportConfigId's could belong to the subset. For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more indicators or triggers each pointing/corresponding/associated/specific to one or more CSI reporting settings in the subset; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, an indicator or trigger pointing/corresponding/associated/specific to a CSI reporting setting in the subset; when/if the UE has received or detected such indicator(s)/trigger(s) from the network, the UE could determine or identify that the candidate/new beam RS resource(s) linked/associated/specific to the subset of the one or more CSI reporting settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI reporting settings respectively according to or following those specified herein in the present disclosure. Otherwise, i.e., when/if the UE does not receive or detect such indicator(s)/trigger(s) or the indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the subset of the one or more CSI reporting settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI reporting settings respectively according to or following those specified herein in the present disclosure, and/or the UE could determine or identify that the candidate/new beam RS resource(s) linked/associated/specific to the one or more CSI reporting settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI reporting settings respectively according to or following those specified herein in the present disclosure.

An indicator/trigger as specified/defined herein in the present disclosure could correspond to a ‘CSI request’ field in a corresponding DCI format(s) 0_1 and/or 0_2 (and therefore, a corresponding trigger state). That is, when/if the UE has received or indicated or determined or identified a trigger state (via the indicated ‘CSI request’ field in the corresponding DCI format(s) 0_1 and/or 0_2) pointing/linking/corresponding/associated/specific to any one or more of the CSI reporting setting(s) in the subset of CSI reporting setting(s), the UE could determine or identify that the candidate/new beam RS resource(s) linked/associated/specific to the CSI reporting setting(s) in the subset of CSI reporting setting(s) could be used or applied for actual candidate/new beam(s) measurement on/for the subset of carrier(s)/CC(s)/cell(s) corresponding to the subset of the one or more CSI reporting settings respectively according to or following those specified herein in the present disclosure.

In another example, the carriers/CCs/cells (e.g., in form/terms of their IDs/indexes) associated/specific/linked to the one or more CSI reporting settings configured/provided for the UE-initiated/event-driven beam reporting according to or following those specified herein in the present disclosure could be denoted by or referred to as reference carriers/CCs/cells for this design example. The UE could first determine or identify a subset of the reference carriers/CCs/cells according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). The UE could then determine or identify a subset of the one or more CSI reporting settings—corresponding/associated/specific to the determined or identified subset of carrier(s)/CC(s)/cell(s) according to or following those specified herein in the present disclosure—to use or apply for determining or identifying candidate/new beam RS resource(s) for actual candidate/new beam(s) measurement on/for the corresponding carrier(s)/CC(s)/cell(s).

For example, the subset of carrier(s)/CC(s)/cell(s) could correspond to the (reference) carriers/CCs/cells associated/corresponding/specific to the one or more CSI reporting settings configured/provided for the UE-initiated/event-driven beam reporting according to or following those specified herein in the present disclosure; optionally, the subset of carrier(s)/CC(s)/cell(s) could correspond to the carrier(s)/CC(s)/cell(s) with odd (or event) carrier/CC/cell ID(s)/index(es) and/or the odd (or even) numbered/indexed carrier(s)/CC(s)/cell(s) among the reference carriers/CCs/cells specified/defined herein in the present disclosure; alternatively, the subset of carrier(s)/CC(s)/cell(s) could correspond to the carrier(s)/CC(s)/cell(s) with the K≥1 highest/lowest carrier/CC/cell ID(s)/index(es) and/or the first/last K≥1 carrier(s)/CC(s)/cell(s) among the reference carriers/CCs/cells specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE (e.g., the UE 116) could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more indicators or triggers each pointing/corresponding/associated/specific to one or more CSI reporting settings in the subset of CSI reporting setting(s)—note here that as specified/defined herein in the present disclosure, the subset of CSI reporting setting(s) could be associated/corresponding/specific to the determined or identified subset of carrier(s)/CC(s)/cell(s); for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, an indicator or trigger pointing/corresponding/associated/specific to a CSI reporting setting in the subset of CSI reporting setting(s); when/if the UE has received or detected such indicator(s)/trigger(s) from the network (e.g., the network 130) pointing/corresponding/associated/specific to any of the CSI reporting setting(s) in the subset of CSI reporting setting(s), the UE could determine or identify that the candidate/new beam RS resource(s) linked/associated/specific to the CSI reporting setting(s) in the subset of CSI reporting setting(s) could be used or applied for actual candidate/new beam(s) measurement on/for the determined or identified subset of carrier(s)/CC(s)/cell(s) corresponding to the subset of the one or more CSI reporting settings respectively according to or following those specified herein in the present disclosure. Otherwise, i.e., when/if the UE does not receive or detect such indicator(s)/trigger(s) or the indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the CSI reporting setting(s) in the subset of CSI reporting setting(s) could be used or applied for actual candidate/new beam(s) measurement on/for the determined or identified subset of carrier(s)/CC(s)/cell(s) corresponding to the subset of the one or more CSI reporting settings respectively according to or following those specified herein in the present disclosure, and/or the UE could determine or identify that the candidate/new beam RS resource(s) linked/associated/specific to the one or more CSI reporting settings configured/provided for the UE-initiated/event-driven beam reporting according to or following those specified herein in the present disclosure could be used or applied for actual candidate/new beam(s) measurement on/for the (reference) carrier(s)/CC(s)/cell(s) corresponding to the one or more CSI reporting settings respectively according to or following those specified herein in the present disclosure.

For another example, the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset of carrier(s)/CC(s)/cell(s). For instance, the information related to the subset of carrier(s)/CC(s)/cell(s) could be or could correspond to a bitmap with each entry/bit position of the bitmap corresponding to a reference carrier/CC/cell as specified/defined herein in the present disclosure; when/if an entry/bit position of the bitmap is set to ‘1’ (or ‘0’), the corresponding carrier/CC/cell could belong to the subset of carrier(s)/CC(s)/cell(s). Alternatively, the information related to the subset of carrier(s)/CC(s)/cell(s) could correspond to or comprise one or more one-bit indicators each corresponding/associated to a reference carrier/CC/cell as specified/defined herein in the present disclosure; when/if a one-bit indicator is set to ‘1’ (or ‘0’), the corresponding reference carrier/CC/cell could belong to the subset of carrier(s)/CC(s)/cell(s). Optionally, the information related to the subset of carrier(s)/CC(s)/cell(s) could correspond to or could comprise one or more carrier/CC/cell IDs/indexes; in this case, the reference carrier(s)/CC(s)/cell(s) with the one or more carrier/CC/cell IDs/indexes could belong to the subset of carrier(s)/CC(s)/cell(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more indicators or triggers each pointing/corresponding/associated/specific to one or more CSI reporting settings in the subset of CSI reporting setting(s)—note here that as specified/defined herein in the present disclosure, the subset of CSI reporting setting(s) could be associated/corresponding/specific to the determined or identified subset of carrier(s)/CC(s)/cell(s); for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, an indicator or trigger pointing/corresponding/associated/specific to a CSI reporting setting in the subset of CSI reporting setting(s); when/if the UE has received or detected such indicator(s)/trigger(s) from the network pointing/corresponding/associated/specific to any of the CSI reporting setting(s) in the subset of CSI reporting setting(s), the UE could determine or identify that the candidate/new beam RS resource(s) linked/associated/specific to the CSI reporting setting(s) in the subset of CSI reporting setting(s) could be used or applied for actual candidate/new beam(s) measurement on/for the determined or identified subset of carrier(s)/CC(s)/cell(s) corresponding to the subset of the one or more CSI reporting settings respectively according to or following those specified herein in the present disclosure. Otherwise, i.e., when/if the UE does not receive or detect such indicator(s)/trigger(s) or the indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the CSI reporting setting(s) in the subset of CSI reporting setting(s) could be used or applied for actual candidate/new beam(s) measurement on/for the determined or identified subset of carrier(s)/CC(s)/cell(s) corresponding to the subset of the one or more CSI reporting settings respectively according to or following those specified herein in the present disclosure, and/or the UE could determine or identify that the candidate/new beam RS resource(s) linked/associated/specific to the one or more CSI reporting settings configured/provided for the UE-initiated/event-driven beam reporting according to or following those specified herein in the present disclosure could be used or applied for actual candidate/new beam(s) measurement on/for the (reference) carrier(s)/CC(s)/cell(s) corresponding to the one or more CSI reporting settings respectively according to or following those specified herein in the present disclosure.

An indicator/trigger as specified/defined herein in the present disclosure could correspond to a ‘CSI request’ field in a corresponding DCI format(s) 0_1 and/or 0_2 (and therefore, a corresponding trigger state). That is, when/if the UE has received or indicated or determined or identified a trigger state (via the indicated ‘CSI request’ field in the corresponding DCI format(s) 0_1 and/or 0_2) pointing/linking/corresponding/associated/specific to any one or more of the CSI reporting setting(s) in the subset of CSI reporting setting(s), the UE could determine or identify that the candidate/new beam RS resource(s) linked/associated/specific to the CSI reporting setting(s) in the subset of CSI reporting setting(s) could be used or applied for actual candidate/new beam(s) measurement on/for the subset of carrier(s)/CC(s)/cell(s) corresponding to the subset of the one or more CSI reporting settings respectively according to or following those specified herein in the present disclosure.

In one embodiment, a CSI reporting setting provided by CSI-ReportConfig or ueiCSI-ReportConfig for the UE-initiated/event-driven beam reporting as specified/defined herein in the present disclosure could be associated/linked/specific to, and/or higher layer parameter(s) TCI-State/UL-TCIState that configures or provides a joint/DL/UL TCI state could provide or comprise, one or more CSI resource settings each provided by CSI-ResourceConfig or ueiCSI-ResourceConfig for the UE-initiated/event-driven beam reporting as specified/defined herein in the present disclosure, wherein each of the one or more CSI resource settings could provide, configure, comprise, contain or include one or more CSI resource sets including SSB resource set(s) and/or NZP CSI-RS resource set(s), and/or each of the one or more CSI resource sets could provide, configure, comprise, contain or include one or more CSI-RS resources including SSB(s) and/or NZP CSI-RS resource(s). In a multi-carrier or multi-CC or multi-cell system, wherein one or more (e.g., multiple or more than one) carriers and/or component carriers (CCs) and/or cells could be configured, provided and/or enabled by the network, e.g., via higher layer RRC signaling(s)/parameter(s) and/or MAC CE command(s) and/or dynamic DCI based L1 signaling(s) based on or according to a corresponding UE's capability or capability signaling—e.g., when/if a UE is higher layer configured/provided by the network, e.g., in higher layer parameter(s) CSI-ReportConfig, CSI-ResourceConfig, UEI-ReportConfig and/or UEI-ResourceConfig that provides or configures necessary information and/or setting(s) for the corresponding UE-initiated/event-driven beam reporting, one or more lists of carriers (e.g., in terms/form of their carrier IDs/indexes), one or more lists of CCs (e.g., in terms/form of their CC IDs/indexes), and/or one or more lists of cells (e.g., in terms/form of their cell IDs/indexes), for the UE-initiated/event-driven beam operations including beam reporting, and/or when/if a UE is higher layer configured/provided by the network, e.g., in higher layer parameter(s) CSI-ReportConfig, CSI-ResourceConfig, ueiCSI-ReportConfig and/or ueiCSI-ResourceConfig that provides or configures necessary information and/or setting(s) for the corresponding UE-initiated/event-driven beam reporting, higher layer parameter(s) multiCarrierBeamReporting, multiCCBeamReporting, multiCellBeamReporting, crossCarrierBeamReporting, crossCCBeamReporting, crossCellBeamReporting and/or etc. dedicated for enabling the multi-carrier (or cross-carrier), multi-CC (or cross-CC) and/or multi-cell (or cross-cell) beam reporting (e.g., set to ‘enabled’), the one or more CSI resource settings (and therefore, the corresponding CSI resource set(s) including SSB resource set(s) and/or NZP CSI-RS resource set(s), and/or the corresponding CSI-RS resource(s) including SSB(s) and/or NZP CSI-RS resource(s) provided/configured therein) for the UE-initiated/event-driven beam reporting as specified/defined herein in the present disclosure could be associated or specific to one or more carriers/CCs/cells according to or following one or more of:
In one example, the UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a list/set/pool of carriers/CCs/cells (e.g., in terms/form of their carrier/CC/cell IDs/indexes). For instance, the higher layer parameter(s) CSI-ReportConfig and/or ueiCSI-ReportConfig that configures or provides a/the CSI reporting setting for the UEI/event-driven beam reporting, and/or the higher layer parameter(s) TCI-State/UL-TCIState that configures or provides a joint/DL/UL TCI state and comprises or provides the one or more CSI resource settings for the UEI/event-driven beam reporting, could also provide or configure or include or comprise or contain the list/set/pool of carrier/CC/cell indexes/IDs. In this case,
   For example, (i) when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, each of the one or more CSI resource settings (and therefore, the corresponding CSI resource set(s) including SSB resource set(s) and/or NZP CSI-RS resource set(s), and/or CSI-RS resource(s) including SSB(s) and/or NZP CSI-RS resource(s) configured/provided therein) could be associated or specific to one or more carriers/CCs/cells in the list/set/pool according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s), (ii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising or configuring or providing one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be associated or specific to one or more carriers/CCs/cells in the list/set/pool according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s), and/or (iii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising or configuring or providing one CSI resource set comprising or configuring or providing one or more CSI-RS resources (including SSB(s) and/or NZP CSI-RS resource(s)) as defined/specified herein in the present disclosure, each of the one or more CSI-RS resources could be associated or specific to one or more carriers/CCs/cells in the list/set/pool according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s).
   For another example, (i) when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, each of the one or more CSI resource settings (and therefore, the corresponding CSI resource set(s) including SSB resource set(s) and/or NZP CSI-RS resource set(s), and/or CSI-RS resource(s) including SSB(s) and/or NZP CSI-RS resource(s) configured/provided therein) could be one-to-one mapped/associated/specific to the carriers/CCs/cells in the list/set/pool according to a fixed rule in system specification(s) and/or per RRC (re-)configuration; for instance, the first/last CSI resource setting or the CSI resource setting with the lowest/highest resourceConfigId among the one or more CSI resource settings provided/configured for the UE-initiated/event-driven beam reporting specified/defined herein in the present disclosure could be mapped/associated/specific to the first/last entry in the list/set/pool or the carrier/CC/cell in the list/set/pool with the lowest/highest carrier/CC/cell index/ID among the carriers/CCs/cells in the list/set/pool, and so on, and the last/first CSI resource setting or the CSI resource setting with the highest/lowest resourceConfigId among the one or more CSI resource settings provided/configured for the UE-initiated/event-driven beam reporting specified/defined herein in the present disclosure could be mapped/associated/specific to the last/first entry in the list/set/pool or the carrier/CC/cell in the list/set/pool with the highest/lowest carrier/CC/cell index/ID among the carriers/CCs/cells in the list/set/pool, (ii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be one-to-one mapped/associated/specific to the carriers/CCs/cells in the list/set/pool according to a fixed rule in system specification(s) and/or per RRC (re-)configuration; for instance, the first/last CSI resource set or the CSI resource set with the lowest/highest resource set ID/index value among the one or more CSI resource sets provided/configured for the UE-initiated/event-driven beam reporting specified/defined herein in the present disclosure could be mapped/associated/specific to the first/last entry in the list/set/pool or the carrier/CC/cell in the list/set/pool with the lowest/highest carrier/CC/cell index/ID among the carriers/CCs/cells in the list/set/pool, and so on, and the last/first CSI resource set or the CSI resource set with the highest/lowest resource set ID/index value among the one or more CSI resource sets provided/configured for the UE-initiated/event-driven beam reporting specified/defined herein in the present disclosure could be mapped/associated/specific to the last/first entry in the list/set/pool or the carrier/CC/cell in the list/set/pool with the highest/lowest carrier/CC/cell index/ID among the carriers/CCs/cells in the list/set/pool, and/or (iii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one CSI resource set comprising, configuring or providing one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the list/set/pool according to a fixed rule in system specification(s) and/or per RRC (re-)configuration; for instance, the first/last CSI-RS resource or the CSI-RS resource with the lowest/highest resource ID/index value among the one or more CSI-RS resources provided/configured for the UE-initiated/event-driven beam reporting specified/defined herein in the present disclosure could be mapped/associated/specific to the first/last entry in the list/set/pool or the carrier/CC/cell in the list/set/pool with the lowest/highest carrier/CC/cell index/ID among the carriers/CCs/cells in the list/set/pool, and so on, and the last/first CSI-RS resource or the CSI-RS resource with the highest/lowest resource ID/index value among the one or more CSI-RS resources provided/configured for the UE-initiated/event-driven beam reporting specified/defined herein in the present disclosure could be mapped/associated/specific to the last/first entry in the list/set/pool or the carrier/CC/cell in the list/set/pool with the highest/lowest carrier/CC/cell index/ID among the carriers/CCs/cells in the list/set/pool.
   For another example, (i) when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, each of the one or more CSI resource settings (and therefore, the corresponding CSI resource set(s) including SSB resource set(s) and/or NZP CSI-RS resource set(s), and/or CSI-RS resource(s) including SSB(s) and/or NZP CSI-RS resource(s) configured/provided therein) could be one-to-one mapped/associated/specific to the carriers/CCs/cells in the list/set/pool according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s), (ii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be one-to-one mapped/associated/specific to the carriers/CCs/cells in the list/set/pool according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s), and/or (iii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one CSI resource set comprising, configuring or providing one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the list/set/pool according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s).
In another example, the UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a list/set/pool of carriers/CCs/cells (e.g., in terms/form of their carrier/CC/cell IDs/indexes). For this design example, the UE (e.g., the UE 116) could be further provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a subset of carriers/CCs/cells (e.g., in terms/form of their carrier/CC/cell IDs/indexes) from/out of the carriers/CCs/cells in the list/set/pool. For instance, the higher layer parameter(s) CSI-ReportConfig and/or ueiCSI-ReportConfig that configures or provides a/the CSI reporting setting for the UEI/event-driven beam reporting, and/or the higher layer parameter(s) TCI-State/UL-TCIState that configures or provides a joint/DL/UL TCI state and comprises or provides the one or more CSI resource settings for the UEI/event-driven beam reporting, could also provide or configure or include or comprise or contain information related to the subset of carrier/CC/cell indexes/IDs.
   For example, the information could be or could comprise a bitmap with each entry/bit position of the bitmap corresponding to an entry in the list/set/pool of carriers/CCs/cells (e.g., in terms/form of their carrier/CC/cell IDs/indexes). In this case, when/if an entry/bit position in the bitmap is set to ‘1’ (or ‘0’), the carrier/CC/cell ID/index in the list/set/pool corresponding to the entry/bit position could belong to the subset of carriers/CCs/cells.
   For another example, the information could be or could comprise one or more one-bit indicators each corresponding to an entry in the list/set/pool of carriers/CCs/cells (e.g., in terms/form of their carrier/CC/cell IDs/indexes). In this case, when/if a one-bit indicator is set to ‘1’ (or ‘0’), the carrier/CC/cell ID/index in the list/set/pool corresponding to the one-bit indicator could belong to the subset of carriers/CCs/cells.
   For another example, the information could be or could comprise IDs of the carriers/CCs/cells in the subset, and/or indexes of the carriers/CCs/cells in the subset from/out of the carriers/CCs/cells in the list/set/pool.

In this case,
For example, (i) when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, each of the one or more CSI resource settings (and therefore, the corresponding CSI resource set(s) including SSB resource set(s) and/or NZP CSI-RS resource set(s), and/or CSI-RS resource(s) including SSB(s) and/or NZP CSI-RS resource(s) configured/provided therein) could be associated or specific to one or more carriers/CCs/cells in the subset according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s), (ii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising or configuring or providing one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be associated or specific to one or more carriers/CCs/cells in the subset according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals such as in part of/by CSI/beam report(s) and/or UE's capability signaling(s), and/or (iii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising or configuring or providing one CSI resource set comprising or configuring or providing one or more CSI-RS resources (including SSB(s) and/or NZP CSI-RS resource(s)) as defined/specified herein in the present disclosure, each of the one or more CSI-RS resources could be associated or specific to one or more carriers/CCs/cells in the subset according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s).
For another example, (i) when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, each of the one or more CSI resource settings (and therefore, the corresponding CSI resource set(s) including SSB resource set(s) and/or NZP CSI-RS resource set(s), and/or CSI-RS resource(s) including SSB(s) and/or NZP CSI-RS resource(s) configured/provided therein) could be one-to-one mapped/associated/specific to the carriers/CCs/cells in the subset according to a fixed rule in system specification(s) and/or per RRC (re-)configuration; for instance, the first/last CSI resource setting or the CSI resource setting with the lowest/highest resourceConfigId among the one or more CSI resource settings provided/configured for the UE-initiated/event-driven beam reporting specified/defined herein in the present disclosure could be mapped/associated/specific to the first/last entry in the subset or the carrier/CC/cell in the subset with the lowest/highest carrier/CC/cell index/ID among the carriers/CCs/cells in the subset, and so on, and the last/first CSI resource setting or the CSI resource setting with the highest/lowest resourceConfigId among the one or more CSI resource settings provided/configured for the UE-initiated/event-driven beam reporting specified/defined herein in the present disclosure could be mapped/associated/specific to the last/first entry in the subset or the carrier/CC/cell in the subset with the highest/lowest carrier/CC/cell index/ID among the carriers/CCs/cells in the subset, (ii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be one-to-one mapped/associated/specific to the carriers/CCs/cells in the subset according to a fixed rule in system specification(s) and/or per RRC (re-)configuration; for instance, the first/last CSI resource set or the CSI resource set with the lowest/highest resource set ID/index value among the one or more CSI resource sets provided/configured for the UE-initiated/event-driven beam reporting specified/defined herein in the present disclosure could be mapped/associated/specific to the first/last entry in the subset or the carrier/CC/cell in the subset with the lowest/highest carrier/CC/cell index/ID among the carriers/CCs/cells in the subset, and so on, and the last/first CSI resource set or the CSI resource set with the highest/lowest resource set ID/index value among the one or more CSI resource sets provided/configured for the UE-initiated/event-driven beam reporting specified/defined herein in the present disclosure could be mapped/associated/specific to the last/first entry in the subset or the carrier/CC/cell in the subset with the highest/lowest carrier/CC/cell index/ID among the carriers/CCs/cells in the subset, and/or (iii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one CSI resource set comprising, configuring or providing one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the subset according to a fixed rule in system specification(s) and/or per RRC (re-)configuration; for instance, the first/last CSI-RS resource or the CSI-RS resource with the lowest/highest resource ID/index value among the one or more CSI-RS resources provided/configured for the UE-initiated/event-driven beam reporting specified/defined herein in the present disclosure could be mapped/associated/specific to the first/last entry in the subset or the carrier/CC/cell in the subset with the lowest/highest carrier/CC/cell index/ID among the carriers/CCs/cells in the subset, and so on, and the last/first CSI-RS resource or the CSI-RS resource with the highest/lowest resource ID/index value among the one or more CSI-RS resources provided/configured for the UE-initiated/event-driven beam reporting specified/defined herein in the present disclosure could be mapped/associated/specific to the last/first entry in the subset or the carrier/CC/cell in the subset with the highest/lowest carrier/CC/cell index/ID among the carriers/CCs/cells in the subset.
For another example, (i) when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, each of the one or more CSI resource settings (and therefore, the corresponding CSI resource set(s) including SSB resource set(s) and/or NZP CSI-RS resource set(s), and/or CSI-RS resource(s) including SSB(s) and/or NZP CSI-RS resource(s) configured/provided therein) could be one-to-one mapped/associated/specific to the carriers/CCs/cells in the subset according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s), (ii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be one-to-one mapped/associated/specific to the carriers/CCs/cells in the subset according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s), and/or (iii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one CSI resource set comprising, configuring or providing one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the subset according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s).
In another example, (i) when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, each of the one or more CSI resource settings (and therefore, the corresponding CSI resource set(s) including SSB resource set(s) and/or NZP CSI-RS resource set(s), and/or CSI-RS resource(s) including SSB(s) and/or NZP CSI-RS resource(s) configured/provided therein) could be associated/specific to a carrier/CC/cell (e.g., in terms/form of a carrier/CC/cell ID/index from/in a list/set/pool of carrier/CC/cell IDs/indexes); for instance, the higher layer parameter(s) CSI-ResourceConfig and/or ueiCSI-ResourceConfig that configures or provides a CSI resource setting for the UE-initiated/event-driven beam reporting could also provide, configure, comprise, include or contain a carrier/CC/cell ID/index, (ii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be associated/specific to a carrier/CC/cell (e.g., in terms/form of a carrier/CC/cell ID/index from/in a list/set/pool of carrier/CC/cell IDs/indexes); for instance, the higher layer parameter(s) that configures or provides a CSI resource set for the UE-initiated/event-driven beam reporting could also provide, configure, comprise, include or contain a carrier/CC/cell ID/index, and/or (iii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, configuring or providing one CSI resource set comprising, configuring or providing one or more CSI-RS resources including SSB(s) and/or NZP CSI-RS resource(s) as defined/specified herein in the present disclosure, each of the one or more CSI-RS resources could be associated/specific to a carrier/CC/cell (e.g., in terms/form of a carrier/CC/cell ID/index from/in a list/set/pool of carrier/CC/cell IDs/indexes); for instance, the higher layer parameter(s) that configures or provides a CSI-RS resource for the UE-initiated/event-driven beam reporting could also provide, configure, comprise, include or contain a carrier/CC/cell ID/index.

When/if (i) a UE has determined or identified a CSI resource setting provided/configured for the UE-initiated/event-driven beam reporting as specified/defined herein in the present disclosure associated/specific to a carrier/CC/cell according to or following those specified/described herein in the present disclosure, the UE could also determine or identify that the CSI-RS resource(s) including SSB(s) and/or NZP CSI-RS resource(s) provided/configured/indicated in the determined or identified CSI resource setting could be associated/specific to the carrier/CC/cell, (ii) a UE has determined or identified a CSI resource set provided/configured for the UE-initiated/event-driven beam reporting as specified/defined herein in the present disclosure associated/specific to a carrier/CC/cell according to or following those specified/described herein in the present disclosure, the UE could also determine or identify that the CSI-RS resource(s) including SSB(s) and/or NZP CSI-RS resource(s) provided/configured/indicated in the determined or identified CSI resource set could be associated/specific to the carrier/CC/cell, and/or (iii) a UE has determined or identified a CSI-RS resource provided/configured for the UE-initiated/event-driven beam reporting as specified/defined herein in the present disclosure associated/specific to a carrier/CC/cell according to or following those specified/described herein in the present disclosure, the UE could also determine or identify that the CSI-RS resource including SSB and/or NZP CSI-RS resource could be associated/specific to the carrier/CC/cell, wherein the UE could determine or identify the CSI-RS resource(s) including SSB(s) and/or NZP CSI-RS resource(s) as candidate/new beam RS resource(s) for the UE-initiated/event-driven beam reporting for/on the carrier/CC/cell. For actual candidate/new beam(s) measurement in a multi-carrier or multi-CC or multi-cell system as specified/defined herein in the present disclosure,
In one example, (i) when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, the UE could determine or identify which one or more of the one or more CSI resource settings to use or apply for determining or identifying candidate/new beam RS resource(s) for actual candidate/new beam(s) measurement on/for the corresponding carrier(s)/CC(s)/cell(s) according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s), (ii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, providing or configuring one or more CSI resource sets including SSB resource set(s) and/or NZP CSI-RS resource set(s) as defined/specified herein in the present disclosure, the UE could determine or identify which one or more of the one or more CSI resource sets to use or apply for determining or identifying candidate/new beam RS resource(s) for actual candidate/new beam(s) measurement on/for the corresponding carrier(s)/CC(s)/cell(s) according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s), and/or (iii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, providing or configuring one CSI resource set comprising, providing or configuring one or more CSI-RS resources including SSB(s) and/or NZP CSI-RS resource(s) as defined/specified herein in the present disclosure, the UE could determine or identify which one or more of the one or more CSI-RS resources to use or apply for determining or identifying candidate/new beam RS resource(s) for actual candidate/new beam(s) measurement on/for the corresponding carrier(s)/CC(s)/cell(s) according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). The following design examples specify, illustrate, discuss, explain and focus on means of determining or identifying which one or more of the one or more CSI resource settings to use or apply for determining or identifying candidate/new beam RS resource(s) for actual candidate/new beam(s) measurement on/for the corresponding carrier(s)/CC(s)/cell(s) as discussed in (i), which could be extended and applied for determining or identifying which one or more of the one or more CSI resource sets to use or apply for determining or identifying candidate/new beam RS resource(s) for actual candidate/new beam(s) measurement on/for the corresponding carrier(s)/CC(s)/cell(s), and determining or identifying which one or more of the one or more CSI-RS resources to use or apply for determining or identifying candidate/new beam RS resource(s) for actual candidate/new beam(s) measurement on/for the corresponding carrier(s)/CC(s)/cell(s) as discussed in (ii) and (iii), respectively.
   For example, the UE could determine or identify that the candidate/new beam RS resource(s) provided/configured/indicated in a subset of the one or more CSI resource settings—associated/corresponding/specific to a/the (same) CSI reporting setting and/or provided/comprised in the higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource settings respectively according to or following those specified herein in the present disclosure. In this case, the subset could correspond to the one or more CSI resource settings configured/provided for the UE-initiated/event-driven beam reporting according to or following those specified herein in the present disclosure; optionally, the subset could correspond to the CSI resource setting(s) with odd (or event) resourceConfigId value(s) and/or the odd (or even) numbered/indexed CSI resource setting(s) among the one or more CSI resource settings configured/provided for the UE-initiated/event-driven beam reporting as specified/defined herein in the present disclosure; alternatively, the subset could correspond to the CSI resource setting(s) with the K≥1 highest/lowest resourceConfigId value(s) and/or the first/last K≥1 CSI resource setting(s) among the one or more CSI resource settings configured/provided for the UE-initiated/event-driven beam reporting as specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI resource settings in the subset, and/or a second indicator or trigger pointing/corresponding/associated/specific to the CSI reporting setting/TCI state associated/corresponding/specific to the (subset of) one or more CSI resource settings as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource setting in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the subset of the one or more CSI resource settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource settings respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the subset of the one or more CSI resource settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource settings respectively according to or following those specified herein in the present disclosure, and/or the UE could determine or identify that the candidate/new beam RS resource(s) linked/associated/specific to the one or more CSI resource settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI resource settings respectively according to or following those specified herein in the present disclosure.
   For another example, the UE could determine or identify that the candidate/new beam RS resource(s) linked/associated/specific to a subset of the one or more CSI resource settings—associated/corresponding/specific to a/the (same) CSI reporting setting and/or provided/comprised in the higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource settings respectively according to or following those specified herein in the present disclosure, wherein the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset. For instance, the information related to the subset could be or could correspond to a bitmap with each entry/bit position of the bitmap corresponding to a CSI resource setting configured/provided for the UE-initiated/event-driven beam reporting as specified/defined herein in the present disclosure; when/if an entry/bit position of the bitmap is set to ‘1’ (or ‘0’), the corresponding CSI resource setting could belong to the subset. Alternatively, the information related to the subset could correspond to or comprise one or more one-bit indicators each corresponding/associated to a CSI resource setting configured/provided for the UE-initiated/event-driven beam reporting as specified/defined herein in the present disclosure; when/if a one-bit indicator is set to ‘1’ (or ‘0’), the corresponding CSI resource setting could belong to the subset. Optionally, the information related to the subset could correspond to or could comprise one or more resource setting IDs (or resourceConfigId's); in this case, the CSI resource setting(s) with the one or more resource setting IDs/resourceConfigId's could belong to the subset. For this design example, the UE (e.g., the UE 116) could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI resource settings in the subset, and/or a second indicator or trigger pointing/corresponding/associated/specific to the CSI reporting setting/TCI state associated/corresponding/specific to the (subset of) one or more CSI resource settings as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource setting in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the subset of the one or more CSI resource settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource settings respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network (e.g., the network 130), the UE could still determine or identify that the candidate/new beam RS resource(s) linked/associated/specific to the subset of the one or more CSI resource settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource settings respectively according to or following those specified herein in the present disclosure, and/or the UE could determine or identify that the candidate/new beam RS resource(s) linked/associated/specific to the one or more CSI resource settings configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI resource settings respectively according to or following those specified herein in the present disclosure.
   For another example, the UE could determine or identify that the candidate/new beam RS resource(s) provided/configured/indicated in a subset of the one or more CSI resource sets—provided/configured/indicated in a/the (same) CSI resource setting associated/corresponding/specific to a/the (same) CSI reporting setting and/or provided/comprised in the higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure. In this case, the subset could correspond to the one or more CSI resource sets configured/provided for the UE-initiated/event-driven beam reporting according to or following those specified herein in the present disclosure; optionally, the subset could correspond to the CSI resource set(s) with odd (or event) resource set ID/index value(s) and/or the odd (or even) numbered/indexed CSI resource set(s) among the one or more CSI resource sets configured/provided for the UE-initiated/event-driven beam reporting as specified/defined herein in the present disclosure; alternatively, the subset could correspond to the CSI resource set(s) with the K≥1 highest/lowest resource set ID/index value(s) and/or the first/last K≥1 CSI resource set(s) among the one or more CSI resource sets configured/provided for the UE-initiated/event-driven beam reporting as specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI resource sets in the subset, and/or a second indicator or trigger pointing/corresponding/associated/specific to the CSI reporting setting/TCI state associated/corresponding/specific to the (subset of) one or more CSI resource sets as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource set in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the subset of the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the subset of the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure, and/or the UE could determine or identify that the candidate/new beam RS resource(s) linked/associated/specific to the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI resource sets respectively according to or following those specified herein in the present disclosure.
   For another example, the UE could determine or identify that the candidate/new beam RS resource(s) provided/configured/indicated in a subset of the one or more CSI resource sets—provided/configured/indicated in a/the (same) CSI resource setting associated/corresponding/specific to a/the (same) CSI reporting setting and/or provided/comprised in higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure, wherein the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset. For instance, the information related to the subset could be or could correspond to a bitmap with each entry/bit position of the bitmap corresponding to a CSI resource set configured/provided for the UE-initiated/event-driven beam reporting as specified/defined herein in the present disclosure; when/if an entry/bit position of the bitmap is set to ‘1’ (or ‘0’), the corresponding CSI resource set could belong to the subset. Alternatively, the information related to the subset could correspond to or comprise one or more one-bit indicators each corresponding/associated to a CSI resource set configured/provided for the UE-initiated/event-driven beam reporting as specified/defined herein in the present disclosure; when/if a one-bit indicator is set to ‘1’ (or ‘0’), the corresponding CSI resource set could belong to the subset. Optionally, the information related to the subset could correspond to or could comprise one or more resource set IDs/indexes; in this case, the CSI resource set(s) with the one or more resource set IDs/indexes could belong to the subset. For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI resource sets in the subset, and/or a second indicator or trigger pointing/corresponding/associated/specific to the CSI reporting setting/TCI state associated/corresponding/specific to the (subset of) one or more CSI resource sets as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource set in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the subset of the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the subset of the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure, and/or the UE could determine or identify that the candidate/new beam RS resource(s) linked/associated/specific to the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI resource sets respectively according to or following those specified herein in the present disclosure.
   For another example, the UE could determine or identify that the candidate/new beam RS resource(s) corresponding to a subset of the one or more CSI-RS resources—provided/configured/indicated in a/the (same) CSI resource set provided/configured/indicated in a/the (same) CSI resource setting associated/corresponding/specific to a/the (same) CSI reporting setting and/or provided/comprised in the higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure. In this case, the subset could correspond to the one or more CSI-RS resources configured/provided for the UE-initiated/event-driven beam reporting according to or following those specified herein in the present disclosure; optionally, the subset could correspond to the CSI-RS resource(s) with odd (or event) resource ID/index value(s) and/or the odd (or even) numbered/indexed CSI-RS resource(s) among the one or more CSI-RS resources configured/provided for the UE-initiated/event-driven beam reporting as specified/defined herein in the present disclosure; alternatively, the subset could correspond to the CSI-RS resource(s) with the K≥1 highest/lowest resource ID/index value(s) and/or the first/last K≥1 CSI-RS resource(s) among the one or more CSI-RS resources configured/provided for the UE-initiated/event-driven beam reporting as specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI-RS resources in the subset, and/or a second indicator or trigger pointing/corresponding/associated/specific to the CSI reporting setting/TCI state associated/corresponding/specific to the (subset of) one or more CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI-RS resource in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure, and/or the UE could determine or identify that the candidate/new beam RS resource(s) corresponding to the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI-RS resources respectively according to or following those specified herein in the present disclosure.
   For another example, the UE could determine or identify that the candidate/new beam RS resource(s) corresponding to a subset of the one or more CSI-RS resources—provided/configured/indicated in a/the (same) CSI resource set provided/configured/indicated in a/the (same) CSI resource setting associated/corresponding/specific to a/the (same) CSI reporting setting and/or provided/comprised in the higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure, wherein the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset. For instance, the information related to the subset could be or could correspond to a bitmap with each entry/bit position of the bitmap corresponding to a CSI-RS resource configured/provided for the UE-initiated/event-driven beam reporting as specified/defined herein in the present disclosure; when/if an entry/bit position of the bitmap is set to ‘1’ (or ‘0’), the corresponding CSI-RS resource could belong to the subset. Alternatively, the information related to the subset could correspond to or comprise one or more one-bit indicators each corresponding/associated to a CSI-RS resource configured/provided for the UE-initiated/event-driven beam reporting as specified/defined herein in the present disclosure; when/if a one-bit indicator is set to ‘1’ (or ‘0’), the corresponding CSI-RS resource could belong to the subset. Optionally, the information related to the subset could correspond to or could comprise one or more resource IDs/indexes; in this case, the CSI-RS resource(s) with the one or more resource IDs/indexes could belong to the subset. For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI-RS resources in the subset, and/or a second indicator or trigger pointing/corresponding/associated/specific to the CSI reporting setting/TCI state associated/corresponding/specific to the (subset of) one or more CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI-RS resource in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure, and/or the UE could determine or identify that the candidate/new beam RS resource(s) corresponding to the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI-RS resources respectively according to or following those specified herein in the present disclosure.

A first or second indicator/trigger as specified/defined herein in the present disclosure could correspond to a ‘CSI request’ field in a corresponding DCI format(s) 0_1 and/or 0_2 (and therefore, a corresponding trigger state). That is, when/if the UE has received or indicated or determined or identified a trigger state (via the indicated ‘CSI request’ field in the corresponding DCI format(s) 0_1 and/or 0_2) pointing/linking/corresponding/associated/specific to any one or more of the CSI resource setting(s) in the subset of CSI resource setting(s) as in case (i) defined/specified herein, any one or more of the CSI resource set(s) in the subset of CSI resource set(s) as in case (ii) defined/specified herein, any one or more of the CSI-RS resource(s) in the subset of CSI-RS resource(s) as in case (iii) defined/specified herein, or the CSI reporting setting/TCI state associated/specific/corresponding/linked to the one or more CSI resource settings as in case (i) defined/specified herein, the one or more CSI resource sets as in case (ii) defined/specified herein, or the one or more CSI-RS resources including SSB(s) and/or NZP CSI-RS resource(s) as in case (iii) defined/specified herein, the UE could determine or identify that the candidate/new beam RS resource(s) linked/associated/specific/corresponding to the CSI resource setting(s) in the subset of CSI resource setting(s) in the case of (i) as specified/defined herein, the CSI resource set(s) in the subset of CSI resource set(s) in the case of (ii) as specified/defined herein, or the CSI-RS resource(s) in the subset of CSI-RS resource(s) in the case of (iii) as specified/defined herein, could be used or applied for actual candidate/new beam(s) measurement on/for the subset of carrier(s)/CC(s)/cell(s) corresponding to (i) the subset of CSI resource setting(s), (ii) the subset of CSI resource set(s) or (iii) the subset of CSI-RS resource(s) according to or following those specified herein in the present disclosure.

In another example, (i) when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, the carriers/CCs/cells (e.g., in form/terms of their IDs/indexes) associated/specific/linked to the one or more CSI resource settings configured/provided for the UE-initiated/event-driven beam reporting according to or following those specified herein in the present disclosure could be denoted by or referred to as reference carriers/CCs/cells for this design example, (ii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, providing or configuring one or more CSI resource sets including SSB resource set(s) and/or NZP CSI-RS resource set(s) as defined/specified herein in the present disclosure, the carriers/CCs/cells (e.g., in form/terms of their IDs/indexes) associated/specific/linked to the one or more CSI resource sets could be denoted by or referred to as reference carriers/CCs/cells for this design example, and/or (iii) when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, providing or configuring one CSI resource set comprising, providing or configuring one or more CSI-RS resources including SSB(s) and/or NZP CSI-RS resource(s) as defined/specified herein in the present disclosure, the carriers/CCs/cells (e.g., in form/terms of their IDs/indexes) associated/specific/linked to the one or more CSI-RS resources could be denoted by or referred to as reference carriers/CCs/cells for this design example. The UE (e.g., the UE 116) could first determine or identify a subset of the reference carriers/CCs/cells according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). The UE could then determine or identify a subset of the one or more CSI resource settings, a subset of the one or more CSI resource sets and/or a subset of the one or more CSI-RS resources—corresponding/associated/specific to the determined or identified subset of carrier(s)/CC(s)/cell(s) according to or following those specified herein in the present disclosure—to use or apply for determining or identifying candidate/new beam RS resource(s) for actual candidate/new beam(s) measurement on/for the corresponding carrier(s)/CC(s)/cell(s).

For example, the subset of carrier(s)/CC(s)/cell(s) could correspond to the reference carriers/CCs/cells; optionally, the subset of carrier(s)/CC(s)/cell(s) could correspond to the carrier(s)/CC(s)/cell(s) with odd (or event) carrier/CC/cell ID(s)/index(es) and/or the odd (or even) numbered/indexed carrier(s)/CC(s)/cell(s) among the reference carriers/CCs/cells specified/defined herein in the present disclosure; alternatively, the subset of carrier(s)/CC(s)/cell(s) could correspond to the carrier(s)/CC(s)/cell(s) with the K≥1 highest/lowest carrier/CC/cell ID(s)/index(es) and/or the first/last K≥1 carrier(s)/CC(s)/cell(s) among the reference carriers/CCs/cells specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to (i) one or more CSI resource settings in the subset of CSI resource setting(s)—note here that as specified/defined herein in the present disclosure, the subset of CSI resource setting(s) could be associated/corresponding/specific to the determined or identified subset of carrier(s)/CC(s)/cell(s)—when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, (ii) one or more CSI resource sets in the subset of CSI resource set(s)—note here that as specified/defined herein in the present disclosure, the subset of CSI resource set(s) could be associated/corresponding/specific to the determined or identified subset of carrier(s)/CC(s)/cell(s)—when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, providing or configuring one or more CSI resource sets including SSB resource set(s) and/or NZP CSI-RS resource set(s) as defined/specified herein in the present disclosure, and/or (iii) one or more CSI-RS resources in the subset of CSI-RS resource(s)—note here that as specified/defined herein in the present disclosure, the subset of CSI-RS resource(s) could be associated/corresponding/specific to the determined or identified subset of carrier(s)/CC(s)/cell(s)—when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, providing or configuring one CSI resource set comprising, providing or configuring one or more CSI-RS resources including SSB(s) and/or NZP CSI-RS resource(s) as defined/specified herein in the present disclosure, and/or a second indicator or trigger pointing/corresponding/associated/specific to the CSI reporting setting/TCI state associated/corresponding/specific to the (subset of) one or more CSI resource settings/CSI resource sets/CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource setting in the subset of CSI reporting setting(s)—in the case of (i) as specified/defined herein, a CSI resource set in the subset of CSI resource set(s)—in the case of (ii) as specified/defined herein, or a CSI-RS resource in the subset of CSI-RS resource(s)—in the case of (iii) as specified/defined herein, and/or a second indicator or trigger pointing/corresponding/associated/specific to the CSI reporting setting/TCI state; when/if the UE has received or detected such first indicator(s)/trigger(s) and/or second indicator/trigger from the network (e.g., the network 130), the UE could determine or identify that the candidate/new beam RS resource(s) linked/associated/specific to the CSI resource setting(s) in the subset of CSI resource setting(s) as in case (i) specified/defined herein, the CSI resource set(s) in the subset of CSI resource set(s) as in case (ii) specified/defined herein or the CSI-RS resource(s) in the subset of CSI-RS resource(s) as in case (iii) specified/defined herein could be used or applied for actual candidate/new beam(s) measurement on/for the determined or identified subset of carrier(s)/CC(s)/cell(s) corresponding to (i) the subset of CSI resource setting(s), (ii) the subset of CSI resource set(s) or (iii) the subset of CSI-RS resource(s) according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the CSI resource setting(s) in the subset of CSI resource setting(s) as in case (i) specified/defined herein, the CSI resource set(s) in the subset of CSI resource set(s) as in case (ii) specified/defined herein or the CSI-RS resource(s) in the subset of CSI-RS resource(s) as in case (iii) specified/defined herein could be used or applied for actual candidate/new beam(s) measurement on/for the determined or identified subset of carrier(s)/CC(s)/cell(s) corresponding to (i) the subset of CSI resource setting(s), (ii) the subset of CSI resource set(s) or (iii) the subset of CSI-RS resource(s) according to or following those specified herein in the present disclosure, and/or the UE could determine or identify that the candidate/new beam RS resource(s) linked/associated/specific to the one or more CSI resource settings as in case (i) defined/specified herein, the one or more CSI resource sets as in case (ii) defined/specified herein, or the one or more CSI-RS resources as in case (iii) defined/specified herein, linked/associated/specific/corresponding to the CSI reporting setting, and/or provided/comprised in the higher layer parameter(s) TCI-State/UL-TCIState that provides or configures a joint/DL/UL TCI state, configured/provided for the UE-initiated/event-driven beam reporting according to or following those specified herein in the present disclosure could be used or applied for actual candidate/new beam(s) measurement on/for the reference carrier(s)/CC(s)/cell(s) as defined/specified herein in the present disclosure.

For another example, the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset of carrier(s)/CC(s)/cell(s). For instance, the information related to the subset of carrier(s)/CC(s)/cell(s) could be or could correspond to a bitmap with each entry/bit position of the bitmap corresponding to a reference carrier/CC/cell as specified/defined herein in the present disclosure; when/if an entry/bit position of the bitmap is set to ‘1’ (or ‘0’), the corresponding carrier/CC/cell could belong to the subset of carrier(s)/CC(s)/cell(s). Alternatively, the information related to the subset of carrier(s)/CC(s)/cell(s) could correspond to or comprise one or more one-bit indicators each corresponding/associated to a reference carrier/CC/cell as specified/defined herein in the present disclosure; when/if a one-bit indicator is set to ‘1’ (or ‘0’), the corresponding reference carrier/CC/cell could belong to the subset of carrier(s)/CC(s)/cell(s). Optionally, the information related to the subset of carrier(s)/CC(s)/cell(s) could correspond to or could comprise one or more carrier/CC/cell IDs/indexes; in this case, the reference carrier(s)/CC(s)/cell(s) with the one or more carrier/CC/cell IDs/indexes could belong to the subset of carrier(s)/CC(s)/cell(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to (i) one or more CSI resource settings in the subset of CSI resource setting(s)—note here that as specified/defined herein in the present disclosure, the subset of CSI resource setting(s) could be associated/corresponding/specific to the determined or identified subset of carrier(s)/CC(s)/cell(s)—when/if the CSI reporting setting is linked/associated/corresponding/specific to, and/or the higher layer parameter(s) TCI-State/UL-TCIState that provides or configures a joint/DL/UL TCI state comprises or provides, one or more CSI resource settings as defined/specified herein in the present disclosure, (ii) one or more CSI resource sets in the subset of CSI resource set(s)—note here that as specified/defined herein in the present disclosure, the subset of CSI resource set(s) could be associated/corresponding/specific to the determined or identified subset of carrier(s)/CC(s)/cell(s)—when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, providing or configuring one or more CSI resource sets including SSB resource set(s) and/or NZP CSI-RS resource set(s) as defined/specified herein in the present disclosure, and/or (iii) one or more CSI-RS resources in the subset of CSI-RS resource(s)—note here that as specified/defined herein in the present disclosure, the subset of CSI-RS resource(s) could be associated/corresponding/specific to the determined or identified subset of carrier(s)/CC(s)/cell(s)—when/if the CSI reporting setting is linked/associated/corresponding/specific to, and/or the higher layer parameter(s) TCI-State/UL-TCIState that provides or configures a joint/DL/UL TCI state comprises or provides, one CSI resource setting comprising, providing or configuring one CSI resource set comprising, providing or configuring one or more CSI-RS resources including SSB(s) and/or NZP CSI-RS resource(s) as defined/specified herein in the present disclosure, and/or a second indicator or trigger pointing/corresponding/associated/specific to the CSI reporting setting/TCI state associated/corresponding/specific to the (subset of) one or more CSI resource settings/CSI resource sets/CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource setting in the subset of CSI reporting setting(s)—in the case of (i) as specified/defined herein, a CSI resource set in the subset of CSI resource set(s)—in the case of (ii) as specified/defined herein, or a CSI-RS resource in the subset of CSI-RS resource(s)—in the case of (iii) as specified/defined herein, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the CSI resource setting(s) in the subset of CSI resource setting(s) as in case (i) specified/defined herein, the CSI resource set(s) in the subset of CSI resource set(s) as in case (ii) specified/defined herein or the CSI-RS resource(s) in the subset of CSI-RS resource(s) as in case (iii) specified/defined herein could be used or applied for actual candidate/new beam(s) measurement on/for the determined or identified subset of carrier(s)/CC(s)/cell(s) corresponding to (i) the subset of CSI resource setting(s), (ii) the subset of CSI resource set(s) or (iii) the subset of CSI-RS resource(s) according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the CSI resource setting(s) in the subset of CSI resource setting(s) as in case (i) specified/defined herein, the CSI resource set(s) in the subset of CSI resource set(s) as in case (ii) specified/defined herein or the CSI-RS resource(s) in the subset of CSI-RS resource(s) as in case (iii) specified/defined herein could be used or applied for actual candidate/new beam(s) measurement on/for the determined or identified subset of carrier(s)/CC(s)/cell(s) corresponding to (i) the subset of CSI resource setting(s), (ii) the subset of CSI resource set(s) or (iii) the subset of CSI-RS resource(s) according to or following those specified herein in the present disclosure, and/or the UE could determine or identify that the candidate/new beam RS resource(s) linked/associated/specific to the one or more CSI resource settings as in case (i) defined/specified herein, the one or more CSI resource sets as in case (ii) defined/specified herein, or the one or more CSI-RS resources as in case (iii) defined/specified herein, linked/associated/specific/corresponding to the CSI reporting setting, and/or provided/comprised in the higher layer parameter(s) TCI-State/UL-TCIState that provides or configures a joint/DL/UL TCI state configured/provided for the UE-initiated/event-driven beam reporting according to or following those specified herein in the present disclosure could be used or applied for actual candidate/new beam(s) measurement on/for the reference carrier(s)/CC(s)/cell(s) as defined/specified herein in the present disclosure.

A first or second indicator/trigger as specified/defined herein in the present disclosure could correspond to a ‘CSI request’ field in a corresponding DCI format(s) 0_1 and/or 0_2 (and therefore, a corresponding trigger state). That is, when/if the UE has received or indicated or determined or identified a trigger state (via the indicated ‘CSI request’ field in the corresponding DCI format(s) 0_1 and/or 0_2) pointing/linking/corresponding/associated/specific to any one or more of the CSI resource setting(s) in the subset of CSI resource setting(s) as in case (i) defined/specified herein, any one or more of the CSI resource set(s) in the subset of CSI resource set(s) as in case (ii) defined/specified herein, any one or more of the CSI-RS resource(s) in the subset of CSI-RS resource(s) as in case (iii) defined/specified herein, or the CSI reporting setting/TCI state associated/specific/corresponding/linked to the one or more CSI resource settings as in case (i) defined/specified herein, the one or more CSI resource sets as in case (ii) defined/specified herein, or the one or more CSI-RS resources including SSB(s) and/or NZP CSI-RS resource(s) as in case (iii) defined/specified herein, the UE could determine or identify that the candidate/new beam RS resource(s) linked/associated/specific/corresponding to the CSI resource setting(s) in the subset of CSI resource setting(s) in the case of (i) as specified/defined herein, the CSI resource set(s) in the subset of CSI resource set(s) in the case of (ii) as specified/defined herein, or the CSI-RS resource(s) in the subset of CSI-RS resource(s) in the case of (iii) as specified/defined herein, could be used or applied for actual candidate/new beam(s) measurement on/for the subset of carrier(s)/CC(s)/cell(s) corresponding to (i) the subset of CSI resource setting(s), (ii) the subset of CSI resource set(s) or (iii) the subset of CSI-RS resource(s) according to or following those specified herein in the present disclosure.

In one embodiment, a CSI reporting setting provided by CSI-ReportConfig or ueiCSI-ReportConfig for the UE-initiated/event-driven beam reporting as specified/defined herein in the present disclosure could be associated/linked/specific to one CSI resource setting provided by CSI-ResourceConfig or ueiCSI-ResourceConfig for the UE-initiated/event-driven beam reporting as specified/defined herein in the present disclosure, wherein the CSI resource setting could provide, configure, comprise, contain or include one or more CSI resource sets including SSB resource set(s) and/or NZP CSI-RS resource set(s), and/or each of the one or more CSI resource sets could provide, configure, comprise, contain or include one or more CSI-RS resources including SSB(s) and/or NZP CSI-RS resource(s); optionally, a joint/DL/UL TCI state could be associated/linked/specific to, e.g., the higher layer parameter(s) TCI-State/UL-TCIState that provides or configures the joint/DL/UL TCI state could provide or comprise, one or more CSI resource sets including SSB resource set(s) and/or NZP CSI-RS resource set(s), wherein each of the one or more CSI resource sets could provide, configure, comprise, contain or include one or more CSI-RS resources including SSB(s) and/or NZP CSI-RS resource(s). In a multi-carrier or multi-CC or multi-cell system, wherein one or more (e.g., multiple or more than one) carriers and/or component carriers (CCs) and/or cells could be configured, provided and/or enabled by the network, e.g., via higher layer RRC signaling(s)/parameter(s) and/or MAC CE command(s) and/or dynamic DCI based L1 signaling(s) based on or according to a corresponding UE's capability or capability signaling—e.g., when/if a UE is higher layer configured/provided by the network, e.g., in higher layer parameter(s) CSI-ReportConfig, CSI-ResourceConfig, UEI-ReportConfig and/or UEI-ResourceConfig that provides or configures necessary information and/or setting(s) for the corresponding UE-initiated/event-driven beam reporting, one or more lists of carriers (e.g., in terms/form of their carrier IDs/indexes), one or more lists of CCs (e.g., in terms/form of their CC IDs/indexes), and/or one or more lists of cells (e.g., in terms/form of their cell IDs/indexes), for the UE-initiated/event-driven beam operations including beam reporting, and/or when/if a UE is higher layer configured/provided by the network, e.g., in higher layer parameter(s) CSI-ReportConfig, CSI-ResourceConfig, ueiCSI-ReportConfig and/or ueiCSI-ResourceConfig that provides or configures necessary information and/or setting(s) for the corresponding UE-initiated/event-driven beam reporting, higher layer parameter(s) multiCarrierBeamReporting, multiCCBeamReporting, multiCellBeamReporting, crossCarrierBeamReporting, crossCCBeamReporting, crossCellBeamReporting and/or etc. dedicated for enabling the multi-carrier (or cross-carrier), multi-CC (or cross-CC) and/or multi-cell (or cross-cell) beam reporting (e.g., set to ‘enabled’), the one or more CSI resource sets (and therefore, the corresponding CSI-RS resource(s) including SSB(s) and/or NZP CSI-RS resource(s) provided/configured therein) for the UE-initiated/event-driven beam reporting as specified/defined herein in the present disclosure could be associated or specific to one or more carriers/CCs/cells according to or following one or more of:
In one example, the UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a list/set/pool of carriers/CCs/cells (e.g., in terms/form of their carrier/CC/cell IDs/indexes). For instance, the higher layer parameter(s) CSI-ResourceConfig and/or ueiCSI-ResourceConfig that configures or provides a/the CSI resource setting for the UEI/event-driven beam reporting, and/or the higher layer parameter(s) TCI-State/UL-TCIState that configures or provides a joint/DL/UL TCI state and comprises or provides the one or more CSI resource sets for the UEI/event-driven beam reporting could also provide or configure or include or comprise or contain the list/set/pool of carrier/CC/cell indexes/IDs. In this case,
   For example, (i) when/if the CSI resource setting provides, configures or comprises, and/or the higher layer parameter(s) TCI-State/UL-TCIState that provides or configures a joint/DL/UL TCI state comprises or provides, one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be associated or specific to one or more carriers/CCs/cells in the list/set/pool according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s), and/or (ii) when/if the CSI resource setting provides or configures or comprises, and/or the higher layer parameter(s) TCI-State/UL-TCIState that provides or configures a joint/DL/UL TCI state comprises or provides, one CSI resource set comprising or configuring or providing one or more CSI-RS resources (including SSB(s) and/or NZP CSI-RS resource(s)) as defined/specified herein in the present disclosure, each of the one or more CSI-RS resources could be associated or specific to one or more carriers/CCs/cells in the list/set/pool according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s).
   For another example, (i) when/if the CSI resource setting provides, configures or comprises, and/or the higher layer parameter(s) TCI-State/UL-TCIState that provides or configures a joint/DL/UL TCI state comprises or provides, one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be one-to-one mapped/associated/specific to the carriers/CCs/cells in the list/set/pool according to a fixed rule in system specification(s) and/or per RRC (re-)configuration; for instance, the first/last CSI resource set or the CSI resource set with the lowest/highest resource set ID/index among the one or more CSI resource sets provided/configured for the UE-initiated/event-driven beam reporting specified/defined herein in the present disclosure could be mapped/associated/specific to the first/last entry in the list/set/pool or the carrier/CC/cell in the list/set/pool with the lowest/highest carrier/CC/cell index/ID among the carriers/CCs/cells in the list/set/pool, and so on, and the last/first CSI resource set or the CSI resource set with the highest/lowest resource set ID/index among the one or more CSI resource sets provided/configured for the UE-initiated/event-driven beam reporting specified/defined herein in the present disclosure could be mapped/associated/specific to the last/first entry in the list/set/pool or the carrier/CC/cell in the list/set/pool with the highest/lowest carrier/CC/cell index/ID among the carriers/CCs/cells in the list/set/pool, and/or (ii) when/if the CSI resource setting provides, configures or comprises, and/or the higher layer parameter(s) TCI-State/UL-TCIState that provides or configures a joint/DL/UL TCI state comprises or provides, one CSI resource set comprising, configuring or providing one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the list/set/pool according to a fixed rule in system specification(s) and/or per RRC (re-)configuration; for instance, the first/last CSI-RS resource or the CSI-RS resource with the lowest/highest resource ID/index value among the one or more CSI-RS resources provided/configured for the UE-initiated/event-driven beam reporting specified/defined herein in the present disclosure could be mapped/associated/specific to the first/last entry in the list/set/pool or the carrier/CC/cell in the list/set/pool with the lowest/highest carrier/CC/cell index/ID among the carriers/CCs/cells in the list/set/pool, and so on, and the last/first CSI-RS resource or the CSI-RS resource with the highest/lowest resource ID/index value among the one or more CSI-RS resources provided/configured for the UE-initiated/event-driven beam reporting specified/defined herein in the present disclosure could be mapped/associated/specific to the last/first entry in the list/set/pool or the carrier/CC/cell in the list/set/pool with the highest/lowest carrier/CC/cell index/ID among the carriers/CCs/cells in the list/set/pool.
   For another example, (i) when/if the CSI resource setting provides or configures or comprises, and/or the higher layer parameter(s) TCI-State/UL-TCIState that provides or configures a joint/DL/UL TCI state comprises or provides, one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be one-to-one mapped/associated/specific to the carriers/CCs/cells in the list/set/pool according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s), and/or (ii) when/if the CSI resource setting provides or configures or comprises, and/or the higher layer parameter(s) TCI-State/UL-TCIState that provides or configures a joint/DL/UL TCI state comprises or provides, one CSI resource set comprising, configuring or providing one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the list/set/pool according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s).
In another example, the UE (e.g., the UE 116) could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a list/set/pool of carriers/CCs/cells (e.g., in terms/form of their carrier/CC/cell IDs/indexes). For this design example, the UE could be further provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a subset of carriers/CCs/cells (e.g., in terms/form of their carrier/CC/cell IDs/indexes) from/out of the carriers/CCs/cells in the list/set/pool. For instance, the higher layer parameter(s) CSI-ResourceConfig and/or ueiCSI-ResourceConfig that configures or provides a/the CSI resource setting for the UEI/event-driven beam reporting, and/or the higher layer parameter(s) TCI-State/UL-TCIState that provides or configures a joint/DL/UL TCI state and comprises or provides the one or more CSI resource sets for the UEI/event-driven beam reporting, could also provide or configure or include or comprise or contain information related to the subset of carrier/CC/cell indexes/IDs.
   For example, the information could be or could comprise a bitmap with each entry/bit position of the bitmap corresponding to an entry in the list/set/pool of carriers/CCs/cells (e.g., in terms/form of their carrier/CC/cell IDs/indexes). In this case, when/if an entry/bit position in the bitmap is set to ‘1’ (or ‘0’), the carrier/CC/cell ID/index in the list/set/pool corresponding to the entry/bit position could belong to the subset of carriers/CCs/cells.
   For another example, the information could be or could comprise one or more one-bit indicators each corresponding to an entry in the list/set/pool of carriers/CCs/cells (e.g., in terms/form of their carrier/CC/cell IDs/indexes). In this case, when/if a one-bit indicator is set to ‘1’ (or ‘0’), the carrier/CC/cell ID/index in the list/set/pool corresponding to the one-bit indicator could belong to the subset of carriers/CCs/cells.
   For another example, the information could be or could comprise IDs of the carriers/CCs/cells in the subset, and/or indexes of the carriers/CCs/cells in the subset from/out of the carriers/CCs/cells in the list/set/pool.

In this case,
For example, (i) when/if the CSI resource setting comprises or provides or configures, and/or the higher layer parameter(s) TCI-State/UL-TCIState that provides or configures a joint/DL/UL TCI state comprises or provides, one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be associated or specific to one or more carriers/CCs/cells in the subset according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals such as in part of/by CSI/beam report(s) and/or UE's capability signaling(s), and/or (ii) when/if the CSI resource setting provides or configures or comprises, and/or the higher layer parameter(s) TCI-State/UL-TCIState that provides or configures a joint/DL/UL TCI state comprises or provides, one CSI resource set comprising or configuring or providing one or more CSI-RS resources (including SSB(s) and/or NZP CSI-RS resource(s)) as defined/specified herein in the present disclosure, each of the one or more CSI-RS resources could be associated or specific to one or more carriers/CCs/cells in the subset according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s).
For another example, (i) when/if the CSI resource setting provides or configures or comprises, and/or the higher layer parameter(s) TCI-State/UL-TCIState that provides or configures a joint/DL/UL TCI state comprises or provides, one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be one-to-one mapped/associated/specific to the carriers/CCs/cells in the subset according to a fixed rule in system specification(s) and/or per RRC (re-)configuration; for instance, the first/last CSI resource set or the CSI resource set with the lowest/highest resource set ID/index among the one or more CSI resource sets provided/configured for the UE-initiated/event-driven beam reporting specified/defined herein in the present disclosure could be mapped/associated/specific to the first/last entry in the subset or the carrier/CC/cell in the subset with the lowest/highest carrier/CC/cell index/ID among the carriers/CCs/cells in the subset, and so on, and the last/first CSI resource set or the CSI resource set with the highest/lowest resource set ID/index among the one or more CSI resource sets provided/configured for the UE-initiated/event-driven beam reporting specified/defined herein in the present disclosure could be mapped/associated/specific to the last/first entry in the subset or the carrier/CC/cell in the subset with the highest/lowest carrier/CC/cell index/ID among the carriers/CCs/cells in the subset, and/or (ii) when/if the CSI resource setting provides or configures or comprises, and/or the higher layer parameter(s) TCI-State/UL-TCIState that provides or configures a joint/DL/UL TCI state comprises or provides, one CSI resource set comprising, configuring or providing one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the subset according to a fixed rule in system specification(s) and/or per RRC (re-)configuration; for instance, the first/last CSI-RS resource or the CSI-RS resource with the lowest/highest resource ID/index value among the one or more CSI-RS resources provided/configured for the UE-initiated/event-driven beam reporting specified/defined herein in the present disclosure could be mapped/associated/specific to the first/last entry in the subset or the carrier/CC/cell in the subset with the lowest/highest carrier/CC/cell index/ID among the carriers/CCs/cells in the subset, and so on, and the last/first CSI-RS resource or the CSI-RS resource with the highest/lowest resource ID/index value among the one or more CSI-RS resources provided/configured for the UE-initiated/event-driven beam reporting specified/defined herein in the present disclosure could be mapped/associated/specific to the last/first entry in the subset or the carrier/CC/cell in the subset with the highest/lowest carrier/CC/cell index/ID among the carriers/CCs/cells in the subset.
For another example, (i) when/if the CSI resource setting provides or configures or comprises, and/or the higher layer parameter(s) TCI-State/UL-TCIState that provides or configures a joint/DL/UL TCI state comprises or provides, one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be one-to-one mapped/associated/specific to the carriers/CCs/cells in the subset according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s), and/or (ii) when/if the CSI resource setting comprises, provides or configures, and/or the higher layer parameter(s) TCI-State/UL-TCIState that provides or configures a joint/DL/UL TCI state comprises or provides, one CSI resource set comprising, configuring or providing one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the subset according to (1)network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s).
In another example, (i) when/if the CSI resource setting provides or configures or comprises, and/or the higher layer parameter(s) TCI-State/UL-TCIState that provides or configures a joint/DL/UL TCI state comprises or provides, one or more CSI resource sets as defined/specified herein in the present disclosure, each of the one or more CSI resource sets (and therefore, the corresponding CSI-RS resource(s) including SSB(s) and/or NZP CSI-RS resource(s) configured/provided therein) could be associated/specific to a carrier/CC/cell (e.g., in terms/form of a carrier/CC/cell ID/index from/in a list/set/pool of carrier/CC/cell IDs/indexes); for instance, the higher layer parameter(s) CSI-SSB-ResourceSet/ueiCSI-SSB-ResourceSet and/or NZP-CSI-RS-ResourceSet/ueiNZP-CSI-RS-ResourceSet that configures or provides a CSI resource set including SSB resource set/NZP CSI-RS resource set for the UE-initiated/event-driven beam reporting could also provide, configure, comprise, include or contain a carrier/CC/cell ID/index, and/or (ii) when/if the CSI resource setting provides or configures or comprises, and/or the higher layer parameter(s) TCI-State/UL-TCIState that provides or configures a joint/DL/UL TCI state comprises or provides, one CSI resource set comprising, configuring or providing one or more CSI-RS resources including SSB(s) and/or NZP CSI-RS resource(s) as defined/specified herein in the present disclosure, each of the one or more CSI-RS resources could be associated/specific to a carrier/CC/cell (e.g., in terms/form of a carrier/CC/cell ID/index from/in a list/set/pool of carrier/CC/cell IDs/indexes); for instance, the higher layer parameter(s) that configures or provides a CSI-RS resource for the UE-initiated/event-driven beam reporting could also provide, configure, comprise, include or contain a carrier/CC/cell ID/index.

When/if (i) a UE has determined or identified a CSI resource set provided/configured for the UE-initiated/event-driven beam reporting as specified/defined herein in the present disclosure associated/specific to a carrier/CC/cell according to or following those specified/described herein in the present disclosure, the UE could also determine or identify that the CSI-RS resource(s) including SSB(s) and/or NZP CSI-RS resource(s) provided/configured/indicated in the determined or identified CSI resource set could be associated/specific to the carrier/CC/cell, and/or (ii) a UE has determined or identified a CSI-RS resource provided/configured for the UE-initiated/event-driven beam reporting as specified/defined herein in the present disclosure associated/specific to a carrier/CC/cell according to or following those specified/described herein in the present disclosure, the UE could also determine or identify that the CSI-RS resource including SSB and/or NZP CSI-RS resource could be associated/specific to the carrier/CC/cell, wherein the UE could determine or identify the CSI-RS resource(s) including SSB(s) and/or NZP CSI-RS resource(s) as candidate/new beam RS resource(s) for the UE-initiated/event-driven beam reporting for/on the carrier/CC/cell. For actual candidate/new beam(s) measurement in a multi-carrier or multi-CC or multi-cell system as specified/defined herein in the present disclosure,
In one example, (i) when/if the CSI resource setting provides or configures or comprises, and/or the higher layer parameter(s) TCI-State/UL-TCIState that provides or configures a joint/DL/UL TCI state comprises or provides, one or more CSI resource sets as defined/specified herein in the present disclosure, the UE could determine or identify which one or more of the one or more CSI resource sets to use or apply for determining or identifying candidate/new beam RS resource(s) for actual candidate/new beam(s) measurement on/for the corresponding carrier(s)/CC(s)/cell(s) according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s), and/or (ii) when/if the CSI resource setting provides or configures or comprises, and/or the higher layer parameter(s) TCI-State/UL-TCIState that provides or configures a joint/DL/UL TCI state comprises or provides, one CSI resource set comprising, providing or configuring one or more CSI-RS resources including SSB(s) and/or NZP CSI-RS resource(s) as defined/specified herein in the present disclosure, the UE could determine or identify which one or more of the one or more CSI-RS resources to use or apply for determining or identifying candidate/new beam RS resource(s) for actual candidate/new beam(s) measurement on/for the corresponding carrier(s)/CC(s)/cell(s) according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). The following design examples specify, illustrate, discuss, explain and focus on means of determining or identifying which one or more of the one or more CSI resource sets to use or apply for determining or identifying candidate/new beam RS resource(s) for actual candidate/new beam(s) measurement on/for the corresponding carrier(s)/CC(s)/cell(s) as discussed in (i), which could be extended and applied for determining or identifying which one or more of the one or more CSI-RS resources to use or apply for determining or identifying candidate/new beam RS resource(s) for actual candidate/new beam(s) measurement on/for the corresponding carrier(s)/CC(s)/cell(s) as discussed in (ii).
   For example, the UE could determine or identify that the candidate/new beam RS resource(s) provided/configured/indicated in a subset of the one or more CSI resource sets—provided/configured/comprised in a/the (same) CSI resource setting associated/corresponding/specific to a/the (same) CSI reporting setting and/or comprised/provided in the higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure. In this case, the subset could correspond to the one or more CSI resource sets configured/provided for the UE-initiated/event-driven beam reporting according to or following those specified herein in the present disclosure; optionally, the subset could correspond to the CSI resource set(s) with odd (or event) resource set ID/index value(s) and/or the odd (or even) numbered/indexed CSI resource set(s) among the one or more CSI resource sets configured/provided for the UE-initiated/event-driven beam reporting as specified/defined herein in the present disclosure; alternatively, the subset could correspond to the CSI resource set(s) with the K≥1 highest/lowest resource set ID/index value(s) and/or the first/last K≥1 CSI resource set(s) among the one or more CSI resource sets configured/provided for the UE-initiated/event-driven beam reporting as specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI resource sets in the subset, and/or a second indicator or trigger pointing/corresponding/associated/specific to the CSI reporting setting/TCI state associated/corresponding/specific to the (subset of) one or more CSI resource sets as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource set in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the subset of the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the subset of the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure, and/or the UE could determine or identify that the candidate/new beam RS resource(s) linked/associated/specific to the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI resource sets respectively according to or following those specified herein in the present disclosure.
   For another example, the UE could determine or identify that the candidate/new beam RS resource(s) linked/associated/specific to a subset of the one or more CSI resource sets—provided/configured/comprised in a/the (same) CSI resource setting associated/corresponding/specific to a/the (same) CSI reporting setting and/or provided/comprised in the higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure, wherein the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset. For instance, the information related to the subset could be or could correspond to a bitmap with each entry/bit position of the bitmap corresponding to a CSI resource set configured/provided for the UE-initiated/event-driven beam reporting as specified/defined herein in the present disclosure; when/if an entry/bit position of the bitmap is set to ‘1’ (or ‘0’), the corresponding CSI resource set could belong to the subset. Alternatively, the information related to the subset could correspond to or comprise one or more one-bit indicators each corresponding/associated to a CSI resource set configured/provided for the UE-initiated/event-driven beam reporting as specified/defined herein in the present disclosure; when/if a one-bit indicator is set to ‘1’ (or ‘0’), the corresponding CSI resource set could belong to the subset. Optionally, the information related to the subset could correspond to or could comprise one or more resource set IDs/indexes; in this case, the CSI resource set(s) with the one or more resource set IDs/indexes could belong to the subset. For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI resource sets in the subset, and/or a second indicator or trigger pointing/corresponding/associated/specific to the CSI reporting setting/TCI state associated/corresponding/specific to the (subset of) one or more CSI resource sets as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource set in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the subset of the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the subset of the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI resource sets respectively according to or following those specified herein in the present disclosure, and/or the UE could determine or identify that the candidate/new beam RS resource(s) linked/associated/specific to the one or more CSI resource sets configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI resource sets respectively according to or following those specified herein in the present disclosure.
   For another example, the UE could determine or identify that the candidate/new beam RS resource(s) corresponding to a subset of the one or more CSI-RS resources—provided/configured/indicated in a/the (same) CSI resource set provided/configured/indicated in a/the (same) CSI resource setting associated/corresponding/specific to a/the (same) CSI reporting setting and/or provided/comprised in the higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure. In this case, the subset could correspond to the one or more CSI-RS resources configured/provided for the UE-initiated/event-driven beam reporting according to or following those specified herein in the present disclosure; optionally, the subset could correspond to the CSI-RS resource(s) with odd (or event) resource ID/index value(s) and/or the odd (or even) numbered/indexed CSI-RS resource(s) among the one or more CSI-RS resources configured/provided for the UE-initiated/event-driven beam reporting as specified/defined herein in the present disclosure; alternatively, the subset could correspond to the CSI-RS resource(s) with the K≥1 highest/lowest resource ID/index value(s) and/or the first/last K≥1 CSI-RS resource(s) among the one or more CSI-RS resources configured/provided for the UE-initiated/event-driven beam reporting as specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI-RS resources in the subset, and/or a second indicator or trigger pointing/corresponding/associated/specific to the CSI reporting setting/TCI state associated/corresponding/specific to the (subset of) one or more CSI-RS resources as defined/specified herein in the present disclosure; for instance, the UE (e.g., the UE 116) could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI-RS resource in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure, and/or the UE could determine or identify that the candidate/new beam RS resource(s) corresponding to the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI-RS resources respectively according to or following those specified herein in the present disclosure.
   For another example, the UE could determine or identify that the candidate/new beam RS resource(s) corresponding to a subset of the one or more CSI-RS resources—provided/configured/indicated in a/the (same) CSI resource set provided/configured/indicated in a/the (same) CSI resource setting associated/corresponding/specific to a/the (same) CSI reporting setting and/or provided/comprised in the higher layer parameter(s) TCI-State/UL-TCIState that provides or configures a joint/DL/UL TCI state as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure, wherein the UE could be indicated, configured or provided by the network (e.g., the network 130), e.g., via higher layer RRC signaling(s)/parameter(s) and/or MAC CE command(s) and/or dynamic DCI based L1 signaling(s) based on or according to a corresponding UE's capability or capability signaling, information related to the subset. For instance, the information related to the subset could be or could correspond to a bitmap with each entry/bit position of the bitmap corresponding to a CSI-RS resource configured/provided for the UE-initiated/event-driven beam reporting as specified/defined herein in the present disclosure; when/if an entry/bit position of the bitmap is set to ‘1’ (or ‘0’), the corresponding CSI-RS resource could belong to the subset. Alternatively, the information related to the subset could correspond to or comprise one or more one-bit indicators each corresponding/associated to a CSI-RS resource configured/provided for the UE-initiated/event-driven beam reporting as specified/defined herein in the present disclosure; when/if a one-bit indicator is set to ‘1’ (or ‘0’), the corresponding CSI-RS resource could belong to the subset. Optionally, the information related to the subset could correspond to or could comprise one or more resource IDs/indexes; in this case, the CSI-RS resource(s) with the one or more resource IDs/indexes could belong to the subset. For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI-RS resources in the subset, and/or a second indicator or trigger pointing/corresponding/associated/specific to the CSI reporting setting associated/corresponding/specific to the (subset of) one or more CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI-RS resource in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure, and/or the UE could determine or identify that the candidate/new beam RS resource(s) corresponding to the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI-RS resources respectively according to or following those specified herein in the present disclosure.

A first or second indicator/trigger as specified/defined herein in the present disclosure could correspond to a ‘CSI request’ field in a corresponding DCI format(s) 0_1 and/or 0_2 (and therefore, a corresponding trigger state). That is, when/if the UE has received or indicated or determined or identified a trigger state (via the indicated ‘CSI request’ field in the corresponding DCI format(s) 0_1 and/or 0_2) pointing/linking/corresponding/associated/specific to any one or more of the CSI resource set(s) in the subset of CSI resource set(s) as in case (i) defined/specified herein, any one or more of the CSI-RS resource(s) in the subset of CSI-RS resource(s) as in case (ii) defined/specified herein, or the CSI reporting setting/TCI state associated/specific/corresponding/linked to the CSI resource setting providing, configuring or comprising the one or more CSI resource sets as in case (i) defined/specified herein or the CSI resource set providing, configuring or comprising the one or more CSI-RS resources including SSB(s) and/or NZP CSI-RS resource(s) as in case (ii) defined/specified herein, the UE could determine or identify that the candidate/new beam RS resource(s) linked/associated/specific/corresponding to the CSI resource set(s) in the subset of CSI resource set(s) in the case of (i) as specified/defined herein, or the CSI-RS resource(s) in the subset of CSI-RS resource(s) in the case of (ii) as specified/defined herein, could be used or applied for actual candidate/new beam(s) measurement on/for the subset of carrier(s)/CC(s)/cell(s) corresponding to (i) the subset of CSI resource set(s) or (ii) the subset of CSI-RS resource(s) according to or following those specified herein in the present disclosure.
In another example, (i) when/if the CSI resource setting comprises, provides or configures, and/or the higher layer parameter(s) TCI-State/UL-TCIState that provides or configures a joint/DL/UL TCI state comprises or provides, one or more CSI resource sets including SSB resource set(s) and/or NZP CSI-RS resource set(s) as defined/specified herein in the present disclosure, the carriers/CCs/cells (e.g., in form/terms of their IDs/indexes) associated/specific/linked to the one or more CSI resource sets could be denoted by or referred to as reference carriers/CCs/cells for this design example, and/or (ii) when/if the CSI resource setting comprises, provides or configures, and/or the higher layer parameter(s) TCI-State/UL-TCIState that provides or configures a joint/DL/UL TCI state comprises or provides, one CSI resource set comprising, providing or configuring one or more CSI-RS resources including SSB(s) and/or NZP CSI-RS resource(s) as defined/specified herein in the present disclosure, the carriers/CCs/cells (e.g., in form/terms of their IDs/indexes) associated/specific/linked to the one or more CSI-RS resources could be denoted by or referred to as reference carriers/CCs/cells for this design example. The UE could first determine or identify a subset of the reference carriers/CCs/cells according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). The UE could then determine or identify a subset of the one or more CSI resource sets and/or a subset of the one or more CSI-RS resources—corresponding/associated/specific to the determined or identified subset of carrier(s)/CC(s)/cell(s) according to or following those specified herein in the present disclosure—to use or apply for determining or identifying candidate/new beam RS resource(s) for actual candidate/new beam(s) measurement on/for the corresponding carrier(s)/CC(s)/cell(s).
   For example, the subset of carrier(s)/CC(s)/cell(s) could correspond to the reference carriers/CCs/cells; optionally, the subset of carrier(s)/CC(s)/cell(s) could correspond to the carrier(s)/CC(s)/cell(s) with odd (or event) carrier/CC/cell ID(s)/index(es) and/or the odd (or even) numbered/indexed carrier(s)/CC(s)/cell(s) among the reference carriers/CCs/cells specified/defined herein in the present disclosure; alternatively, the subset of carrier(s)/CC(s)/cell(s) could correspond to the carrier(s)/CC(s)/cell(s) with the K≥1 highest/lowest carrier/CC/cell ID(s)/index(es) and/or the first/last K≥1 carrier(s)/CC(s)/cell(s) among the reference carriers/CCs/cells specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to (i) one or more CSI resource sets in the subset of CSI resource set(s)—note here that as specified/defined herein in the present disclosure, the subset of CSI resource set(s) could be associated/corresponding/specific to the determined or identified subset of carrier(s)/CC(s)/cell(s)—when/if the CSI reporting setting is linked/associated/corresponding/specific to one CSI resource setting comprising, providing or configuring one or more CSI resource sets including SSB resource set(s) and/or NZP CSI-RS resource set(s) as defined/specified herein in the present disclosure, and/or (ii) one or more CSI-RS resources in the subset of CSI-RS resource(s)—note here that as specified/defined herein in the present disclosure, the subset of CSI-RS resource(s) could be associated/corresponding/specific to the determined or identified subset of carrier(s)/CC(s)/cell(s)—when/if the CSI reporting setting is linked/associated/corresponding/specific to one CSI resource setting comprising, providing or configuring one CSI resource set comprising, providing or configuring one or more CSI-RS resources including SSB(s) and/or NZP CSI-RS resource(s) as defined/specified herein in the present disclosure, and/or a second indicator or trigger pointing/corresponding/associated/specific to the CSI reporting setting associated/corresponding/specific to the (subset of) one or more CSI resource sets/CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource set in the subset of CSI resource set(s)—in the case of (i) as specified/defined herein, or a CSI-RS resource in the subset of CSI-RS resource(s)—in the case of (ii) as specified/defined herein, and/or a second indicator or trigger pointing/corresponding/associated/specific to the CSI reporting setting; when/if the UE has received or detected such first indicator(s)/trigger(s) and/or second indicator/trigger from the network, the UE could determine or identify that the candidate/new beam RS resource(s) linked/associated/specific to the CSI resource set(s) in the subset of CSI resource set(s) as in case (i) specified/defined herein or the CSI-RS resource(s) in the subset of CSI-RS resource(s) as in case (ii) specified/defined herein could be used or applied for actual candidate/new beam(s) measurement on/for the determined or identified subset of carrier(s)/CC(s)/cell(s) corresponding to (i) the subset of CSI resource set(s) or (ii) the subset of CSI-RS resource(s) according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the CSI resource set(s) in the subset of CSI resource set(s) as in case (i) specified/defined herein or the CSI-RS resource(s) in the subset of CSI-RS resource(s) as in case (ii) specified/defined herein could be used or applied for actual candidate/new beam(s) measurement on/for the determined or identified subset of carrier(s)/CC(s)/cell(s) corresponding to (i) the subset of CSI resource set(s) or (ii) the subset of CSI-RS resource(s) according to or following those specified herein in the present disclosure, and/or the UE could determine or identify that the candidate/new beam RS resource(s) linked/associated/specific to the one or more CSI resource sets as in case (i) defined/specified herein, or the one or more CSI-RS resources as in case (ii) defined/specified herein, provided/configured/comprised in the CSI resource setting linked/associated/specific/corresponding to the CSI reporting setting configured/provided for the UE-initiated/event-driven beam reporting according to or following those specified herein in the present disclosure could be used or applied for actual candidate/new beam(s) measurement on/for the reference carrier(s)/CC(s)/cell(s) as defined/specified herein in the present disclosure.
   For another example, the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset of carrier(s)/CC(s)/cell(s). For instance, the information related to the subset of carrier(s)/CC(s)/cell(s) could be or could correspond to a bitmap with each entry/bit position of the bitmap corresponding to a reference carrier/CC/cell as specified/defined herein in the present disclosure; when/if an entry/bit position of the bitmap is set to ‘1’ (or ‘0’), the corresponding carrier/CC/cell could belong to the subset of carrier(s)/CC(s)/cell(s). Alternatively, the information related to the subset of carrier(s)/CC(s)/cell(s) could correspond to or comprise one or more one-bit indicators each corresponding/associated to a reference carrier/CC/cell as specified/defined herein in the present disclosure; when/if a one-bit indicator is set to ‘1’ (or ‘0’), the corresponding reference carrier/CC/cell could belong to the subset of carrier(s)/CC(s)/cell(s). Optionally, the information related to the subset of carrier(s)/CC(s)/cell(s) could correspond to or could comprise one or more carrier/CC/cell IDs/indexes; in this case, the reference carrier(s)/CC(s)/cell(s) with the one or more carrier/CC/cell IDs/indexes could belong to the subset of carrier(s)/CC(s)/cell(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to (i) one or more CSI resource sets in the subset of CSI resource set(s)—note here that as specified/defined herein in the present disclosure, the subset of CSI resource set(s) could be associated/corresponding/specific to the determined or identified subset of carrier(s)/CC(s)/cell(s)—when/if the CSI reporting setting is linked/associated/corresponding/specific to one CSI resource setting comprising, providing or configuring one or more CSI resource sets including SSB resource set(s) and/or NZP CSI-RS resource set(s), and/or the higher layer parameter(s) TCI-State/UL-TCIState that provides or configures a joint/DL/UL TCI state provides or comprises one or more CSI resource sets including SSB resource set(s) and/or NZP CSI-RS resource set(s), as defined/specified herein in the present disclosure, and/or (ii) one or more CSI-RS resources in the subset of CSI-RS resource(s)—note here that as specified/defined herein in the present disclosure, the subset of CSI-RS resource(s) could be associated/corresponding/specific to the determined or identified subset of carrier(s)/CC(s)/cell(s)—when/if the CSI reporting setting is linked/associated/corresponding/specific to one CSI resource setting comprising, providing or configuring one CSI resource set comprising, providing or configuring one or more CSI-RS resources including SSB(s) and/or NZP CSI-RS resource(s), and/or the higher layer parameter(s) TCI-State/UL-TCIState that provides or configures a joint/DL/UL TCI state provides or comprises one CSI resource set including a SSB resource set or a NZP CSI-RS resource set, as defined/specified herein in the present disclosure, and/or a second indicator or trigger pointing/corresponding/associated/specific to the CSI reporting setting/TCI state associated/corresponding/specific to the (subset of) one or more CSI resource sets/CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI resource set in the subset of CSI resource set(s)—in the case of (i) as specified/defined herein, or a CSI-RS resource in the subset of CSI-RS resource(s)—in the case of (ii) as specified/defined herein, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the CSI resource set(s) in the subset of CSI resource set(s) as in case (i) specified/defined herein or the CSI-RS resource(s) in the subset of CSI-RS resource(s) as in case (ii) specified/defined herein could be used or applied for actual candidate/new beam(s) measurement on/for the determined or identified subset of carrier(s)/CC(s)/cell(s) corresponding to (i) the subset of CSI resource set(s) or (ii) the subset of CSI-RS resource(s) according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the CSI resource set(s) in the subset of CSI resource set(s) as in case (i) specified/defined herein or the CSI-RS resource(s) in the subset of CSI-RS resource(s) as in case (ii) specified/defined herein could be used or applied for actual candidate/new beam(s) measurement on/for the determined or identified subset of carrier(s)/CC(s)/cell(s) corresponding to (i) the subset of CSI resource set(s) or (ii) the subset of CSI-RS resource(s) according to or following those specified herein in the present disclosure, and/or the UE could determine or identify that the candidate/new beam RS resource(s) linked/associated/specific to the one or more CSI resource sets as in case (i) defined/specified herein, or the one or more CSI-RS resources as in case (ii) defined/specified herein, provided/configured/comprised in the CSI resource setting linked/associated/specific/corresponding to the CSI reporting setting configured/provided for the UE-initiated/event-driven beam reporting and/or provided/comprised in the higher layer parameter(s) TCI-State/UL-TCIState that provides or configures a joint/DL/UL TCI state according to or following those specified herein in the present disclosure could be used or applied for actual candidate/new beam(s) measurement on/for the reference carrier(s)/CC(s)/cell(s) as defined/specified herein in the present disclosure.

A first or second indicator/trigger as specified/defined herein in the present disclosure could correspond to a ‘CSI request’ field in a corresponding DCI format(s) 0_1 and/or 0_2 (and therefore, a corresponding trigger state). That is, when/if the UE has received or indicated or determined or identified a trigger state (via the indicated ‘CSI request’ field in the corresponding DCI format(s) 0_1 and/or 0_2) pointing/linking/corresponding/associated/specific to any one or more of the CSI resource set(s) in the subset of CSI resource set(s) as in case (i) defined/specified herein, any one or more of the CSI-RS resource(s) in the subset of CSI-RS resource(s) as in case (ii) defined/specified herein, or the CSI reporting setting/TCI state associated/specific/corresponding/linked to the CSI resource setting providing, configuring or comprising the one or more CSI resource sets as in case (i) defined/specified herein or the CSI resource set providing, configuring or comprising the one or more CSI-RS resources including SSB(s) and/or NZP CSI-RS resource(s) as in case (ii) defined/specified herein, the UE (e.g., the UE 116) could determine or identify that the candidate/new beam RS resource(s) linked/associated/specific/corresponding to the CSI resource set(s) in the subset of CSI resource set(s) in the case of (i) as specified/defined herein, or the CSI-RS resource(s) in the subset of CSI-RS resource(s) in the case of (ii) as specified/defined herein, could be used or applied for actual candidate/new beam(s) measurement on/for the subset of carrier(s)/CC(s)/cell(s) corresponding to (i) the subset of CSI resource set(s) or (ii) the subset of CSI-RS resource(s) according to or following those specified herein in the present disclosure.

In one embodiment, a CSI reporting setting provided by CSI-ReportConfig or ueiCSI-ReportConfig for the UE-initiated/event-driven beam reporting as specified/defined herein in the present disclosure could be associated/linked/specific to, and/or higher layer parameter(s) TCI-State/UL-TCIState that provides or configures a joint/DL/UL TCI state could provide or comprise, one CSI resource setting provided by CSI-ResourceConfig or ueiCSI-ResourceConfig for the UE-initiated/event-driven beam reporting as specified/defined herein in the present disclosure, wherein the CSI resource setting could provide, configure, comprise, contain or include one CSI resource set including a SSB resource set or a NZP CSI-RS resource set providing, configuring, comprising, containing or including one or more CSI-RS resources including SSB(s) and/or NZP CSI-RS resource(s). In a multi-carrier or multi-CC or multi-cell system, wherein one or more (e.g., multiple or more than one) carriers and/or component carriers (CCs) and/or cells could be configured, provided and/or enabled by the network, e.g., via higher layer RRC signaling(s)/parameter(s) and/or MAC CE command(s) and/or dynamic DCI based L1 signaling(s) based on or according to a corresponding UE's capability or capability signaling—e.g., when/if a UE is higher layer configured/provided by the network, e.g., in higher layer parameter(s) CSI-ReportConfig, CSI-ResourceConfig, UEI-ReportConfig and/or UEI-ResourceConfig that provides or configures necessary information and/or setting(s) for the corresponding UE-initiated/event-driven beam reporting, one or more lists of carriers (e.g., in terms/form of their carrier IDs/indexes), one or more lists of CCs (e.g., in terms/form of their CC IDs/indexes), and/or one or more lists of cells (e.g., in terms/form of their cell IDs/indexes), for the UE-initiated/event-driven beam operations including beam reporting, and/or when/if a UE is higher layer configured/provided by the network, e.g., in higher layer parameter(s) CSI-ReportConfig, CSI-ResourceConfig, ueiCSI-ReportConfig and/or ueiCSI-ResourceConfig that provides or configures necessary information and/or setting(s) for the corresponding UE-initiated/event-driven beam reporting, higher layer parameter(s) multiCarrierBeamReporting, multiCCBeamReporting, multiCellBeamReporting, crossCarrierBeamReporting, crossCCBeamReporting, crossCellBeamReporting and/or etc. dedicated for enabling the multi-carrier (or cross-carrier), multi-CC (or cross-CC) and/or multi-cell (or cross-cell) beam reporting (e.g., set to ‘enabled’), the one or more CSI-RS resources including SSB(s) and/or NZP CSI-RS resource(s) for the UE-initiated/event-driven beam reporting as specified/defined herein in the present disclosure could be associated or specific to one or more carriers/CCs/cells according to or following one or more of:
In one example, the UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a list/set/pool of carriers/CCs/cells (e.g., in terms/form of their carrier/CC/cell IDs/indexes). For instance, the higher layer parameter(s) CSI-SSB-ResourceSet/ueiCSI-SSB-ResourceSet and/or NZP-CSI-RS-ResourceSet/ueiNZP-CSI-RS-ResourceSet that configures or provides a/the CSI resource set including a/the SSB resource set or a/the NZP CSI-RS resource set for the UEI/event-driven beam reporting, and/or the higher layer parameter(s) TCI-State/UL-TCIState that provides or configures a joint/DLJUL TCI state and provides or comprises the one or more CSI-RS resources including SSB(s) and/or NZP CSI-RS resource(s) for the UEI/event-driven beam reporting, could also provide or configure or include or comprise or contain the list/set/pool of carrier/CC/cell indexes/IDs. In this case,
   For example, as in this case the CSI resource set provides or configures or comprises, and/or the higher layer parameter(s) TCI-State/UL-TCIState that provides or configures a joint/DL/UL TCI provides or comprises, one or more CSI-RS resources (including SSB(s) and/or NZP CSI-RS resource(s)) as defined/specified herein in the present disclosure, each of the one or more CSI-RS resources could be associated or specific to one or more carriers/CCs/cells in the list/set/pool according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network (e.g., the network 130) via various UL channels/signals such as in part of/by CSI/beam report(s) and/or UE's capability signaling(s).
   For another example, as in this case the CSI resource set provides, configures or comprises, and/or the higher layer parameter(s) TCI-State/UL-TCIState that provides or configures a joint/DL/UL TCI provides or comprises, one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the list/set/pool according to a fixed rule in system specification(s) and/or per RRC (re-)configuration; for instance, the first/last CSI-RS resource or the CSI-RS resource with the lowest/highest resource ID/index value among the one or more CSI-RS resources provided/configured for the UE-initiated/event-driven beam reporting specified/defined herein in the present disclosure could be mapped/associated/specific to the first/last entry in the list/set/pool or the carrier/CC/cell in the list/set/pool with the lowest/highest carrier/CC/cell index/ID among the carriers/CCs/cells in the list/set/pool, and so on, and the last/first CSI-RS resource or the CSI-RS resource with the highest/lowest resource ID/index value among the one or more CSI-RS resources provided/configured for the UE-initiated/event-driven beam reporting specified/defined herein in the present disclosure could be mapped/associated/specific to the last/first entry in the list/set/pool or the carrier/CC/cell in the list/set/pool with the highest/lowest carrier/CC/cell index/ID among the carriers/CCs/cells in the list/set/pool.
   For another example, as in this case the CSI resource set provides or configures or comprises, and/or the higher layer parameter(s) TCI-State/UL-TCIState that provides or configures a joint/DL/UL TCI provides or comprises, one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the list/set/pool according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s).
In another example, the UE could be provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a list/set/pool of carriers/CCs/cells (e.g., in terms/form of their carrier/CC/cell IDs/indexes). For this design example, the UE could be further provided or indicated or configured by the network, e.g., via higher layer RRC signaling(s)/parameter(s) and/or MAC CE command(s) and/or dynamic DCI based L1 signaling(s) based on or according to a corresponding UE's capability or capability signaling, a subset of carriers/CCs/cells (e.g., in terms/form of their carrier/CC/cell IDs/indexes) from/out of the carriers/CCs/cells in the list/set/pool. For instance, the higher layer parameter(s) CSI-SSB-ResourceSet/ueiCSI-SSB-ResourceSet and/or NZP-CSI-RS-ResourceSet/ueiNZP-CSI-RS-ResourceSet that configures or provides a/the CSI resource set including a/the SSB resource set or a/the NZP CSI-RS resource set for the UEI/event-driven beam reporting, and/or the higher layer parameter(s) TCI-State/UL-TCIState that provides or configures a joint/DL/UL TCI and provides or comprises the one or more CSI-RS resources including SSB(s) and/or NZP CSI-RS resource(s), could also provide or configure or include or comprise or contain information related to the subset of carrier/CC/cell indexes/IDs.
   For example, the information could be or could comprise a bitmap with each entry/bit position of the bitmap corresponding to an entry in the list/set/pool of carriers/CCs/cells (e.g., in terms/form of their carrier/CC/cell IDs/indexes). In this case, when/if an entry/bit position in the bitmap is set to ‘1’ (or ‘0’), the carrier/CC/cell ID/index in the list/set/pool corresponding to the entry/bit position could belong to the subset of carriers/CCs/cells.
   For another example, the information could be or could comprise one or more one-bit indicators each corresponding to an entry in the list/set/pool of carriers/CCs/cells (e.g., in terms/form of their carrier/CC/cell IDs/indexes). In this case, when/if a one-bit indicator is set to ‘1’ (or ‘0’), the carrier/CC/cell ID/index in the list/set/pool corresponding to the one-bit indicator could belong to the subset of carriers/CCs/cells.
   For another example, the information could be or could comprise IDs of the carriers/CCs/cells in the subset, and/or indexes of the carriers/CCs/cells in the subset from/out of the carriers/CCs/cells in the list/set/pool.

In this case,
For example, as in this case the CSI resource set provides or configures or comprises, and/or the higher layer parameter(s) TCI-State/UL-TCIState that provides or configures a joint/DL/UL TCI provides or comprises, one or more CSI-RS resources (including SSB(s) and/or NZP CSI-RS resource(s)) as defined/specified herein in the present disclosure, each of the one or more CSI-RS resources could be associated or specific to one or more carriers/CCs/cells in the subset according to: (1) a fixed rule in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals such as in part of/by CSI/beam report(s) and/or UE's capability signaling(s).
For another example, as in this case the CSI resource set provides or configures or comprises, and/or the higher layer parameter(s) TCI-State/UL-TCIState that provides or configures a joint/DL/UL TCI provides or comprises, one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the subset according to a fixed rule in system specification(s) and/or per RRC (re-)configuration; for instance, the first/last CSI-RS resource or the CSI-RS resource with the lowest/highest resource ID/index value among the one or more CSI-RS resources provided/configured for the UE-initiated/event-driven beam reporting specified/defined herein in the present disclosure could be mapped/associated/specific to the first/last entry in the subset or the carrier/CC/cell in the subset with the lowest/highest carrier/CC/cell index/ID among the carriers/CCs/cells in the subset, and so on, and the last/first CSI-RS resource or the CSI-RS resource with the highest/lowest resource ID/index value among the one or more CSI-RS resources provided/configured for the UE-initiated/event-driven beam reporting specified/defined herein in the present disclosure could be mapped/associated/specific to the last/first entry in the subset or the carrier/CC/cell in the subset with the highest/lowest carrier/CC/cell index/ID among the carriers/CCs/cells in the subset.
For another example, as in this case the CSI resource set comprises, provides or configures, and/or the higher layer parameter(s) TCI-State/UL-TCIState that provides or configures a joint/DL/UL TCI provides or comprises, one or more CSI-RS resources including SSB(s) and/or NZP CSI-RS resource(s) as defined/specified herein in the present disclosure, each of the one or more CSI-RS resources could be one-to-one mapped/associated/specific to the carriers/CCs/cells in the subset according to (1) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (2) UE's autonomous determination or selection, which could be further sent to the network via various UL channels/signals such as in part of/by CSI/beam report(s) and/or UE's capability signaling(s).
In another example, as in this case the CSI resource set provides or configures or comprises, and/or the higher layer parameter(s) TCI-State/UL-TCIState that provides or configures a joint/DL/UL TCI provides or comprises, one or more CSI-RS resources including SSB(s) and/or NZP CSI-RS resource(s) as defined/specified herein in the present disclosure, each of the one or more CSI-RS resources could be associated/specific to a carrier/CC/cell (e.g., in terms/form of a carrier/CC/cell ID/index from/in a list/set/pool of carrier/CC/cell IDs/indexes); for instance, the higher layer parameter(s) that configures or provides a CSI-RS resource for the UE-initiated/event-driven beam reporting could also provide, configure, comprise, include or contain a carrier/CC/cell ID/index.

When/if a UE has determined or identified a CSI-RS resource provided/configured for the UE-initiated/event-driven beam reporting as specified/defined herein in the present disclosure associated/specific to a carrier/CC/cell according to or following those specified/described herein in the present disclosure, the UE could also determine or identify that the CSI-RS resource including SSB and/or NZP CSI-RS resource could be associated/specific to the carrier/CC/cell, wherein the UE could determine or identify the CSI-RS resource(s) including SSB(s) and/or NZP CSI-RS resource(s) as candidate/new beam RS resource(s) for the UE-initiated/event-driven beam reporting for/on the carrier/CC/cell. For actual candidate/new beam(s) measurement in a multi-carrier or multi-CC or multi-cell system as specified/defined herein in the present disclosure,
In one example, as in this case the CSI resource set provides or configures or comprises, and/or the higher layer parameter(s) TCI-State/UL-TCIState that provides or configures a joint/DL/UL TCI provides or comprises, one or more CSI-RS resources including SSB(s) and/or NZP CSI-RS resource(s) as defined/specified herein in the present disclosure, the UE could determine or identify which one or more of the one or more CSI-RS resources to use or apply for determining or identifying candidate/new beam RS resource(s) for actual candidate/new beam(s) measurement on/for the corresponding carrier(s)/CC(s)/cell(s) according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s).
   For example, the UE could determine or identify that the candidate/new beam RS resource(s) corresponding to a subset of the one or more CSI-RS resources—provided/configured/indicated in a/the (same) CSI resource set provided/configured/indicated in a/the (same) CSI resource setting associated/corresponding/specific to a/the (same) CSI reporting setting, and/or provided/comprised in the higher layer parameter(s) TCI-State/UL-TCIState that provides or configures a joint/DL/UL TCI state, as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure. In this case, the subset could correspond to the one or more CSI-RS resources configured/provided for the UE-initiated/event-driven beam reporting according to or following those specified herein in the present disclosure; optionally, the subset could correspond to the CSI-RS resource(s) with odd (or event) resource ID/index value(s) and/or the odd (or even) numbered/indexed CSI-RS resource(s) among the one or more CSI-RS resources configured/provided for the UE-initiated/event-driven beam reporting as specified/defined herein in the present disclosure; alternatively, the subset could correspond to the CSI-RS resource(s) with the K≥1 highest/lowest resource ID/index value(s) and/or the first/last K≥1 CSI-RS resource(s) among the one or more CSI-RS resources configured/provided for the UE-initiated/event-driven beam reporting as specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI-RS resources in the subset, and/or a second indicator or trigger pointing/corresponding/associated/specific to the CSI reporting setting/TCI state associated/corresponding/specific to the (subset of) one or more CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI-RS resource in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure, and/or the UE could determine or identify that the candidate/new beam RS resource(s) corresponding to the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI-RS resources respectively according to or following those specified herein in the present disclosure.
   For another example, the UE could determine or identify that the candidate/new beam RS resource(s) corresponding to a subset of the one or more CSI-RS resources—provided/configured/indicated in a/the (same) CSI resource set provided/configured/indicated in a/the (same) CSI resource setting associated/corresponding/specific to a/the (same) CSI reporting setting, and/or provided/comprised in the higher layer parameter(s) TCI-State/UL-TCIState that provides or configures a joint/DL/UL TCI, as specified herein in the present disclosure—configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure, wherein the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset. For instance, the information related to the subset could be or could correspond to a bitmap with each entry/bit position of the bitmap corresponding to a CSI-RS resource configured/provided for the UE-initiated/event-driven beam reporting as specified/defined herein in the present disclosure; when/if an entry/bit position of the bitmap is set to ‘1’ (or ‘0’), the corresponding CSI-RS resource could belong to the subset. Alternatively, the information related to the subset could correspond to or comprise one or more one-bit indicators each corresponding/associated to a CSI-RS resource configured/provided for the UE-initiated/event-driven beam reporting as specified/defined herein in the present disclosure; when/if a one-bit indicator is set to ‘1’ (or ‘0’), the corresponding CSI-RS resource could belong to the subset. Optionally, the information related to the subset could correspond to or could comprise one or more resource IDs/indexes; in this case, the CSI-RS resource(s) with the one or more resource IDs/indexes could belong to the subset. For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI-RS resources in the subset, and/or a second indicator or trigger pointing/corresponding/associated/specific to the CSI reporting setting/TCI state associated/corresponding/specific to the (subset of) one or more CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI-RS resource in the subset, and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) corresponding to the subset of the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the subset of the one or more CSI-RS resources respectively according to or following those specified herein in the present disclosure, and/or the UE could determine or identify that the candidate/new beam RS resource(s) corresponding to the one or more CSI-RS resources configured/provided for the UE-initiated/event-driven beam reporting according to or following those specified herein in the present disclosure could be used or applied for actual candidate/new beam(s) measurement on/for the carrier(s)/CC(s)/cell(s) corresponding to the one or more CSI-RS resources respectively according to or following those specified herein in the present disclosure.

A first or second indicator/trigger as specified/defined herein in the present disclosure could correspond to a ‘CSI request’ field in a corresponding DCI format(s) 0_1 and/or 0_2 (and therefore, a corresponding trigger state). That is, when/if the UE has received or indicated or determined or identified a trigger state (via the indicated ‘CSI request’ field in the corresponding DCI format(s) 0_1 and/or 0_2) pointing/linking/corresponding/associated/specific to any one or more of the CSI-RS resource(s) in the subset of CSI-RS resource(s), or the CSI reporting setting/TCI state associated/specific/corresponding/linked to the CSI resource setting providing, configuring or comprising the CSI resource set providing, configuring or comprising the one or more CSI-RS resources including SSB(s) and/or NZP CSI-RS resource(s), the UE could determine or identify that the candidate/new beam RS resource(s) linked/associated/specific/corresponding to the CSI-RS resource(s) in the subset of CSI-RS resource(s), could be used or applied for actual candidate/new beam(s) measurement on/for the subset of carrier(s)/CC(s)/cell(s) corresponding to the subset of CSI-RS resource(s) according to or following those specified herein in the present disclosure.

In another example, as in this case the CSI resource set comprises, provides or configures, and/or the higher layer parameter(s) TCI-State/UL-TCIState that provides or configures a joint/DL/UL TCI provides or comprises, one or more CSI-RS resources including SSB(s) and/or NZP CSI-RS resource(s) as defined/specified herein in the present disclosure, the carriers/CCs/cells (e.g., in form/terms of their IDs/indexes) associated/specific/linked to the one or more CSI-RS resources could be denoted by or referred to as reference carriers/CCs/cells for this design example. The UE could first determine or identify a subset of the reference carriers/CCs/cells according to or based on: (1) fixed rule(s) in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). The UE (e.g., the UE 116) could then determine or identify a subset of the one or more CSI-RS resources—corresponding/associated/specific to the determined or identified subset of carrier(s)/CC(s)/cell(s) according to or following those specified herein in the present disclosure—to use or apply for determining or identifying candidate/new beam RS resource(s) for actual candidate/new beam(s) measurement on/for the corresponding carrier(s)/CC(s)/cell(s).

For example, the subset of carrier(s)/CC(s)/cell(s) could correspond to the reference carriers/CCs/cells; optionally, the subset of carrier(s)/CC(s)/cell(s) could correspond to the carrier(s)/CC(s)/cell(s) with odd (or event) carrier/CC/cell ID(s)/index(es) and/or the odd (or even) numbered/indexed carrier(s)/CC(s)/cell(s) among the reference carriers/CCs/cells specified/defined herein in the present disclosure; alternatively, the subset of carrier(s)/CC(s)/cell(s) could correspond to the carrier(s)/CC(s)/cell(s) with the K≥1 highest/lowest carrier/CC/cell ID(s)/index(es) and/or the first/last K≥1 carrier(s)/CC(s)/cell(s) among the reference carriers/CCs/cells specified/defined herein in the present disclosure, wherein the value(s) of K could be determined or identified according to: (1) fixed value(s), e.g., K=1, in system specification(s) and/or per RRC (re-)configuration, (2) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent to the network in/via various UL channels/signals including beam/CSI report(s) and/or UE's capability signaling(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI-RS resources in the subset of CSI-RS resource(s)—note here that as specified/defined herein in the present disclosure, the subset of CSI-RS resource(s) could be associated/corresponding/specific to the determined or identified subset of carrier(s)/CC(s)/cell(s)—as in this case the CSI reporting setting is linked/associated/corresponding/specific to one CSI resource setting comprising, providing or configuring one CSI resource set comprising, providing or configuring one or more CSI-RS resources including SSB(s) and/or NZP CSI-RS resource(s), and/or the higher layer parameter(s) TCI-State/UL-TCIState that provides or configures a joint/DL/UL TCI provides or comprises the one or more CSI-RS resources including SSB(s) and/or NZP CSI-RS resource(s), as defined/specified herein in the present disclosure, and/or a second indicator or trigger pointing/corresponding/associated/specific to the CSI reporting setting/TCI state associated/corresponding/specific to the (subset of) one or more CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI-RS resource in the subset of CSI-RS resource(s), and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the CSI-RS resource(s) in the subset of CSI-RS resource(s) could be used or applied for actual candidate/new beam(s) measurement on/for the determined or identified subset of carrier(s)/CC(s)/cell(s) corresponding to the subset of CSI-RS resource(s) according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network (e.g., the network 130), the UE could still determine or identify that the candidate/new beam RS resource(s) linked/associated/specific to the CSI-RS resource(s) in the subset of CSI-RS resource(s) could be used or applied for actual candidate/new beam(s) measurement on/for the determined or identified subset of carrier(s)/CC(s)/cell(s) corresponding to the subset of CSI-RS resource(s) according to or following those specified herein in the present disclosure, and/or the UE could determine or identify that the candidate/new beam RS resource(s) linked/associated/specific to the one or more CSI-RS resources, provided/configured/comprised in the CSI resource set/setting linked/associated/specific/corresponding to the CSI reporting setting configured/provided for the UE-initiated/event-driven beam reporting and/or the higher layer parameter(s) TCI-State/UL-TCIState that provides or configures a joint/DL/UL TCI state according to or following those specified herein in the present disclosure could be used or applied for actual candidate/new beam(s) measurement on/for the reference carrier(s)/CC(s)/cell(s) as defined/specified herein in the present disclosure. For another example, the UE could be indicated, configured or provided by the network, e.g., via higher layer RRC signaling(s)/parameter(s) and/or MAC CE command(s) and/or dynamic DCI based L1 signaling(s) based on or according to a corresponding UE's capability or capability signaling, information related to the subset of carrier(s)/CC(s)/cell(s). For instance, the information related to the subset of carrier(s)/CC(s)/cell(s) could be or could correspond to a bitmap with each entry/bit position of the bitmap corresponding to a reference carrier/CC/cell as specified/defined herein in the present disclosure; when/if an entry/bit position of the bitmap is set to ‘1’ (or ‘0’), the corresponding carrier/CC/cell could belong to the subset of carrier(s)/CC(s)/cell(s). Alternatively, the information related to the subset of carrier(s)/CC(s)/cell(s) could correspond to or comprise one or more one-bit indicators each corresponding/associated to a reference carrier/CC/cell as specified/defined herein in the present disclosure; when/if a one-bit indicator is set to ‘1’ (or ‘0’), the corresponding reference carrier/CC/cell could belong to the subset of carrier(s)/CC(s)/cell(s). Optionally, the information related to the subset of carrier(s)/CC(s)/cell(s) could correspond to or could comprise one or more carrier/CC/cell IDs/indexes; in this case, the reference carrier(s)/CC(s)/cell(s) with the one or more carrier/CC/cell IDs/indexes could belong to the subset of carrier(s)/CC(s)/cell(s). For this design example, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, one or more first indicators or triggers each pointing/corresponding/associated/specific to one or more CSI-RS resources in the subset of CSI-RS resource(s)—note here that as specified/defined herein in the present disclosure, the subset of CSI-RS resource(s) could be associated/corresponding/specific to the determined or identified subset of carrier(s)/CC(s)/cell(s)—as in this case the CSI reporting setting is linked/associated/corresponding/specific to one CSI resource setting comprising, providing or configuring one CSI resource set comprising, providing or configuring one or more CSI-RS resources including SSB(s) and/or NZP CSI-RS resource(s), and/or the higher layer parameter(s) TCI-State/UL-TCIState that provides or configures a joint/DL/UL TCI provides or comprises the one or more CSI-RS resources including SSB(s) and/or NZP CSI-RS resource(s), as defined/specified herein in the present disclosure, and/or a second indicator or trigger pointing/corresponding/associated/specific to the CSI reporting setting/TCI state associated/corresponding/specific to the (subset of) one or more CSI-RS resources as defined/specified herein in the present disclosure; for instance, the UE could be provided, indicated or configured by the network, e.g., via higher layer RRC signaling(s)/parameter(s) and/or MAC CE command(s) and/or dynamic DCI based L1 signaling (e.g., via a DCI field in a DCI format) according to or based on a corresponding UE's capability or capability signaling, a first indicator or trigger pointing/corresponding/associated/specific to a CSI-RS resource in the subset of CSI-RS resource(s), and/or a second indicator or trigger pointing/corresponding/associated/specific to the CSI reporting setting/TCI state; when/if the UE has received or detected such first indicator(s)/trigger(s) and/or second indicator/trigger from the network, the UE could determine or identify that the candidate/new beam RS resource(s) linked/associated/specific to the CSI-RS resource(s) in the subset of CSI-RS resource(s) could be used or applied for actual candidate/new beam(s) measurement on/for the determined or identified subset of carrier(s)/CC(s)/cell(s) corresponding to the subset of CSI-RS resource(s) according to or following those specified herein in the present disclosure. Otherwise, i.e., when/if the UE does not receive or detect such first indicator(s)/trigger(s) and/or second indicator/trigger, or the first/second indicator(s)/trigger(s) is absent or not present in the corresponding RRC signaling(s)/parameter(s) and/or MAC CE command(s) and/or DCI format(s)—e.g., RRC configured by the network, the UE could still determine or identify that the candidate/new beam RS resource(s) linked/associated/specific to the CSI-RS resource(s) in the subset of CSI-RS resource(s) could be used or applied for actual candidate/new beam(s) measurement on/for the determined or identified subset of carrier(s)/CC(s)/cell(s) corresponding to the subset of CSI-RS resource(s) according to or following those specified herein in the present disclosure, and/or the UE could determine or identify that the candidate/new beam RS resource(s) linked/associated/specific to the one or more CSI-RS resources provided/configured/comprised in the CSI resource set/setting linked/associated/specific/corresponding to the CSI reporting setting configured/provided for the UE-initiated/event-driven beam reporting and/or the higher layer parameter(s) TCI-State/UL-TCIState that provides or configures a joint/DL/UL TCI state according to or following those specified herein in the present disclosure could be used or applied for actual candidate/new beam(s) measurement on/for the reference carrier(s)/CC(s)/cell(s) as defined/specified herein in the present disclosure.

A first or second indicator/trigger as specified/defined herein in the present disclosure could correspond to a ‘CSI request’ field in a corresponding DCI format(s) 0_1 and/or 0_2 (and therefore, a corresponding trigger state). That is, when/if the UE has received or indicated or determined or identified a trigger state (via the indicated ‘CSI request’ field in the corresponding DCI format(s) 0_1 and/or 0_2) pointing/linking/corresponding/associated/specific to any one or more of the CSI-RS resource(s) in the subset of CSI-RS resource(s), or the CSI reporting setting/TCI state associated/specific/corresponding/linked to the CSI resource setting providing, configuring or comprising the CSI resource set providing, configuring or comprising the one or more CSI-RS resources including SSB(s) and/or NZP CSI-RS resource(s), the UE could determine or identify that the candidate/new beam RS resource(s) linked/associated/specific/corresponding to the CSI-RS resource(s) in the subset of CSI-RS resource(s), could be used or applied for actual candidate/new beam(s) measurement on/for the subset of carrier(s)/CC(s)/cell(s) corresponding to the subset of CSI-RS resource(s) according to or following those specified herein in the present disclosure.

According to or following those specified herein in the present disclosure, a UE could receive from the network, in a higher layer parameter CSI-ReportConfig or UEI-ReportConfig provided or configured for the UE-initiated/event-driven beam reporting according to or following those specified herein in the present disclosure for a first carrier/CC/cell, a first higher layer parameter carrier/servCellIndex pointing to a second carrier/CC/cell as specified/defined herein in the present disclosure for determining or identifying current serving beam RS(s) or RS resource(s) for the second carrier/CC/cell according to or following those specified herein in the present disclosure, and/or a second higher layer parameter carrier/servCellIndex pointing to a third carrier/CC/cell as specified/defined herein in the present disclosure for determining or identifying candidate/new beam RS(s) or RS resource(s) for the third carrier/CC/cell according to or following those specified herein in the present disclosure (e.g., the UE could determine or identify the RS(s)/RS resource(s) including SSB(s)/CSI-RS(s)/CSI-RS resource(s) provided or configured in the corresponding CSI resource set(s)/CSI resource setting(s) associated/linked/specific to the corresponding CSI reporting setting(s)—e.g., provided or configured for the UE-initiated/event-driven beam reporting—associated/specific/corresponding to the carrier/CC/cell provided or indicated by the second carrier/servCellIndex as the corresponding candidate/new beam RS(s) or RS resource(s)),
In one example, when/if the first carrier/servCellIndex is absent or is not present or is set to invalid value(s) such as ‘0’, ‘null’, ‘empty’ and etc., the UE could determine or identify the current serving beam RS(s) or RS resource(s) for the third carrier/CC/cell (e.g., when/if the second carrier/servCellIndex is present) according to or following those specified herein in the present disclosure. In particular,
   For example, the UE could determine or identify the current serving beam RS(s) or RS resource(s) for the third carrier/CC/cell (e.g., when/if the second carrier/servCellIndex is present/configured/provided and/or set to valid value(s)) according to the RS(s) provided in the TCI state, e.g., provided by TCI-State or UL-TCIState, configured, activated or indicated or applied in/for/on the first carrier/CC/cell.
   For another example, the UE could determine or identify the current serving beam RS(s) or RS resource(s) for the third carrier/CC/cell (e.g., when/if the second carrier/servCellIndex is present/configured/provided and/or set to valid value(s)) according to the RS(s) provided in the TCI state, e.g., provided by TCI-State or UL-TCIState, configured, activated or indicated or applied in/for/on the third carrier/CC/cell.
In another example, when/if the second carrier/servCellIndex is absent or is not present or is set to invalid value(s) such as ‘0’, ‘null’, ‘empty’ and etc., the UE could determine or identify the candidate/new beam RS(s) or RS resource(s) for the second carrier/CC/cell (e.g., when/if the first carrier/servCellIndex is present) according to or following those specified herein in the present disclosure. In particular,
   For example, the UE could determine or identify the candidate/new beam RS(s) or RS resource(s) for the second carrier/CC/cell (e.g., when/if the first carrier/servCellIndex is present/configured/provided and/or set to valid value(s)) according to the RS(s)/RS resource(s) including SSB(s)/CSI-RS(s)/CSI-RS resource(s) provided or configured in the corresponding CSI resource set(s)/CSI resource setting(s) associated/linked/specific to the corresponding CSI reporting setting(s)—e.g., provided or configured for the UE-initiated/event-driven beam reporting—associated/specific/corresponding to the first carrier/CC/cell.
   For another example, the UE could determine or identify the candidate/new beam RS(s) or RS resource(s) for the second carrier/CC/cell (e.g., when/if the first carrier/servCellIndex is present/configured/provided and/or set to valid value(s)) according to the RS(s)/RS resource(s) including SSB(s)/CSI-RS(s)/CSI-RS resource(s) provided or configured in the corresponding CSI resource set(s)/CSI resource setting(s) associated/linked/specific to the corresponding CSI reporting setting(s)—e.g., provided or configured for the UE-initiated/event-driven beam reporting—associated/specific/corresponding to the second carrier/CC/cell.
In another example, the first carrier/servCellIndex and the second carrier/servCellIndex could be both present/configured/provided and/or set to valid values. For this design example, the UE could determine or identify the current serving beam RS(s) or RS resource(s) for the second carrier/CC/cell according to or following those specified herein in the present disclosure, and the candidate/new beam RS(s) or RS resource(s) for the third carrier/CC/cell according to or following those specified herein in the present disclosure (e.g., the UE could determine or identify the RS(s)/RS resource(s) including SSB(s)/CSI-RS(s)/CSI-RS resource(s) provided or configured in the corresponding CSI resource set(s)/CSI resource setting(s) associated/linked/specific to the corresponding CSI reporting setting(s)—e.g., provided or configured for the UE-initiated/event-driven beam reporting—associated/specific/corresponding to the carrier/CC/cell provided or indicated by the second carrier/servCellIndex as the corresponding candidate/new beam RS(s) or RS resource(s)).
In another example, the first carrier/servCellIndex could be absent or is not present or is set to invalid value(s) such as ‘0’, ‘null’, ‘empty’ and etc., and the second carrier/servCellIndex could be absent or is not present or is set to invalid value(s) such as ‘0’, ‘null’, ‘empty’ and etc. For this design example, the UE may not initiate or trigger cross-carrier or cross-CC or cross-cell beam reporting as specified/defined herein in the present disclosure according to the higher layer parameter CSI-ReportConfig or UEI-ReportConfig provided or configured for the UE-initiated/event-driven beam reporting according to or following those specified herein in the present disclosure for the first carrier/CC/cell.

In the described/specified design examples herein, the values of the first carrier/servCellIndex and the second carrier/servCellIndex (and therefore, the second carrier/CC/cell and the third carrier/CC/cell) could be same/identical or different. Furthermore, according to those specified herein in the present disclosure, a UE could receive from the network one or more CSI/beam reporting settings provided by higher layer parameters CSI-ReportConfig's or UEI-ReportConfig's provided or configured for the UE-initiated/event-driven beam reporting according to or following those specified herein in the present disclosure for the first carrier/CC/cell, wherein each of the CSI-ReportConfig's or UEI-ReportConfig's could provide, configure, comprise, contain or include one or more carrier's/servCellIndex's pointing to one or more carriers/CCs/cells as specified/defined herein in the present disclosure for determining or identifying current serving beam RS(s) or RS resource(s) and/or candidate/new beam RS(s) or RS resource(s) for the one or more carriers/CCs/cells according to or following those specified herein in the present disclosure. To evaluate an instance of an event (e.g., the fourth event or Event-4 as specified/defined herein in the present disclosure), e.g., for/on/in a carrier/CC/cell of interest, the UE could determine or identify the corresponding current serving beam RS(s) or RS resource(s) and the candidate/new beam RS(s) or RS resource(s) according to:
In one example, the current serving beam RS(s) or RS resource(s) and the candidate/new beam RS(s) or RS resource(s) could be determined or identified or derived from the same CSI/beam reporting setting provided by CSI-ReportConfig or UEI-ReportConfig for the UE-initiated/event-driven beam reporting according to or following those specified herein in the present disclosure. In this case, when/if the higher layer parameter(s) CSI-ReportConfig or UEI-ReportConfig provides or configures or includes or comprises one carrier/servCellIndex, the carrier/servCellIndex could correspond/point to the carrier/CC/cell of interest. When/if the higher layer parameter(s) CSI-ReportConfig or UEI-ReportConfig provides or configures or includes or comprises a first carrier/servCellIndex and a second carrier/servCellIndex according to or following those specified herein in the present disclosure, the UE could determine or identify which of the first carrier/servCellIndex or the second carrier/servCellIndex could correspond/point the carrier/CC/cell of interest based on or according to: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be sent to the network in/via various UL channels/signals including by/in part of a beam/CSI report and/or UE's capability signaling(s).
In another example, the current serving beam RS(s) or RS resource(s) and the candidate/new beam RS(s) or RS resource(s) could be determined or identified or derived from the same CSI/beam reporting setting or different/separate CSI/beam reporting settings each provided by CSI-ReportConfig or UEI-ReportConfig for the UE-initiated/event-driven beam reporting according to or following those specified herein in the present disclosure, and the current serving beam RS(s) or RS resource(s) and the candidate/new beam RS(s) or RS resource(s) could correspond to or could be associated/specific to or could be determined or identified or derived according to or based on the same/identical carrier/CC/cell of interest, e.g., the same value of carrier/servCellIndex.

According to those specified/described herein in the present disclosure, a UE could receive from the network one or more CSI/beam reporting settings provided by higher layer parameters CSI-ReportConfig's or UEI-ReportConfig's provided or configured for the UE-initiated/event-driven beam reporting according to or following those specified herein in the present disclosure for the first carrier/CC/cell, wherein each of the CSI-ReportConfig's or UEI-ReportConfig's could provide, configure, comprise, contain or include one or more carrier's/servCellIndex's pointing to one or more carriers/CCs/cells as specified/defined herein in the present disclosure for determining or identifying current serving beam RS(s) or RS resource(s) and/or candidate/new beam RS(s) or RS resource(s) for the one or more carriers/CCs/cells according to or following those specified herein in the present disclosure. The UE could determine or identify which of the one or more CSI/beam reporting settings to use/apply for initiating or triggering the cross-carrier or cross-CC or cross-cell beam reporting according to:
Fixed rule(s) in system specification(s) or per RRC (re-)configuration:
   For example, the UE could use or apply the one or more CSI/beam reporting settings for initiating or triggering the cross-carrier or cross-CC or cross-cell beam reporting, e.g., to determine current serving beam RS(s) or RS resource(s) and/or candidate/new beam RS(s) or RS resource(s) for the corresponding carrier(s)/CC(s)/cell(s) according to or following those specified herein in the present disclosure.
   For another example, the UE could use or apply the first (or the one with the lowest reporting setting/configuration ID/index) of the one or more CSI/beam reporting settings for initiating or triggering the cross-carrier or cross-CC or cross-cell beam reporting, e.g., to determine current serving beam RS(s) or RS resource(s) and/or candidate/new beam RS(s) or RS resource(s) for the corresponding carrier(s)/CC(s)/cell(s) according to or following those specified herein in the present disclosure.
   For another example, the UE could use or apply the last (or the one with the highest reporting setting/configuration ID/index) of the one or more CSI/beam reporting settings for initiating or triggering the cross-carrier or cross-CC or cross-cell beam reporting, e.g., to determine current serving beam RS(s) or RS resource(s) and/or candidate/new beam RS(s) or RS resource(s) for the corresponding carrier(s)/CC(s)/cell(s) according to or following those specified herein in the present disclosure.
Network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling:
   For example, the UE could be configured or provided or indicated by the network, e.g., via higher layer RRC signaling(s)/parameter(s) and/or MAC CE command(s) and/or dynamic DCI based L1 signaling(s) according to or based on a corresponding UE's capability or capability signaling, a bitmap with each entry/bit position of the bitmap corresponding to a CSI/beam reporting setting as specified/defined herein. For this design example, when/if an entry/bit position of the bitmap is set to ‘1’ (or ‘0’), the UE could use or apply the CSI/beam reporting setting corresponding to the entry/bit position of the bitmap for initiating or triggering the cross-carrier or cross-CC or cross-cell beam reporting, e.g., to determine current serving beam RS(s) or RS resource(s) and/or candidate/new beam RS(s) or RS resource(s) for the corresponding carrier(s)/CC(s)/cell(s) according to or following those specified herein in the present disclosure.
   For another example, the higher layer parameter CSI-ReportConfig or UEI-ReportConfig that configures or provides a CSI/beam reporting setting could comprise, include, contain, provide or indicate a one-bit flag indicator. For this design example, when/if the one-bit indicator is set to ‘1’ (or ‘0’), the UE could use or apply the CSI/beam reporting setting corresponding to the one-bit flag indicator for initiating or triggering the cross-carrier or cross-CC or cross-cell beam reporting, e.g., to determine current serving beam RS(s) or RS resource(s) and/or candidate/new beam RS(s) or RS resource(s) for the corresponding carrier(s)/CC(s)/cell(s) according to or following those specified herein in the present disclosure
UE's autonomous determination/selection, which could be sent to the network in/via various UL channels/signals including by/in part of a beam/CSI report and/or UE's capability signaling(s).

According to those specified herein in the present disclosure, a UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, an indicator for/on/in one or more reference carriers/CCs/cells, wherein the indicator could be used/applied to trigger a corresponding UE-initiated/event-driven beam operation including beam reporting as specified herein in the present disclosure for/on/in the one or more reference carriers/CCs/cells, and/or could be part of a corresponding UE-initiated/event-driven beam operation including beam reporting procedure(s) for/on/in the one or more reference carriers/CCs/cells. Additionally, the one or more reference carriers/CCs/cells here could correspond to the carriers/CCs/cells, for/on/in which the UE (e.g., the UE 116) could (a) transmit or send to the network, in a first uplink channel (e.g., periodic PUCCH(s)), a first signal/channel to indicate or request (UL resource(s) for) transmission of a second signal/channel carrying beam report(s), (b) receive from network, e.g., in a DCI (via DCI format(s) 0_0/0_1/0_2/0_3/1_0/1_1/1_2/1_3), a first response to the transmission of the first signal/channel wherein the first response could be in form of ACK/negative ACK (NACK) and/or UL grant/assignment for PUSCH to transmit/send the second signal/channel and/or a non-zero ‘CSI request’ field in the corresponding DCI format(s), (c) transmit or send to the network, in a second uplink channel (e.g., periodic PUCCH(s) and/or configured grant (CG) Type1/2 PUSCH(s)), the second signal/channel to carry the beam report(s), (d) receive from network, e.g., in a DCI (via DCI format(s) 0_0/0_1/0_2/0_3/1_0/1_1/1_2/1_3), a second response to the transmission of the second signal/channel wherein the second response could be in form of ACK/NACK and/or UL grant/assignment for PUSCH to transmit/send the beam report(s) and/or a non-zero ‘CSI request’ field in the corresponding DCI format(s), and/or (e) receive from the network, e.g., via/in a (unified) TCI state(s) activation/deactivation (MAC CE) command and/or TCI state(s) indication/update DCI (e.g., via/in a/the TCI field in/of DCI format(s) 1_1/1_2/1_3 with or without DL assignment), one or more joint/DL/UL TCI states—e.g., as a third response (note here that the third and second responses defined/specified herein could be sent via/in a/the same DL signaling or different DL signalings). In this case, when/if the UE has received or detected such an indicator from the network, the UE could determine or identify the corresponding candidate/new beam RS resource(s) for actual candidate/new beam(s) measurement on/for the one or more reference carriers/CCs/cells according to or following those specified herein in the present disclosure. The indicator could be in form of one or more of:
Higher layer RRC parameter(s)/signaling(s) and/or MAC CE command(s) that enables the UE-initiated/event-driven beam management/operation including beam reporting
Higher layer RRC parameter(s)/signaling(s) including, e.g., CSI-ReportConfig, CSI-ResourceConfig, ueiCSI-ResourceConfig, ueiCSI-ReportConfig and/or etc., and/or MAC CE command(s) that provides or configures necessary information and/or setting(s) for the UE-initiated/event-driven beam management/operation including beam reporting
Higher layer RRC parameter(s)/signaling(s) and/or MAC CE command(s) that enables the UE-initiated/event-driven beam management/operation including beam reporting in a multi-carrier/multi-CC/multi-cell system as specified/defined herein in the present disclosure
Higher layer RRC parameter(s)/signaling(s) and/or MAC CE command(s) that provides or configures necessary information and/or setting(s) for the UE-initiated/event-driven beam management/operation including beam reporting in a multi-carrier/multi-CC/multi-cell system as specified/defined herein in the present disclosure
Higher layer RRC parameter(s)/signaling(s) and/or MAC CE command(s) that enables the cross-carrier/cross-CC/cross-cell UE-initiated/event-driven beam management/operation including beam reporting as specified/defined herein in the present disclosure
Higher layer RRC parameter(s)/signaling(s) and/or MAC CE command(s) that provides or configures necessary information and/or setting(s) for the cross-carrier/cross-CC/cross-cell UE-initiated/event-driven beam management/operation including beam reporting as specified/defined herein in the present disclosure
Higher layer RRC parameter(s)/signaling(s) and/or MAC CE command(s) that provides or configures necessary information and/or setting(s) of one or more events for the UE-initiated/event-driven beam management/operation including beam reporting as specified/defined herein in the present disclosure
The first response from the network (e.g., the network 130) as specified/defined herein in the present disclosure, e.g., in a DCI (via DCI format(s) 0_0/0_1/0_2/0_3/1_0/1_1/1_2/1_3), to the transmission of the first signal/channel wherein the first response could be in form of ACK/NACK and/or UL grant/assignment for PUSCH to transmit/send the second signal/channel and/or a non-zero ‘CSI request’ field in the corresponding DCI format(s)
The second response from the network as specified/defined herein in the present disclosure, e.g., in a DCI (via DCI format(s) 0_0/0_1/0_2/0_3/1_0/1_1/1_2/1_3), to the transmission of the second signal/channel wherein the second response could be in form of ACK/NACK and/or UL grant/assignment for PUSCH to transmit/send the beam report(s) and/or a non-zero ‘CSI request’ field in the corresponding DCI format(s)
The third response from the network, e.g., via/in a (unified) TCI state(s) activation/deactivation (MAC CE) command and/or TCI state(s) indication/update DCI (e.g., via/in a/the TCI field in/of DCI format(s) 1_1/1_2/1_3 with or without DL assignment), one or more joint/DL/UL TCI states, wherein the higher layer parameter(s) TCI-State/UL-TCIState that provides or configures the one or more indicated joint/DL/UL TCI states could provide or comprise first information related to candidate/new beam RS resource(s) and/or second information related to carrier(s)/CC(s)/cell(s) for the actual candidate/new beam(s) measurement as specified/defined herein in the present disclosure.

In one embodiment, a UE could be provided or configured or indicated by the network, e.g., via higher layer RRC signaling(s)/parameter(s) and/or MAC CE command(s) and/or dynamic DCI based L1 signaling(s) according to or based on a corresponding UE's capability or capability signaling, a list/set/pool of RS resources (e.g., in terms/form of their resource IDs/indexes) as candidates for the UE to determine or identify candidate/new beam RS resource(s) for candidate/new beam(s) measurement on/for one or more carriers/CCs/cells in a multi-carrier/multi-CC/multi-cell system as specified/defined herein in the present disclosure for cross-carrier/cross-CC/cross-cell beam reporting as specified/defined herein in the present disclosure. For instance, the list/set/pool of RS resources could be provided by a higher layer parameter candidateRSsList. In this case, the UE could determine or identify association(s)/mapping(s) between one or more of the RS resources in the list/set/pool and one or more carriers/CCs/cells according to one or more of:
In one example, the list/set/pool of RS resources, e.g., provided by candidateRSsList, could correspond to a CSI resource setting in one or more embodiments described herein, and the UE could follow those specified/discussed in one or more embodiments described herein in the present disclosure to determine or identify the association(s)/mapping(s) between the one or more of the RS resources in the list/set/pool and the one or more carriers/CCs/cells. For this design example, the list/set/pool of RS resources could further comprise or include or contain or provide or configure (or could be further divided into) one or more subsets of RS resources, wherein each of the one or more subsets of RS resources could correspond to a CSI resource set including a SSB resource set or a NZP CSI-RS resource set in one or more embodiments described herein. In particular, the UE could determine or identify the subset(s) of RS resource(s) from the list/set/pool of RS resources according to:
   Fixed rule(s) in system specification(s) and/or per RRC (re-)configuration: for example, the list/set/pool of RS resources could comprise, include, contain, provide or configure (or could be divided into) a number Nsub>1 subsets of RS resources (e.g., with consecutive RS resource indexes/IDs—across the Nsub subsets—in a descending/ascending order) each comprising M_sub≥1 RS resources, wherein the UE could determine or identify the value(s) of Nsub and/or Msub according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be sent to the network in/via various UL channels/signals including by/in part of a beam/CSI report and/or UE's capability signaling(s); for another example, the RS resource(s) in the list/set/pool with even (or odd) resource ID(s)/index(es) or the even (or odd) numbered/indexed RS resource(s) in the list/set/pool could belong to a first subset of RS resource(s), and the RS resource(s) in the list/set/pool with odd (or even) resource ID(s)/index(es) or the odd (or even) numbered/indexed RS resource(s) in the list/set/pool could belong to a second subset of RS resource(s); for another example, the list/set/pool of RS resources provided by candidateRSsList could correspond or belong to a/one (same) subset of RS resources.
   Network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling: for example, the UE could be provided or configured or indicated by the network, e.g., via higher layer RRC signaling(s)/parameter(s) and/or MAC CE command(s) and/or dynamic DCI based L1 signaling(s) according to or based on a corresponding UE's capability or capability signaling, one or more (e.g., Nsub≥1) subsets of RS resources (e.g., each provided by a higher layer parameter candidateRSsSubset), wherein each provided/configured/indicated subset of RS resources could comprise, provide or configure one or more (e.g., Msub≥1) RS resources (e.g., in terms/form of their resource IDs/indexes in the list/set/pool of RS resources). In this case, the UE could determine or identify the value(s) of Nsub and/or Msub according to or based on: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be sent to the network in/via various UL channels/signals including by/in part of a beam/CSI report and/or UE's capability signaling(s).
In another example, the list/set/pool of RS resources, e.g., provided by candidateRSsList, could correspond to a CSI resource set in one or more embodiments described herein, wherein a RS resource in the list/set/pool could correspond to a CSI-RS resource including a SSB or a NZP CSI-RS resource in the CSI resource set in one or more embodiments described herein, and the UE could follow those specified/discussed in one or more embodiments described herein in the present disclosure to determine or identify the association(s)/mapping(s) between the one or more of the RS resources in the list/set/pool and the one or more carriers/CCs/cells.

As specified or described herein in the present disclosure, a UE could be provided or indicated by the network, e.g., via/by/in a (unified) TCI state(s) activation/deactivation (MAC CE) command and/or a TCI state(s) indication/update DCI (e.g., via/by/in the TCI field of DCI format(s) 1_1/1_2/1_3 with or without DL assignment), one or more joint/DL/UL TCI states, wherein the higher layer parameter(s) TCI-State/UL-TCIState that provides or configures the one or more indicated joint/DL/UL TCI states could also provide or comprise first information related to one or more candidate/new beam RS resources and/or second information related to one or more carriers/CCs/cells (e.g., in terms/form of their carrier/CC/cell IDs/indexes in a list/set/pool of carriers/CCs/cells and/or a subset of carriers/CCs/cells provided/configured to the UE and/or determined/identified by the UE according to or following those specified herein in the present disclosure), wherein the first information could comprise, provide or indicate one or more CSI reporting settings (e.g., in terms/form of their reporting setting IDs provided by reportConfigId's), and/or one or more CSI resource settings (e.g., in terms/form of their resource setting IDs provided by resourceConfigId's), and/or one or more CSI resource sets including SSB resource(s) and/or NZP CSI-RS resource set(s)—e.g., in terms/form of their resource set IDs/indexes, and/or one or more CSI-RS resources including SSB(s) and/or NZP CSI-RS resource(s)—e.g., in terms/form of their resource IDs/indexes, and/or one or more subsets of RS resources as specified/defined in one or more embodiments described herein in the present disclosure, and/or one or more RS resources (e.g., in terms/from of their resource IDs/indexes) from/in the list/set/pool of RS resources as specified/defined in one or more embodiments described herein in the present disclosure, wherein, according to or following those specified/defined herein in the present disclosure, the UE could determine, identify or derive the one or more candidate/new beam RS resources, e.g., in terms/form of their resource IDs/indexes, from/according to/based on the one or more CSI reporting settings/CSI resource settings/CSI resource sets/CSI-RS resources/subsets of RS resources/RS resources from/in the list/set/pool of RS resources comprised, provided or indicated in/by the first information as described/specified herein in the present disclosure.
In one example, when/if the second information is absent or not present/provided/comprised/configured/indicated in the higher layer parameter(s) TCI-State/UL-TCIState that provides or configures the one or more indicated joint/DL/UL TCI states, the UE could determine or identify the association(s)/mapping(s) between the one or more candidate/new beam RS resources and one or more carriers/CCs/cells according to those specified herein in the present disclosure. The UE could then use/apply the one or more candidate/new beam RS resources for actual candidate/new beam(s) measurement on/for the corresponding carrier(s)/CC(s)/cell(s) according to or based on the determined or identified association(s)/mapping(s).
In another example, when/if the second information is present/provided/comprised/configured/indicated in the higher layer parameter(s) TCI-State/UL-TCIState that provides or configures the one or more indicated joint/DL/UL TCI states, the UE could determine or identify the association(s)/mapping(s) between the one or more candidate/new beam RS resources and the one or more carriers/CCs/cells provided/comprised/configured in the same higher layer parameter(s) TCI-State/UL-TCIState that provides or configures the one or more indicated joint/DL/UL TCI states according to those specified herein in the present disclosure. The UE could then use/apply the one or more candidate/new beam RS resources for actual candidate/new beam(s) measurement on/for the corresponding carrier(s)/CC(s)/cell(s) according to or based on the determined or identified association(s)/mapping(s).

As specified herein in the present disclosure, a UE could use/apply one or more first candidate/new beam RS resources determined or identified according to or following those specified herein in the present disclosure to perform or conduct candidate/new beam(s) measurement for/on/in one or more corresponding carriers/CCs/cells in a multi-carrier/multi-CC/multi-cell system for cross-carrier/cross-CC/cross-cell beam reporting according to or following those specified herein in the present disclosure. The UE could also receive from the network a MAC CE command to provide or indicate one or more second candidate/new beam RS resources (e.g., in form/terms of their resource IDs/indexes/ordinal positions in form of a bitmap, e.g., from/in/among one or more CSI-RS resources including SSB(s) and/or NZP CSI-RS resource(s) provided/configured in one or more CSI resource settings/sets configured/provided for the UE-initiated/event-driven beam reporting according to those specified herein in the present disclosure (e.g., according to one or more embodiments described herein in the present disclosure) or a list/set/pool of RS resources provided by candidateRSsList as defined/specified herein in the present disclosure (e.g., according to one or more embodiments described herein in the present disclosure), to replace or update one or more of the first candidate/new beam RS resources for candidate/new beam(s) measurement for/on/in the one or more corresponding carriers/CCs/cells. The MAC CE command could comprise, provide or indicate first information related the second candidate/new beam RS resource(s), wherein the information could comprise, provide or indicate one or more CSI reporting settings (e.g., in terms/form of their reporting setting IDs provided by reportConfigId's), and/or one or more CSI resource settings (e.g., in terms/form of their resource setting IDs provided by resourceConfigId's), and/or one or more CSI resource sets including SSB resource(s) and/or NZP CSI-RS resource set(s)—e.g., in terms/form of their resource set IDs/indexes, and/or one or more CSI-RS resources including SSB(s) and/or NZP CSI-RS resource(s)—e.g., in terms/form of their resource IDs/indexes, and/or one or more subsets of RS resources as specified/defined in one or more embodiments described herein in the present disclosure, and/or one or more RS resources (e.g., in terms/from of their resource IDs/indexes) from/in the list/set/pool of RS resources as specified/defined in one or more embodiments described herein in the present disclosure; in this case, according to or following those specified/defined herein in the present disclosure, the UE could determine, identify or derive the one or more second candidate/new beam RS resources (when indicated/provided by the MAC CE command), e.g., in terms/form of their resource IDs/indexes, from/according to/based on the one or more CSI reporting settings/CSI resource settings/CSI resource sets/CSI-RS resources/subsets of RS resources/RS resources from/in the list/set/pool of RS resources comprised, provided or indicated in/by the first information as described/specified herein in the present disclosure.
In one example, the MAC CE command could reuse/repurpose or could have a similar or same form to or as an aperiodic CSI trigger state Subselection MAC CE command. For instance, the MAC CE command could provide or indicate a bitmap with each entry/bit position of the bitmap (e.g., the Ti field in an aperiodic CSI trigger state Subselection MAC CE) corresponding/specific to alone first candidate/new beam RS resource. When/if an entry/bit position of the bitmap is set to ‘1’ (or ‘0’), the UE could determine or identify that the first candidate/new beam RS resource corresponding/specific to the entry/bit position could be updated/replaced by a second candidate/new beam RS resource. Furthermore, the MAC CE command could also provide or indicate one or more second candidate/new beam RS resources (e.g., in form/terms of their resource IDs/indexes provided or indicated by one or more RS ID fields in the MAC CE) as defined/specified herein corresponding/associated/mapped/specific to entry(s)/bit position(s) in the bitmap that is set to ‘1’ (or ‘0’) as defined/specified herein by their ordinal positions. For instance, the first (or last) of the one or more second candidate/new beam RS resources or the second candidate/new beam RS resource with the lowest (or highest) resource ID/index among the one or more second candidate/new beam RS resources by their ordinal positions could be corresponding/associated/mapped/specific to the first (or last) entry/bit position among the entry(s)/bit position(s) in the bitmap that is set to ‘1’ (or ‘0’), and so on, and the last (or first) of the one or more second candidate/new beam RS resources or the second candidate/new beam RS resource with the highest (or lowest) resource ID/index among the one or more second candidate/new beam RS resources by their ordinal positions could be corresponding/associated/mapped/specific to the last (or first) entry/bit position among the entry(s)/bit position(s) in the bitmap that is set to ‘1’ (or ‘0’). In this case, when/if the UE has received the MAC CE command and/or the MAC CE command including the entry(s)/codepoint(s)/value(s) provided/indicated therein has become applicable, the UE would replace or update a first candidate/new beam RS resource with a second candidate/new beam RS resource when/if they correspond to a/the same entry/bit position of/in the bitmap that is set to ‘1’ (or ‘0’).
In another example, the MAC CE command could reuse/repurpose or could have a similar or same form to or as a beam failure detection (BFD)-RS indication MAC CE command. For instance, the MAC CE command could comprise, include or contain one or more RS fields (e.g., the BFD-RS ID field in a BFD-RS indication MAC CE) each providing or indicating a second candidate/new beam RS resource (e.g., in terms/form its resource ID/index). For this design example, the UE could replace or update one or more (or all) of the first candidate/new beam RS resources by/with the second candidate/new beam RS resources indicated/provided by/in the MAC CE command—e.g., when/if the number of the first candidate/new beam RS resources and the number of the second candidate/new beam RS resources indicated/provided in/by the MAC CE command are the same—to perform or conduct candidate/new beam(s) measurement on/for/in the corresponding carrier(s)/CC(s)/cell(s). Alternatively, the UE could use/apply one or more (or all) of the first candidate/new beam RS resources and the second candidate/new beam RS resources indicated/provided by/in the MAC CE command—e.g., when/if the number of the first candidate/new beam RS resources and the number of the second candidate/new beam RS resources indicated/provided in/by the MAC CE command are different—to perform or conduct candidate/new beam(s) measurement on/for/in the corresponding carrier(s)/CC(s)/cell(s).

The MAC CE command could also provide or indicate or comprise second information related to one or more carriers/CCs/cells (e.g., in terms/form of their carrier/CC/cell IDs/indexes in a list/set/pool of carriers/CCs/cells and/or a subset of carriers/CCs/cells provided/configured to the UE and/or determined/identified by the UE according to or following those specified herein in the present disclosure).
In one example, when/if the second information is absent or not present/provided/comprised/indicated in the MAC CE command, the UE could determine or identify the association(s)/mapping(s) between the one or more second candidate/new beam RS resources provided/indicated by/in the MAC CE command and one or more carriers/CCs/cells according to those specified herein in the present disclosure. The UE could then use/apply the one or more second candidate/new beam RS resources for actual candidate/new beam(s) measurement on/for the corresponding carrier(s)/CC(s)/cell(s) according to or based on the determined or identified association(s)/mapping(s) following or according to those specified herein in the present disclosure.
In another example, when/if the second information is present/provided/comprised/indicated in the MAC CE command, the UE could determine or identify the association(s)/mapping(s) between the one or more second candidate/new beam RS resources and the one or more carriers/CCs/cells provided/comprised/indicated in the same MAC CE command according to those specified herein in the present disclosure. The UE could then use/apply the one or more second candidate/new beam RS resources for actual candidate/new beam(s) measurement on/for the corresponding carrier(s)/CC(s)/cell(s) according to or based on the determined or identified association(s)/mapping(s) following or according to those specified herein in the present disclosure.

As specified herein in the present disclosure, a UE could use/apply one or more first candidate/new beam RS resources determined or identified according to or following those specified herein in the present disclosure to perform or conduct candidate/new beam(s) measurement for/on/in one or more corresponding carriers/CCs/cells in a multi-carrier/multi-CC/multi-cell system for cross-carrier/cross-CC/cross-cell beam reporting according to or following those specified herein in the present disclosure. The UE could also receive from the network a MAC CE sub-selection command or a sub-selection MAC CE command to provide or indicate first information related to one or more second candidate/new beam RS resources (e.g., in form/terms of their resource IDs/indexes/ordinal positions in form of a bitmap, from/in/among one or more reference CSI-RS resources including SSB(s) and/or NZP CSI-RS resource(s), e.g., provided/configured in one or more CSI resource settings/sets configured/provided for the UE-initiated/event-driven beam reporting according to those specified herein in the present disclosure (e.g., according to one or more embodiments described herein in the present disclosure) or a list/set/pool of RS resources provided by candidateRSsList as defined/specified herein in the present disclosure (e.g., according to one or more embodiments described herein in the present disclosure), to replace or update one or more of the first candidate/new beam RS resources for candidate/new beam(s) measurement for/on/in the one or more corresponding carriers/CCs/cells. In this case, the MAC CE sub-selection command could reuse/repurpose or could have a similar or same form to or as an aperiodic CSI trigger state Subselection MAC CE command. For instance, the sub-selection MAC CE command could provide or indicate a bitmap with each entry/bit position of the bitmap (e.g., the Ti field in an aperiodic CSI trigger state Subselection MAC CE) corresponding/specific to a reference CSI-RS resource as defined herein. When/if an entry/bit position of the bitmap is set to ‘1’ (or ‘0’), the UE could determine or identify that the reference CSI-RS resource corresponding/specific to the entry/bit position could correspond to or could be considered/referred to as a second candidate/new beam RS resource. In this case, when/if the UE has received the sub-selection MAC CE command and/or the sub-selection MAC CE command including the entry(s)/codepoint(s)/value(s) provided/indicated therein has become applicable,
In one example, the UE could replace or update one or more (or all) of the first candidate/new beam RS resources by/with the second candidate/new beam RS resources indicated/provided by/in the MAC CE sub-selection command—e.g., when/if the number of the first candidate/new beam RS resources and the number of the second candidate/new beam RS resources indicated/provided in/by the MAC CE sub-selection command are the same—to perform or conduct candidate/new beam(s) measurement on/for/in the corresponding carrier(s)/CC(s)/cell(s).
In another example, the UE could use/apply one or more (or all) of the first candidate/new beam RS resources and the second candidate/new beam RS resources indicated/provided by/in the MAC CE sub-selection command—e.g., when/if the number of the first candidate/new beam RS resources and the number of the second candidate/new beam RS resources indicated/provided in/by the MAC CE sub-selection command are different—to perform or conduct candidate/new beam(s) measurement on/for/in the corresponding carrier(s)/CC(s)/cell(s).

The sub-selection MAC CE command could also provide or indicate or comprise second information related to one or more carriers/CCs/cells (e.g., in terms/form of their carrier/CC/cell IDs/indexes in a list/set/pool of carriers/CCs/cells and/or a subset of carriers/CCs/cells provided/configured to the UE and/or determined/identified by the UE according to or following those specified herein in the present disclosure).

In one example, when/if the second information is absent or not present/provided/comprised/indicated in the sub-selection MAC CE command, the UE could determine or identify the association(s)/mapping(s) between the one or more second candidate/new beam RS resources provided/indicated by/in the MAC CE sub-selection command and one or more carriers/CCs/cells according to those specified herein in the present disclosure. The UE could then use/apply the one or more second candidate/new beam RS resources for actual candidate/new beam(s) measurement on/for the corresponding carrier(s)/CC(s)/cell(s) according to or based on the determined or identified association(s)/mapping(s) following or according to those specified herein in the present disclosure.

In another example, when/if the second information is present/provided/comprised/indicated in the sub-selection MAC CE command, the UE could determine or identify the association(s)/mapping(s) between the one or more second candidate/new beam RS resources and the one or more carriers/CCs/cells provided/comprised/indicated in the same sub-selection MAC CE command according to those specified herein in the present disclosure. The UE could then use/apply the one or more second candidate/new beam RS resources for actual candidate/new beam(s) measurement on/for the corresponding carrier(s)/CC(s)/cell(s) according to or based on the determined or identified association(s)/mapping(s) following or according to those specified herein in the present disclosure.

The described or specified design examples, options, procedures, signaling alternatives and etc. throughout the present disclosure for the current serving beam RS(s)/RS resource(s)/RS resource index(es) can be extended or equally applied to the candidate/actual candidate/new beam RS(s)/RS resource(s)/RS resource index(es) according to or following those specified herein in the present disclosure.

If the UE (e.g., the UE 116) is not provided q̅₀ by failureDetectionResourcesToAddModList for a bandwidth part (BWP) of the serving cell, the UE determines the set q̅₀ to include periodic CSI-RS resource configuration indexes with same values as the RS indexes in the RS sets indicated by one or two TCI-State(s) for respective CORESETs that the UE uses for monitoring PDCCH, wherein
The two TCI-State(s) could correspond to a first TCI state and a second TCI state, and the respective CORESETs could correspond to a CORESET configured with apply-IndicatedICState=‘both’, and/or the UE could be provided sfnSchemePdcch set to ‘sfnSchemeA’ or ‘sfnSchemeB’.
The two TCI-State(s) could correspond to a first TCI state and a second TCI state, and the respective CORESETs could correspond to a CORESET activated with the two TCI-State(s), and/or the UE could be provided sfnSchemePdcch set to ‘sfnSchemeA’ or ‘sfnSchemeB’.
The two TCI-State(s) could correspond to a first TCI state and a second TCI state, and the respective CORESETs could correspond to first CORESET(s) and second CORESET(s), wherein the UE is not provided coresetPoolIndex or is provided coresetPoolIndex with a value of 0 for first CORESET(s) on an active DL BWP of a serving cell, and is provided coresetPoolIndex with a value of 1 for second CORESET(s) on the active DL BWP of the serving cells, and the first TCI state could be specific/associated to the first CORESET(s) and the second TCI state could be specific/associated to the second CORESET(s).

If the UE is not provided q̅_{0,0} and q̅_{0,1} for a BWP of the serving cell, the UE determines the set q̅_{0,0} and q̅_{0,1} to include periodic CSI-RS resource configuration indexes with same values as the RS indexes in the RS sets indicated by TCI-State for first and second CORESETs that the UE uses for monitoring PDCCH, respectively, where the UE is provided two coresetPoolIndex values 0 and 1 for the first and second CORESETs, or is not provided coresetPoolIndex value for the first CORESETs and is provided coresetPoolIndex value of 1 for the second CORESETs, respectively. If there are two RS indexes in a TCI state, the set q̅₀ or q̅_{0,0}, or q̅_{0,1} includes RS indexes configured with qcl-Type set to ‘typeD’ for the corresponding TCI states. If a CORESET that the UE uses for monitoring PDCCH includes two TCI states and the UE is provided sfnSchemePdcch set to ‘sfnSchemeA’ or ‘sfnSchemeB’, the set q̅₀ includes RS indexes in the RS sets associated with the two TCI states.

According to or following those specified or defined herein in the present disclosure, the higher layer parameter(s)/signaling(s) CSI-ReportConfig and/or UEI-ReportConfig, e.g., configured in a UE's serving cell, that provides or configures necessary information and/or setting(s) for the UE-initiated/event-driven beam reporting could provide, indicate, configure, comprise, contain or include a first higher layer parameter carrier/servCellIndex/cell to indicate to the UE a first carrier/CC/cell in which the candidate/new beam RS(s) or RS resource(s) as specified/defined herein in the present disclosure could be configured. In addition, the first higher layer parameter carrier/servCellIndex/cell here could also indicate to the UE that the current serving beam RS(s) or RS resource(s) as specified/defined herein in the present disclosure could also be configured in the same first carrier/CC/cell as in which the candidate/new beam RS(s) or RS resource(s) as specified/defined herein in the present disclosure could be configured. In this case, the UE could determine or identify the current serving beam RS(s) or RS resource(s)—i.e., configured in the first carrier/CC/cell mentioned herein—for event evaluation(s) according to or following one or more of:
In one example, the higher layer parameter(s)/signaling(s) CSI-ReportConfig and/or UEI-ReportConfig, e.g., configured in a UE's serving cell, that provides or configures necessary information and/or setting(s) for the UE-initiated/event-driven beam reporting could provide, indicate, configure, comprise, contain or include a second higher layer parameter carrier/servCellIndex/cell to indicate to the UE a second carrier/CC/cell in which an indicated TCI state is applied. For this design example, the UE could determine or identify the current serving beam RS(s)/RS resource(s) as the RS(s)/RS resource(s) provided in/by or specific or associated or corresponding or linked to the indicated TCI state according to or following those specified/defined herein in the present disclosure. In this case, the UE could expect or assume that
   The determined/identified current serving beam RS(s)/RS resource(s) could have the same value(s) as or could correspond to at least one RS/RS resource configured in the first carrier/CC/cell, and/or
   The higher layer parameter cell configured in the higher layer parameter QCL-Info in the higher layer parameter MI-State that provides or configures the indicated TCI state could have the same value as or could correspond to the value of the first higher layer parameter carrier/servCellIndex/cell.

When/if the second higher layer carrier/servCellIndex/cell (i.e., the corresponding field) is absent, the UE could expect or assume that indicated TCI state is applied in the first carrier/CC/cell. Furthermore, when/if the higher layer parameter cell (i.e., the corresponding field) is absent in the higher layer parameter QCL-Info in the higher layer parameter WI-State that provides or configures the indicated TCI state, the UE could expect or assume that the RS(s)/RS resource(s) provided in/by or specific or associated or corresponding or linked to the indicated TCI state could be configured in the same carrier/CC/cell (e.g., the first carrier/CC/cell provided by the first higher layer parameter carrier/servCellIndex/cell) in which the indicated TCI state applies.
In another example, the UE could determine or identify an indicated TCI state wherein the higher layer parameter cell configured in the higher layer parameter QCL-Info in the higher layer parameter WI-State that provides or configures the indicated TCI state could have the same value as or could correspond to the value of the first higher layer parameter carrier/servCellIndex/cell. In this case, the UE could determine or identify the current serving beam RS(s)/RS resource(s) as the RS(s)/RS resource(s) provided in/by or specific or associated or corresponding or linked to the indicated TCI state according to or following those specified/defined herein in the present disclosure. In this case, the UE could expect or assume that the higher layer parameter cell (i.e., the corresponding field) is present in the higher layer parameter QCL-Info in the higher layer parameter TCI-State that provides or configures the indicated TCI state.
In another example, the UE could determine or identify a RS/RS resource configured in the first carrier/CC/cell as a current serving beam RS/RS resource when/if the determined or identified RS/RS resource has the same value as or corresponds to the RS/RS resource provided in/by or specific or associated or corresponding or linked to an indicated TCI state according to or following those specified/defined herein in the present disclosure—in this case, the higher layer parameter cell (i.e., the corresponding field) could be absent in the higher layer parameter QCL-Info in the higher layer parameter TCI-State that provides or configures the indicated TCI state. When/if the higher layer parameter cell (i.e., the corresponding field) is present in the higher layer parameter QCL-Info in the higher layer parameter TCI-State that provides or configures the indicated TCI state, the UE could expect or assume that the higher layer parameter cell configured in the higher layer parameter QCL-Info in the higher layer parameter TCI-State that provides or configures the indicated TCI state could have the same value as or could correspond to the value of the first higher layer parameter carrier/servCellIndex/cell.

When/if the UE has determined or identified more than on or multiple (e.g., S>1) candidate current serving beam RSs or RS resources configured in the first carrier/CC/cell mentioned herein according to or following those specified/defined herein in the present disclosure, the UE could further determine or identify the current serving beam RS(s) or RS resource(s)—e.g. out of the determined or identified S>1 candidate current serving beam RSs or RS resources—for event evaluation(s), e.g., in/for/on the first (or second) carrier/CC/cell, according to or following: (1) fixed rule(s)/setting(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network (e.g., the network 130) via various UL channels/signals including CSI/beam report(s) and/or UE's capability signaling(s).
In one example, the current serving beam RS(s) or RS resource(s) for event evaluation(s), e.g., in/for/on the first (or second) carrier/CC/cell, could correspond to the determined or identified S>1 candidate current serving beam RSs or RS resources. In this case, (higher layer(s) of) the UE could separately perform or conduct the event evaluation(s) for or regarding or with respect to each of the current serving beam RS(s) or RS resource(s).
In another example, the current serving beam RS(s) or RS resource(s) for event evaluation(s), e.g., in/for/on the first (or second) carrier/CC/cell, could correspond to the candidate current serving beam RS(s) or RS resource(s)—e.g., out of the determined or identified S>1 candidate current serving beam RSs or RS resources—that has the highest (or lowest) RS or RS resource or RS resource configuration ID(s)/index(es).
In another example, the current serving beam RS(s) or RS resource(s) for event evaluation(s), e.g., in/for/on the first (or second) carrier/CC/cell, could correspond to the candidate current serving beam RS(s) or RS resource(s)—e.g., out of the determined or identified S>1 candidate current serving beam RSs or RS resources—that is associated, linked, specific or corresponding to the indicated TCI state(s) that has the highest (or lowest) TCI state ID(s)/index(es)—e.g., among the indicated TCI state(s) associated, linked, specific or corresponding to the determined or identified S>1 candidate current serving beam RSs or RS resources.
In another example, the current serving beam RS(s) or RS resource(s) for event evaluation(s), e.g., in/for/on the first (or second) carrier/CC/cell, could correspond to the candidate current serving beam RS(s) or RS resource(s)—e.g., out of the determined or identified S>1 candidate current serving beam RSs or RS resources—that is associated, linked, specific or corresponding to the indicated TCI state(s) that is applied on/in the carrier(s)/CC(s)/cell(s)having the highest (or lowest) carrier/CC/cell ID(s)/index(es)—e.g., among the carrier(s)/CC(s)/cell(s) in which the indicated TCI state(s) associated, linked, specific or corresponding to the determined or identified S>1 candidate current serving beam RSs or RS resources could be applied.
In another example, the UE could be indicated or configured or provided by the network, e.g., via higher layer RRC signaling(s)/parameter(s) and/or MAC CE command(s) and/or dynamic DCI based L1 signaling(s) based on or according to corresponding UE's capability(s) or capability signaling(s), one or more indicators to which of the determined or identified S>1 candidate current serving beam RSs or RS resources could correspond to the current serving beam RS(s) or RS resource(s) for event evaluation(s), e.g., in/for/on the first (or second) carrier/CC/cell.
   For example, the one or more indicators could be in terms/form of or could correspond to a s-bit indicator with s=┌log₂S┐. When/if a codepoint of the s-bit indicator is indicated or provided or configured, the candidate current beam RS(s) or RS resource(s) corresponding, specific, linked or associated to or indicated by the codepoint could correspond to the current serving beam RS(s) or RS resource(s).
   For another example, the one or more indicators could be in terms/form of or could correspond to a bitmap having a length of S>1 with each entry/bit position corresponding or associated to a candidate current serving beam RS or RS resource. When/if an entry/bit position of the bitmap is set to ‘1’ (or ‘0’), the candidate current beam RS(s) or RS resource(s) corresponding, specific, linked or associated to or indicated by the entry/bit position could correspond to the current serving beam RS(s) or RS resource(s).

When/if the one or more indicators could be indicated in DCI, the one or more indicators could be indicated by/in new/dedicated DCI field(s) in the corresponding DCI format(s), e.g., DCI format(s) 0_0, 0_1, 0_2, 1_0, 1_1, 1_2, a new/dedicated DCI format(s) of 0_x and/or 1_y and/or etc., and/or repurposing one or more codepoints of one or more existing DCI fields in the corresponding DCI format(s), e.g., DCI format(s) 0_0, 0_1, 0_2, 1_0, 1_1, 1_2 and/or etc., and/or
In another example, the UE could transmit or send or indicate to the network, e.g., via/in/by (part of) a UEI (beam) report comprising a first message transmitted or sent on/over/in/by one or more periodically configured PUCCH resources of a first UL channel for triggering/indicating/initiating UEI beam reporting and/or requesting UL resource(s) for transmitting UEI beam report(s) and/or a second message transmitted or sent on/over/in/by one or more (CG Type1/Type2 and/or DG) PUSCH resources of a second UL channel for carrying or conveying the UEI beam report quantity(s)/content(s), one or more indicators to indicate which of the determined or identified S>1 candidate current serving beam RSs or RS resources could correspond to the current serving beam RS(s) or RS resource(s) for event evaluation(s), e.g., in/for/on the first (or second) carrier/CC/cell.
   For example, the one or more indicators could be in terms/form of or could correspond to a s-bit indicator with s=┌log₂S┐. When/if a codepoint of the s-bit indicator is indicated or provided or configured, the candidate current beam RS(s) or RS resource(s) corresponding, specific, linked or associated to or indicated by the codepoint could correspond to the current serving beam RS(s) or RS resource(s).
   For another example, the one or more indicators could be in terms/form of or could correspond to a bitmap having a length of S>1 with each entry/bit position corresponding or associated to a candidate current serving beam RS or RS resource. When/if an entry/bit position of the bitmap is set to ‘1’ (or ‘0’), the candidate current beam RS(s) or RS resource(s) corresponding, specific, linked or associated to or indicated by the entry/bit position could correspond to the current serving beam RS(s) or RS resource(s).

In one embodiment, according to or following those specified/defined herein in the present disclosure, a UE could be configured or provided by the network, e.g., in/via a higher layer parameter newBeamResourceSet in a CSI reporting setting provided by CSI-ReportConfig and/or UEI-ReportConfig that provides or configures necessary information and/or setting(s) for the UE-initiated/event-driven beam operation(s) including beam measurement/reporting as specified/defined herein in the present disclosure, a set of one or more candidate/new beam RSs or RS resources (e.g., in terms/form of their corresponding RS/resource ID(s)/index(es)) for event(s) evaluation(s) and/or measurement/reporting. In particular, the UE could determine or identify a first CC, carrier or serving cell in/on which the set of one or more candidate/new beam RSs or RS resources provided by newBeamResourceSet is configured according to:
If the higher layer parameter or field carrier/servCellIndex/cell is provided, present or configured in the CSI-ReportConfig and/or UEI-ReportConfig mentioned herein, the first CC, carrier or serving cell could correspond to the CC, carrier or serving cell provided or indicated by the (value(s) of) carrier/servCellIndex/cell.
If the higher layer parameter or field carrier/servCellIndex/cell is not provided, present or configured or is absent in the CSI-ReportConfig and/or UEI-ReportConfig mentioned herein, the first CC, carrier or serving cell could correspond to the same CC, carrier or serving cell of the CSI reporting setting mentioned herein provided by the CSI-ReportConfig and/or UEI-ReportConfig.

In addition, according to or following those specified/defined herein in the present disclosure, the UE could determine or identify or derive a RS or RS resource specific to an indicated TCI state as
the reference signal in the indicated TCI state, if the newBeamResourceSet is a NZP-CSI-RS-ResourceSet configured with repetition, else
the SS/PBCH block which is QCLed with the reference signal in the indicated TCI state, if the newBeamResourceSet is a CSI-SSB-ResourceSet.

Furthermore, the UE could determine or identify that a RS or RS resource specific to an indicated TCI state is in/on a/the same first CC or carrier or serving cell in/on which the set of one or more candidate/new beam RSs or RS resources provided by newBeamResourceSet is configured according to or following:
When/if the higher layer parameter or field carrier/servCellIndex/cell is provided, present or configured in QCL-Info of TCI-State that provides or configures the indicated TCI state, the UE could first determine or identify a second CC, carrier or serving cell corresponding to the CC, carrier or serving cell provided or indicated by the (value(s) of) carrier/servCellIndex/cell in the QCL-Info of the TCI-State. In this case, the UE could determine or identify that the reference signal in the indicated TCI state is configured in/on the second CC, carrier or serving cell, and
   when/if the newBeamResourceSet is a NZP-CSI-RS-ResourceSet configured with repetition, the UE could determine or identify that the reference signal in the indicated TCI state is configured in/on the second CC, carrier or serving cell, else
   when/if the newBeamResourceSet is a CSI-SSB-ResourceSet, the UE could determine or identify that the reference signal in the indicated TCI state is configured in/on the second CC, carrier or serving cell, and the UE could further determine or identify that the SS/PBCH block which is QCLed with the reference signal in the indicated TCI state is configured in/on the second CC, carrier or serving cell.
When/if the higher layer parameter or field carrier/servCellIndex/cell is not provided, present or configured or is absent in QCL-Info of TCI-State that provides or configures the indicated TCI state, the UE could first determine or identify a second CC, carrier or serving cell corresponding to the CC, carrier or serving cell in which the indicated TCI state provided by TCI-State is applied, e.g., only if the qcl-Type is configured as TypeC or TypeD. In this case, the UE could determine or identify that the reference signal in the indicated TCI state is configured in/on the second CC, carrier or serving cell, and
   when/if the newBeamResourceSet is a NZP-CSI-RS-ResourceSet configured with repetition, the UE could determine or identify that the reference signal in the indicated TCI state is configured in/on the second CC, carrier or serving cell, else
   when/if the newBeamResourceSet is a CSI-SSB-ResourceSet, the UE could determine or identify that the reference signal in the indicated TCI state is configured in/on the second CC, carrier or serving cell, and the UE could further determine or identify that the SS/PBCH block which is QCLed with the reference signal in the indicated TCI state is configured in/on the second CC, carrier or serving cell.

When/if the second CC or carrier or serving cell is the same as or identical to the first CC or carrier or serving cell in/on which the set of one or more candidate/new beam RSs or RS resources provided by newBeamResourceSet is configured, the UE could determine or identify the RS or RS resource specific to the indicated TCI state as a candidate current serving beam RS or RS resource configured in/on the first (or second) CC/carrier/serving cell. When/if a/the number of candidate current serving beam RSs or RS resources configured in/on the first (or second) CC/carrier/serving cell is greater than one, the UE may need to determine or identify one of the candidate current serving beam RSs or RS resources as the current serving beam RS or RS resource specific to a target indicated TCI state for event(s) evaluation(s). The UE could determine or identify the target indicated TCI state according to or following: (1) fixed rule(s)/setting(s) in system specification(s) and/or per RRC (re)configuration, (2) network's configuration(s)/indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including CSI/beam report(s) and/or UE's capability signaling; for instance, the UE could be indicated or provided or configured by the network, e.g., via higher layer RRC signaling(s)/parameter(s) and/or MAC CE command(s) and/or dynamic DCI based L1 signaling(s) based on or according to corresponding UE's capability(s) or capability signaling(s), which carrier, serving cell or CC the target indicated TCI state is applied.
In one example, the higher layer parameter(s) TCI-State that provides or configures the target indicated TCI state could provide, configure, comprise, include or contain a field (if present) indicating that the corresponding TCI-State is the target indicated TCI state.
   For example, the field could be denoted/represented/implemented/realized by/as a targetTCI field; when/if the field targetTCI is present and/or set to ‘true’, the TCI-State is the target indicated TCI state.
   For another example, the field could be denoted/represented/implemented/realized by/as a carrier/servCellIndex/cell field to indicate a carrier, a serving cell or a CC (e.g., in terms/form of their ID(s)/index(es)), to which the TCI-State is applied. When/if this carrier/servCellIndex/cell field is present and/or set to a/the same carrier/CC/serving cell ID/index value as that for/of the first CC, carrier or serving cell in/on which the set of one or more candidate/new beam RSs or RS resources provided by newBeamResourceSet is configured, the TCI-State is the target indicated TCI state.

For this design example, when/if the field is absent, the UE could determine or identify that the target indicated TCI state could be or could correspond a/the indicated TCI state applied to the (same) first CC/carrier/serving cell in/on which the set of one or more candidate/new beam RSs or RS resources provided by newBeamResourceSet is configured. Or equivalently, when/if the target indicated TCI state corresponds to a/the indicated TCI state applied to the (same) first CC/carrier/serving cell in/on which the set of one or more candidate/new beam RSs or RS resources provided by newBeamResourceSet is configured, the UE could expect that the field is absent.
In another example, the higher layer parameter(s) CSI-ReportConfig and/or UEI-ReportConfig that provides or configures necessary information and/or setting(s) for the UE-initiated/event-driven beam operation(s) including beam measurement/reporting as specified/defined herein in the present disclosure could provide, configured, include, contain or comprise a higher layer parameter or field carrier/servCellIndex/cell indicating the carrier or serving cell or CC (e.g., in terms/form of the corresponding carrier or serving cell or CC ID(s)/index(es)) to which the target indicated TCI state is applied. For this design example, when/if the field carrier/servCellIndex/cell is absent, the UE could determine or identify that the target indicated TCI state could be or could correspond to a/the indicated TCI state applied to the (same) first CC/carrier/serving cell in/on which the set of one or more candidate/new beam RSs or RS resources provided by newBeamResourceSet is configured. Or equivalently, when/if the target indicated TCI state corresponds to a/the indicated TCI state applied to the (same) first CC/carrier/serving cell in/on which the set of one or more candidate/new beam RSs or RS resources provided by newBeamResourceSet is configured, the UE could expect that the field carrier/servCellIndex/cell is absent.

In addition, when/if a/the number of candidate current serving beam RS or RS resource configured in/on the first (or second) CC/carrier/serving cell is one, the UE could determine or identify the only one candidate current serving beam RS or RS resource as the current serving beam RS or RS resource for event(s) evaluation(s) according to or following those specified herein in the present disclosure.

According to or following those specified/defined herein in the present disclosure, for event(s) evaluation(s), when/if the current serving beam RS(s) or RS resource(s) specific to/of the indicated TCI state that triggers or determines the corresponding event(s) and hence the associated UEI beam report(s) and therefore the corresponding UEI report content(s)/quantity(s) is updated or changed such that the UE receives an updated TCI state and the updated RS(s) or RS resource(s) specific to/of the updated TCI state is different from the current serving beam RS(s) or RS resource(s), wherein the updated RS(s) or RS resource(s) could correspond to or could be in form of
the reference signal in the updated TCI state, if the newBeamResourceSet is a NZP-CSI-RS-ResourceSet configured with repetition, else
the SS/PBCH block which is QCLed with the reference signal in the updated TCI state, if the newBeamResourceSet is a CSI-SSB-ResourceSet,
   wherein the indicated TCI state could be received
case-1: in a latest (in time) PDCCH that carries a beam indication DCI (e.g., DCI format(s) 1_1/1_2 with or without DL assignment) or a latest (in time) beam indication DCI (e.g., DCI format(s) 1_1/1_2 with or without DL assignment) that carries or conveys the updated TCI state before or prior to a corresponding PUCCH resource or PUCCH transmission occasion of a first UL channel that could be used to carry or convey a PN message/trigger as specified/defined herein in the present disclosure
case-2: in a latest, in time, (unified) TCI state(s) activation/deactivation MAC CE command indicating or comprising a single TCI codepoint mapped to the indicated TCI state before or prior to a corresponding PUCCH resource or PUCCH transmission occasion of a first UL channel that could be used to carry or convey a PN message/trigger as specified/defined herein in the present disclosure,
   and/or when/if the updated TCI state (or the updated RS(s) or RS resource(s)) has become applicable after a beam application time, wherein the beam application time could be determined according to:
for case-1: when the UE configured with dl-OrJointMI-StateList would transmit a PUCCH with positive HARQ-ACK or a PUSCH with positive HARQ-ACK corresponding to the DCI carrying the updated TCI State indication and without DL assignment, or corresponding to one or more PDSCH(s) scheduled by the DCI carrying the updated TCI State indication, and if the updated TCI State(s) is/are different from the previously indicated one(s), the updated WI-State(s) and/or MI-UL-State(s)—hence the updated RS(s) or RS resource(s)—should be applied starting from the first slot that is at least beamAppTime symbols after the last symbol of the PUCCH or the PUSCH, and if the UE receives more than one updated TCI state for a CC/BWP to be applied starting from the first slot that is at least beamAppTime symbols after the last symbol of the PUCCH or the PUSCH, the updated TCI state carried in the latest DCI, for the corresponding coresetPoolIndex value when applicable, in time corresponding to positive HARQ-ACK value is applied. The first slot and the beamAppTime symbols are both determined on the active BWP with the smallest subcarrier spacing (SCS) among the BWP(s) from the CCs applying the indicated/updated TCI-State(s) or TCI-UL-State(s) that are active at the end of the PUCCH or the PUSCH carrying the positive HARQ-ACK
for case-2: 3 ms after the last symbol of a PUCCH or PUSCH with HARQ-ACK information for the PDSCH providing the (unified) TCI state(s) activation/deactivation MAC CE command, the UE could reset or set the value of event instance counter index e for any of the reference signals configured by the newBeamResourceSet-r19. e.g., running from 0 to eventInstanceCount-r19, to zero(s).

According to or following those specified herein in the present disclosure, a/the UE (e.g., the UE 116) could be provided/configured by the network via higher layer RRC signaling(s)/parameter(s) one or more lists/sets/pools of carriers/CCs/cells as specified/defined herein in the present disclosure each corresponding to a CC list provided by simultaneousU-TCI-UpdateList1-r17, simultaneousU-TCI-UpdateList2-r17, simultaneousU-TCI-UpdateList3-r17 or simultaneousU-TCI-UpdateList4-r17. In this case, the UE may not assume or expect that the first carrier/CC/cell and the second carrier/CC/cell mentioned herein are from the same CC list, or they could be from different CC lists respectively.

Throughout the present disclosure, the higher layer parameter(s) CSI-ReportConfig and/or UEI-ReportConfig that provides or configures necessary information and/or setting(s) for the UE-initiated/event-driven beam operation(s) including beam measurement/reporting as specified/defined herein in the present disclosure could be configured or provided with a higher layer parameter eventType set to a particular value.

Throughout the present disclosure, a higher layer parameter carrier/servCellIndex could be equivalent to or could be the same as or could be identical to or could correspond to a higher layer parameter cell such that they could be used in an exchangeable manner.

Throughout the present disclosure, a TCI state associated, specific, linked or corresponding to a RS or RS resource (or vice versa) could correspond to or could be equivalent to or could be referred to/regarded as:
the RS or RS resource could correspond to or could have a same value as a QCL source RS or RS resource e.g. a NZP CSI-RS resource or resource configuration provided or indicated in the TCI state; and/or
the RS or RS resource could correspond to a QCL root RS or RS resource e.g. a SSB quasi-co-located (QCL'ed)—e.g., of QCL-TypeD—with a RS or RS resource serving/configured or having a same value as a QCL source RS e.g. a NZP CSI-RS resource or resource configuration provided or indicated in the TCI state.

Throughout the present disclosure, a carrier/CC/cell could be indicated/pointed by a higher layer parameter carrier/servCellIndex provided or configured in a higher layer parameter CSI-ReportConfig or UEI-ReportConfig provided or configured for the UE-initiated/event-driven beam reporting according to or following those specified herein in the present disclosure.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a channel quality indicator (CQI) report interval (CRI) reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UFJ-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s). Furthermore, a list/set/pool of carriers/CCs/cells as specified/defined herein in the present disclosure could correspond to a CC list provided by simultaneousU-TCI-UpdateList1-r17, simultaneousU-TCI-UpdateList2-r17, simultaneousU-TCI-UpdateList3-r17 or simultaneousU-TCI-UpdateList4-r17.

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE receiving a configuration related to UEI CSI reporting (910). The UE then identifies, based on the configuration, one or more first RS resources and a first CC (920). The UE then identifies, based on the configuration, a second CC to which an indicated TCI state is applied (930).

The UE then determines a second RS resource based on the indicated TCI state (940). The UE then monitors TOs of the one or more first RS resources or the second RS resource (950). The UE then determines an event based on measured L1-RSRPs of the TOs (960).

In various embodiments, the one or more first RS resources are indicated in the configuration by a higher layer parameter CSI-SSB-ResourceSet comprising one or more SSB or a higher layer parameter NZP-CSI-RS-ResourceSet comprising one or more NZP CSI-RS resources.

In various embodiments, the one or more first RS resources are applied to the first CC, when a first higher layer parameter, carrier, is present in the configuration, the first CC is provided by a value of the carrier, otherwise, the first CC corresponds to a CC of the configuration.

In various embodiments, when a first higher layer parameter, carrier, is present in the configuration, the second CC is provided by a value of the carrier; otherwise, the second CC corresponds to a CC of the configuration.

In various embodiments, when the one or more first RS resources correspond to SSBs, the second RS resource is an SSB quasi-co-located with a RS in the indicated TCI state, and when the one or more first RS resources correspond to NZP CSI-RS resources, the second RS resource is the RS in the indicated TCI state.

In various embodiments, the UE determines an event instance when a measured L1-RSRP of a TO of a first RS resource is greater than a measured L1-RSRP of a TO of a second RS resource by a configured threshold. For example, the event is determined when a number of determined event instances is greater than a configured number within a configured time window length.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive a configuration related to UE-initiated (UEI) channel state information (CSI) reporting; and
a processor operably coupled with the transceiver, the processor configured to:
identify, based on the configuration, one or more first reference signal (RS) resources and a first component carrier (CC);
identify, based on the configuration, a second CC to which an indicated transmission configuration indication (TCI) state is applied; and
determine a second RS resource based on the indicated TCI state,
wherein the transceiver is further configured to monitor transmission occasions (TOs) of the one or more first RS resources or the second RS resource, and
wherein the processor is further configured to determine an event based on measured layer-1 reference signal received powers (L1-RSRPs) of the TOs.

2. The UE of claim 1, wherein the one or more first RS resources are indicated in the configuration by:
a higher layer parameter CSI-SSB-ResourceSet comprising one or more synchronization signal/physical broadcast channel (SS/PBCH) blocks, or
a higher layer parameter NZP-CSI-RS-ResourceSet comprising one or more non-zero-power (NZP) CSI-RS resources.

3. The UE of claim 1, wherein the one or more first RS resources are applied to the first CC:
when a first higher layer parameter, carrier, is present in the configuration, the first CC is provided by a value of the carrier,
otherwise, the first CC corresponds to a CC of the configuration.

4. The UE of claim 1, wherein:
when a first higher layer parameter, carrier, is present in the configuration, the second CC is provided by a value of the carrier,
otherwise, the second CC corresponds to a CC of the configuration.

5. The UE of claim 1, wherein:
when the one or more first RS resources correspond to synchronization signal/physical broadcast channel (SS/PBCH) blocks (SSBs), the second RS resource is an SSB quasi-co-located with a RS in the indicated TCI state; and
when the one or more first RS resources correspond to non-zero-power (NZP) CSI-RS resources, the second RS resource is the RS in the indicated TCI state.

6. The UE of claim 1, wherein the processor is further configured to determine an event instance when a measured L1-RSRP of a TO of a first RS resource is greater than a measured L1-RSRP of a TO of a second RS resource by a configured threshold.

7. The UE of claim 6, wherein the event is determined when a number of determined event instances is greater than a configured number within a configured time window length.

8. A base station (BS), comprising:
a processor; and
a transceiver operably coupled with the processor, the transceiver configured to:
transmit a configuration related to UE-initiated (UEI) channel state information (CSI) reporting, wherein the configuration indicates one or more first reference signal (RS) resources, a first component carrier (CC), and a second CC to which an indicated transmission configuration indication (TCI) state is applied; and
transmit on transmission occasions (TOs) of the one or more first RS resources or a second RS resource associated with the indicated TCI state, wherein an event is based on layer-1 reference signal received powers (L1-RSRPs) of the TOs.

9. The BS of claim 8, wherein the one or more first RS resources are indicated in the configuration by:
a higher layer parameter CSI-SSB-ResourceSet comprising one or more synchronization signal/physical broadcast channel (SS/PBCH) blocks, or
a higher layer parameter NZP-CSI-RS-ResourceSet comprising one or more non-zero-power (NZP) CSI-RS resources.

10. The BS of claim 8, wherein the one or more first RS resources are applied to the first CC:
when a first higher layer parameter, carrier, is present in the configuration, the first CC is provided by a value of the carrier,
otherwise, the first CC corresponds to a CC of the configuration.

11. The BS of claim 8, wherein:
when a first higher layer parameter, carrier, is present in the configuration, the second CC is provided by a value of the carrier,
otherwise, the second CC corresponds to a CC of the configuration.

12. The BS of claim 8, wherein:
when the one or more first RS resources correspond to synchronization signal/physical broadcast channel (SS/PBCH) blocks (SSBs), the second RS resource is an SSB quasi-co-located with a RS in the indicated TCI state; and
when the one or more first RS resources correspond to non-zero-power (NZP) CSI-RS resources, the second RS resource is the RS in the indicated TCI state.

13. The BS of claim 8, wherein an event instance occurs when a L1-RSRP of a TO of a first RS resource is greater than a L1-RSRP of a TO of a second RS resource by a configured threshold.

14. The BS of claim 13, wherein the event occurs when a number of event instances is greater than a configured number within a configured time window length.

15. A method performed by a user equipment (UE), the method comprising:
receiving a configuration related to UE-initiated (UEI) channel state information (CSI) reporting;
identifying, based on the configuration, one or more first reference signal (RS) resources and a first component carrier (CC);
identifying, based on the configuration, a second CC to which an indicated transmission configuration indication (TCI) state is applied;
determining a second RS resource based on the indicated TCI state;
monitoring transmission occasions (TOs) of the one or more first RS resources or the second RS resource; and
determining an event based on measured layer-1 reference signal received powers (L1-RSRPs) of the TOs.

16. The method of claim 15, wherein the one or more first RS resources are indicated in the configuration by:
a higher layer parameter CSI-SSB-ResourceSet comprising one or more synchronization signal/physical broadcast channel (SS/PBCH) blocks, or
a higher layer parameter NZP-CSI-RS-ResourceSet comprising one or more non-zero-power (NZP) CSI-RS resources.

17. The method of claim 15, wherein the one or more first RS resources are applied to the first CC:
when a first higher layer parameter, carrier, is present in the configuration, the first CC is provided by a value of the carrier,
otherwise, the first CC corresponds to a CC of the configuration.

18. The method of claim 15, wherein:
when a first higher layer parameter, carrier, is present in the configuration, the second CC is provided by a value of the carrier,
otherwise, the second CC corresponds to a CC of the configuration.

19. The method of claim 15, wherein:
when the one or more first RS resources correspond to synchronization signal/physical broadcast channel (SS/PBCH) blocks (SSBs), the second RS resource is an SSB quasi-co-located with a RS in the indicated TCI state; and
when the one or more first RS resources correspond to non-zero-power (NZP) CSI-RS resources, the second RS resource is the RS in the indicated TCI state.

20. The method of claim 15, wherein determining the event further comprises determining an event instance when a measured L1-RSRP of a TO of a first RS resource is greater than a measured L1-RSRP of a TO of a second RS resource by a configured threshold.
